(19) United States
(12) Patent Application Publication
(10) Pub. No.: US 2013/0222696 A1
(43) Pub. Date: Aug. 29, 2013

(54) SELECTING BETWEEN CLUSTERING TECHNIQUES FOR DISPLAYING IMAGES

(71) Applicant: Sony Corporation, (US)

(72) Inventors: Toshio Yamazaki, Tokyo (JP); Takuro Kawai, Tokyo (JP); Masaki Handa, Kanagawa (JP); Kazunori Kamio, Kanagawa (JP)

(73) Assignee: Sony Corporation, Tokyo (JP)

(21) Appl. No.: 13/772,776

(22) Filed: Feb. 21, 2013

(30) Foreign Application Priority Data
Feb. 28, 2012 (JP) 2012-041192

(51) Int. Cl. G06K 9/00

(52) U.S. Cl. CPC G06K 9/00536
USPC 348/571

(57) ABSTRACT

A method of operating at least one computing device. The method selects between a first clustering process and a second clustering process based on whether at least one condition is satisfied. If the first clustering process is selected, the first clustering process is performed on a first plurality of images to obtain a first clustering result. The first clustering process uses first coordinate axes that were used in a previous clustering process. If the second clustering process is selected, the second clustering process is performed on a second plurality of images to obtain a second clustering result, wherein the second clustering process uses second coordinate axes different from the first coordinate axes used in the previous clustering process. Some embodiments are directed to an apparatus capable of performing the above method. Some embodiments are directed to a computer-readable storage medium comprising computer-executable instructions that, when executed, perform the above method.

### RELATED APPLICATIONS

This utility patent application claims the benefit of Japanese Priority Patent Application JP 2012-0411192 filed in the Japan Patent Office on Feb. 28, 2012, which is incorporated herein by reference in its entirety.

### BACKGROUND

The present disclosure relates to a terminal apparatus, an information processing apparatus, a display method, and a display control method.

In recent years, digital video cameras on which a large-capacity battery is mounted and which are easily carried due to their compact size have been widely proliferated. Therefore, in general households, opportunities to use digital video cameras have sharply increased compared to the past. On the other hand, since the number of photographed and saved moving images is vast, it is very troublesome to search for desired moving images or scenes. Accordingly, technologies for suggesting relevance or the like between moving images to users and facilitating search have been developed.

For example, Japanese Unexamined Patent Application Publication No. 2009-141820, Japanese Unexamined Patent Application Publication No. 2009-151896, and Japanese Unexamined Patent Application Publication No. 2009-159514 disclose technologies for assisting users in understanding relevance between moving images to be reproduced when a plurality of photographed moving images are reproduced with one display. For example, Japanese Unexamined Patent Application Publication No. 2009-141820, Japanese Unexamined Patent Application Publication No. 2009-151896, and Japanese Unexamined Patent Application Publication No. 2009-159514 disclose configurations in which images generated based on a plurality of moving images are combined to generate a composite image and the composite image is displayed on a display unit.

### SUMMARY

When the technologies disclosed in Japanese Unexamined Patent Application Publication No. 2009-141820, Japanese Unexamined Patent Application Publication No. 2009-151896, and Japanese Unexamined Patent Application Publication No. 2009-159514 are applied, the relevance between the moving images can be understood. Therefore, even when the number of moving images is considerable, users can easily understand the contents of the moving images, for example, by guessing the contents of differently relevant moving images from the contents of a reproduced moving image. In the technologies disclosed in Japanese Unexamined Patent Application Publication No. 2009-141820, Japanese Unexamined Patent Application Publication No. 2009-151896, and Japanese Unexamined Patent Application Publication No. 2009-159514, however, an operation or the like of substituting a criterion for evaluating the relevance halfway is not assumed. That is, the relevance between the moving images detected based on a predetermined criterion is displayed, but a relevance between the moving images is not suggested seamlessly from various viewpoints.

It is desirable to provide a novel and improved terminal apparatus, a novel and improved information processing apparatus, a novel and improved display method, and a novel and improved display control method capable of realizing a user interface more improved in convenience.

According to an embodiment of the present disclosure, there is provided a terminal apparatus including a display unit that displays information regarding a representative content of each cluster located in lower layers of a cluster to which a selected representative content belongs when information regarding the representative content of each cluster in a predetermined layer is displayed in accordance with a result of hierarchical clustering based on a first rule and the information regarding the representative content is selected. When a predetermined condition is satisfied, the information displayed on the display unit is changed to information regarding a representative content of each cluster extracted in accordance with a result of hierarchical clustering based on a second rule different from the first rule.

Further, according to another embodiment of the present disclosure, there is provided an information processing apparatus including a display control unit that causes information regarding a representative content of each cluster located in lower layers of a cluster to which a selected representative content belongs to be displayed when information regarding the representative content of each cluster in a predetermined layer is displayed in accordance with a result of hierarchical clustering based on a first rule and the information regarding the representative content is selected. When a predetermined condition is satisfied, the display control unit causes information regarding the representative content of each cluster to be displayed in accordance with a result of hierarchical clustering based on a second rule different from the first rule.

Further, according to another embodiment of the present disclosure, there is provided a display method including displaying information regarding a representative content of each cluster located in lower layers of a cluster to which a selected representative content belongs when information regarding the representative content of each cluster in a predetermined layer is displayed in accordance with a result of hierarchical clustering based on a first rule and the information regarding the representative content is selected, and changing display information to information regarding a representative content of each cluster extracted in accordance with a result of hierarchical clustering based on a second rule different from the first rule when a predetermined condition is satisfied.

Further, according to another embodiment of the present disclosure, there is provided a display control method including causing information regarding a representative content of each cluster located in lower layers of a cluster to which a selected representative content belongs to be displayed when information regarding the representative content of each cluster in a predetermined layer is displayed in accordance with a result of hierarchical clustering based on a first rule and the information regarding the representative content is selected, and causing information regarding the representative content of each cluster to be displayed in accordance with a result of hierarchical clustering based on a second rule different from the first rule when a predetermined condition is satisfied.

According to the embodiments of the present technology described above, it is possible to realize the higher convenient user interface.

### BRIEF DESCRIPTION OF THE DRAWINGS

FIG. 1 is a diagram illustrating a functional configuration of an information processing apparatus capable of realizing an image classification technology according to an embodiment;

FIG. 2 is a diagram illustrating the flow of preprocessing performed when the image classification technology according to the embodiment is applied to a moving image;

FIG. 3 is a diagram illustrating the functional configuration and operation of the information processing apparatus capable of realizing the image classification technology according to this embodiment in more detail;

FIG. 4 is a diagram illustrating the functional configuration and operation of the information processing apparatus capable of realizing the image classification technology according to this embodiment in more detail;

FIG. 5 is a diagram illustrating the functional configuration and operation of the information processing apparatus capable of realizing the image classification technology according to this embodiment in more detail;

FIG. 6 is a diagram illustrating the functional configuration and operation of the information processing apparatus capable of realizing the image classification technology according to this embodiment in more detail;

FIG. 7 is a diagram illustrating the functional configuration and operation of the information processing apparatus capable of realizing the image classification technology according to this embodiment in more detail;

FIG. 8 is a diagram illustrating the functional configuration and operation of the information processing apparatus capable of realizing the image classification technology according to this embodiment in more detail;

FIG. 9 is a diagram illustrating the functional configuration and operation of the information processing apparatus capable of realizing the image classification technology according to this embodiment in more detail;

FIG. 10 is a diagram illustrating the functional configuration and operation of the information processing apparatus capable of realizing the image classification technology according to this embodiment in more detail;

FIG. 11 is a diagram illustrating the functional configuration and operation of the information processing apparatus capable of realizing the image classification technology according to this embodiment in more detail;

FIG. 12 is a diagram illustrating the functional configuration and operation of the information processing apparatus capable of realizing the image classification technology according to this embodiment in more detail;

FIG. 13 is a diagram illustrating the functional configuration and operation of the information processing apparatus capable of realizing the image classification technology according to this embodiment in more detail;

FIG. 14 is a diagram illustrating the functional configuration and operation of the information processing apparatus capable of realizing the image classification technology according to this embodiment in more detail;

FIG. 15 is a diagram illustrating the functional configuration and operation of the information processing apparatus capable of realizing the image classification technology according to this embodiment in more detail;

FIG. 16 is a diagram illustrating the functional configuration and operation of the information processing apparatus capable of realizing the image classification technology according to this embodiment in more detail;

FIG. 17 is a diagram illustrating the functional configuration and operation of the information processing apparatus capable of realizing the image classification technology according to this embodiment in more detail;

FIG. 18 is a diagram illustrating the functional configuration and operation of the information processing apparatus capable of realizing the image classification technology according to this embodiment in more detail;

FIG. 19 is a diagram illustrating the functional configuration and operation of the information processing apparatus capable of realizing the image classification technology according to this embodiment in more detail;

FIG. 20 is a diagram illustrating the functional configuration and operation of the information processing apparatus capable of realizing the image classification technology according to this embodiment in more detail;

FIG. 21 is a diagram illustrating the functional configuration and operation of the information processing apparatus capable of realizing the image classification technology according to this embodiment in more detail;

FIG. 22 is a diagram illustrating the functional configuration and operation of the information processing apparatus capable of realizing the image classification technology according to this embodiment in more detail;

FIG. 23 is a diagram illustrating the functional configuration and operation of the information processing apparatus capable of realizing the image classification technology according to this embodiment in more detail;

FIG. 24 is a diagram illustrating the functional configuration and operation of the information processing apparatus capable of realizing the image classification technology according to this embodiment in more detail;

FIG. 25 is a diagram illustrating the functional configuration and operation of the information processing apparatus capable of realizing the image classification technology according to this embodiment in more detail;

FIG. 26 is a diagram illustrating the functional configuration and operation of the information processing apparatus capable of realizing the image classification technology according to this embodiment in more detail;

FIG. 27 is a diagram illustrating the functional configuration and operation of the information processing apparatus capable of realizing the image classification technology according to this embodiment in more detail;

FIG. 28 is a diagram illustrating the functional configuration and operation of the information processing apparatus capable of realizing the image classification technology according to this embodiment in more detail;

FIG. 29 is a diagram illustrating the functional configuration and operation of the information processing apparatus capable of realizing the image classification technology according to this embodiment in more detail;

FIG. 30 is a diagram illustrating the functional configuration and operation of the information processing apparatus capable of realizing the image classification technology according to this embodiment in more detail;

FIG. 31 is a diagram illustrating the functional configuration and operation of the information processing apparatus capable of realizing the image classification technology according to this embodiment in more detail;

FIG. 32 is a diagram illustrating the functional configuration and operation of the information processing apparatus capable of realizing the image classification technology according to this embodiment in more detail;

FIG. 33 is a diagram illustrating the functional configuration and operation of the information processing apparatus capable of realizing the image classification technology according to this embodiment in more detail;

FIG. 34 is a diagram illustrating the functional configuration and operation of the information processing apparatus capable of realizing the image classification technology according to this embodiment in more detail;

FIG. 35 is a diagram illustrating the functional configuration and operation of the information processing apparatus capable of realizing the image classification technology according to this embodiment in more detail;

FIG. 36 is a diagram illustrating the functional configuration and operation of the information processing apparatus capable of realizing the image classification technology according to this embodiment in more detail;

FIG. 37 is a diagram illustrating a functional configuration of the information processing apparatus capable of realizing the image classification technology according to the embodiment in consideration of a U/I;

FIG. 38 is a diagram illustrating a functional configuration and operation of the information processing apparatus capable of realizing the image classification technology according to the embodiment in consideration of a U/I;

FIG. 39 is a diagram illustrating a functional configuration and operation of the information processing apparatus capable of realizing the image classification technology according to the embodiment in consideration of a U/I;

FIG. 40 is a diagram illustrating a functional configuration and operation of the information processing apparatus capable of realizing the image classification technology according to the embodiment in consideration of a U/I;

FIG. 41 is a diagram illustrating a functional configuration and operation of the information processing apparatus capable of realizing the image classification technology according to the embodiment in consideration of a U/I;

FIG. 42 is a diagram illustrating a functional configuration and operation of the information processing apparatus capable of realizing the image classification technology according to the embodiment in consideration of a U/I;

FIG. 43 is a diagram illustrating a functional configuration and operation of the information processing apparatus capable of realizing the image classification technology according to the embodiment in consideration of a U/I;

FIG. 44 is a diagram illustrating a functional configuration and operation of the information processing apparatus capable of realizing the image classification technology according to the embodiment in consideration of a U/I;

FIG. 45 is a diagram illustrating a functional configuration of the information processing apparatus capable of realizing the image classification technology according to the embodiment in consideration of a region division;

FIG. 46 is a diagram illustrating a functional configuration and operation of the information processing apparatus capable of realizing the image classification technology according to the embodiment in consideration of a region division;

FIG. 47 is a diagram illustrating a functional configuration and operation of the information processing apparatus capable of realizing the image classification technology according to the embodiment in consideration of a region division;

FIG. 48 is a diagram illustrating a functional configuration and operation of the information processing apparatus capable of realizing the image classification technology according to the embodiment in consideration of a region division;

FIG. 49 is a diagram illustrating a functional configuration and operation of the information processing apparatus capable of realizing the image classification technology according to the embodiment in consideration of a region division;

FIG. 50 is a diagram illustrating a functional configuration of an information processing apparatus capable of realizing an overlook-image generation technology applied from the image classification technology according to the embodiment;

FIG. 51 is a diagram illustrating the functional configuration and operation of the information processing apparatus capable of realizing the overlook-image generation technology applied from the image classification technology according to the embodiment in more detail;

FIG. 52 is a diagram illustrating the functional configuration and operation of the information processing apparatus capable of realizing the overlook-image generation technology applied from the image classification technology according to the embodiment in more detail;

FIG. 53 is a diagram illustrating the functional configuration and operation of the information processing apparatus capable of realizing the overlook-image generation technology applied from the image classification technology according to the embodiment in more detail;

FIG. 54 is a diagram illustrating the functional configuration and operation of the information processing apparatus capable of realizing the overlook-image generation technology applied from the image classification technology according to the embodiment in more detail;

FIG. 55 is a diagram illustrating the functional configuration and operation of the information processing apparatus capable of realizing the overlook-image generation technology applied from the image classification technology according to the embodiment in more detail;

FIG. 56 is a diagram illustrating the functional configuration and operation of the information processing apparatus capable of realizing the overlook-image generation technology applied from the image classification technology according to the embodiment in more detail;

FIG. 57 is a diagram illustrating the functional configuration and operation of the information processing apparatus capable of realizing the overlook-image generation technology applied from the image classification technology according to the embodiment in more detail;

FIG. 58 is a diagram illustrating the functional configuration and operation of the information processing apparatus capable of realizing the overlook-image generation technology applied from the image classification technology according to the embodiment in more detail;

FIG. 59 is a diagram illustrating the functional configuration and operation of the information processing apparatus capable of realizing the overlook-image generation technology applied from the image classification technology according to the embodiment in more detail;

FIG. 60 is a diagram illustrating the functional configuration and operation of the information processing apparatus capable of realizing the overlook-image generation technology applied from the image classification technology according to the embodiment in more detail;

FIG. 61 is a diagram illustrating the functional configuration and operation of the information processing apparatus capable of realizing the overlook-image generation technology applied from the image classification technology according to the embodiment in more detail;

FIG. 62 is a diagram illustrating the functional configuration and operation of the information processing apparatus capable of realizing the overlook-image generation technology applied from the image classification technology according to the embodiment in more detail;

FIG. 63 is a diagram illustrating the functional configuration and operation of the information processing apparatus capable of realizing the overlook-image generation technology applied from the image classification technology according to the embodiment in more detail;

FIG. 64 is a diagram illustrating the functional configuration and operation of the information processing apparatus capable of realizing the overlook-image generation technology applied from the image classification technology according to the embodiment in more detail;

FIG. 65 is a diagram illustrating the functional configuration and operation of the information processing apparatus capable of realizing the overlook-image generation technology applied from the image classification technology according to the embodiment in more detail;

FIG. 66 is a diagram illustrating the functional configuration and operation of the information processing apparatus capable of realizing the overlook-image generation technology applied from the image classification technology according to the embodiment in more detail;

FIG. 67 is a diagram illustrating the functional configuration and operation of the information processing apparatus capable of realizing the overlook-image generation technology applied from the image classification technology according to the embodiment in more detail;

FIG. 68 is a diagram illustrating the functional configuration and operation of the information processing apparatus capable of realizing the overlook-image generation technology applied from the image classification technology according to the embodiment in more detail;

FIG. 69 is a diagram illustrating the functional configuration and operation of the information processing apparatus capable of realizing the overlook-image generation technology applied from the image classification technology according to the embodiment in more detail;

FIG. 70 is a diagram illustrating the functional configuration and operation of the information processing apparatus capable of realizing the overlook-image generation technology applied from the image classification technology according to the embodiment in more detail;

FIG. 71 is a diagram illustrating the functional configuration and operation of the information processing apparatus capable of realizing the overlook-image generation technology applied from the image classification technology according to the embodiment in more detail;

FIG. 72 is a diagram illustrating the functional configuration and operation of the information processing apparatus capable of realizing the overlook-image generation technology applied from the image classification technology according to the embodiment in more detail;

FIG. 73 is a diagram illustrating the functional configuration and operation of the information processing apparatus capable of realizing the overlook-image generation technology applied from the image classification technology according to the embodiment in more detail;

FIG. 74 is a diagram illustrating the functional configuration and operation of the information processing apparatus capable of realizing the overlook-image generation technology applied from the image classification technology according to the embodiment in more detail;

FIG. 75 is a diagram illustrating the functional configuration and operation of the information processing apparatus capable of realizing the overlook-image generation technology applied from the image classification technology according to the embodiment in more detail;

FIG. 76 is a diagram illustrating the functional configuration and operation of the information processing apparatus capable of realizing the overlook-image generation technology applied from the image classification technology according to the embodiment in more detail;

FIG. 77 is a diagram illustrating the functional configuration and operation of the information processing apparatus capable of realizing the overlook-image generation technology applied from the image classification technology according to the embodiment in more detail;

FIG. 78 is a diagram illustrating the functional configuration and operation of the information processing apparatus capable of realizing the overlook-image generation technology applied from the image classification technology according to the embodiment in more detail; and

FIG. 79 is a diagram illustrating an example of a hardware configuration capable of realizing the image classification technology and the overlook-image generation technology according to the embodiment.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

### (Flow of Description)

Hereinafter, the flow of description to be made below will be described in brief.

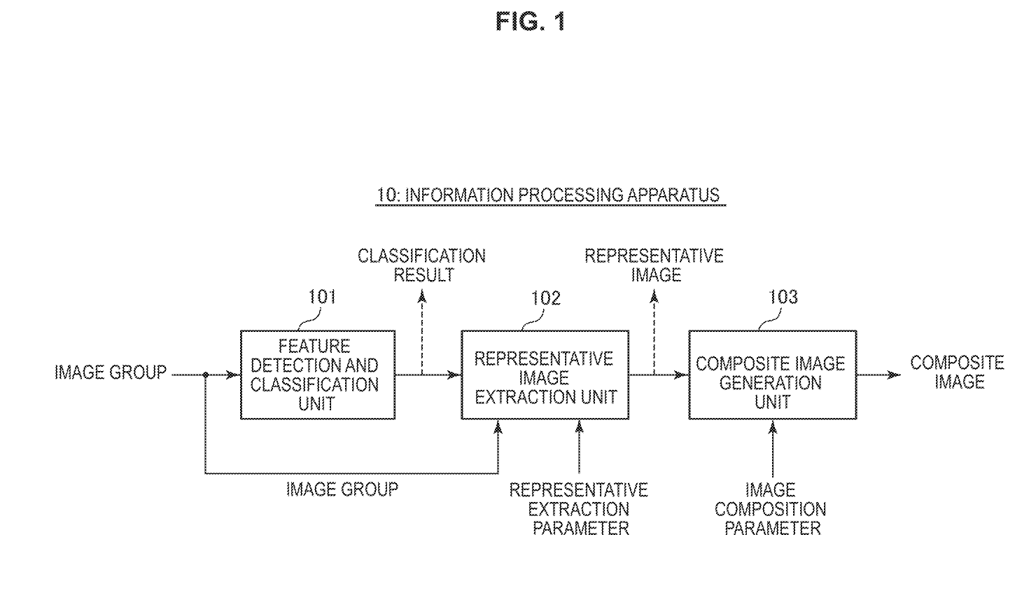

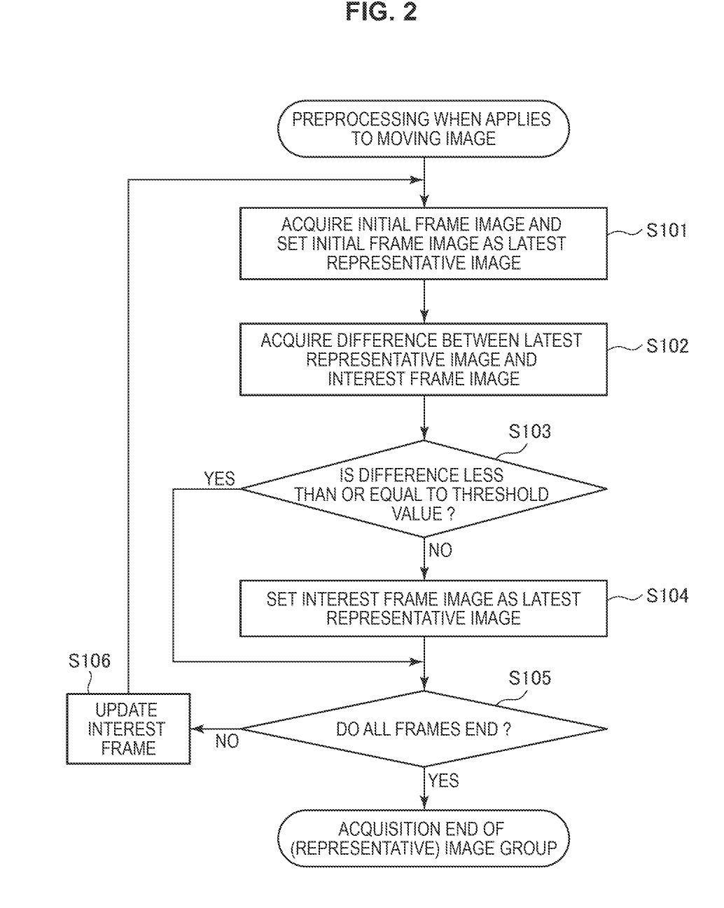

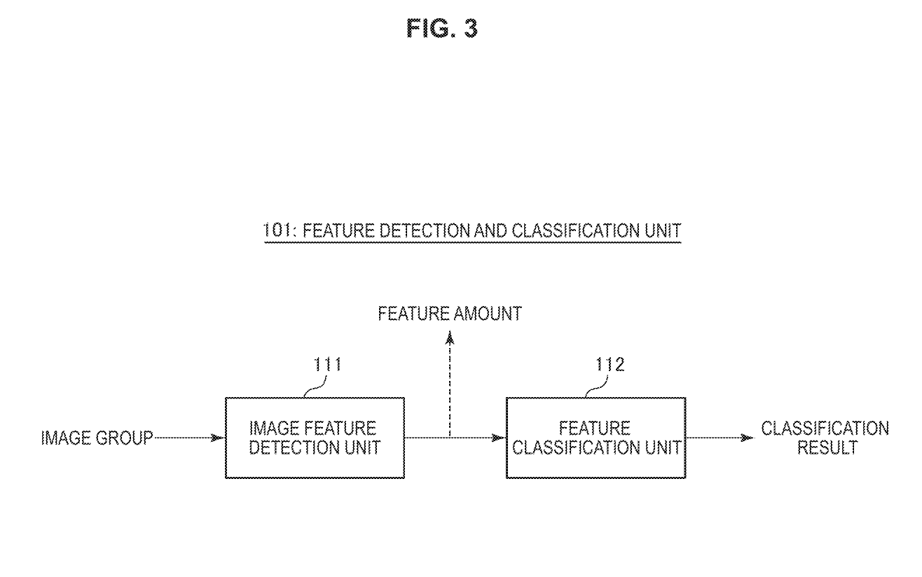

First, the functional configuration of an information processing apparatus 10 capable of realizing an image classification technology according to an embodiment will be described with reference to FIG. 1. Next, the flow of preprocessing performed at the time of applying the image classification technology according to the embodiment to a moving image will be described with reference to FIG. 2. Next, a functional configuration and an operation of the information processing apparatus 10 capable of realizing the image classification technology according to the embodiment will be described in detail with reference to FIGS. 3 to 36.

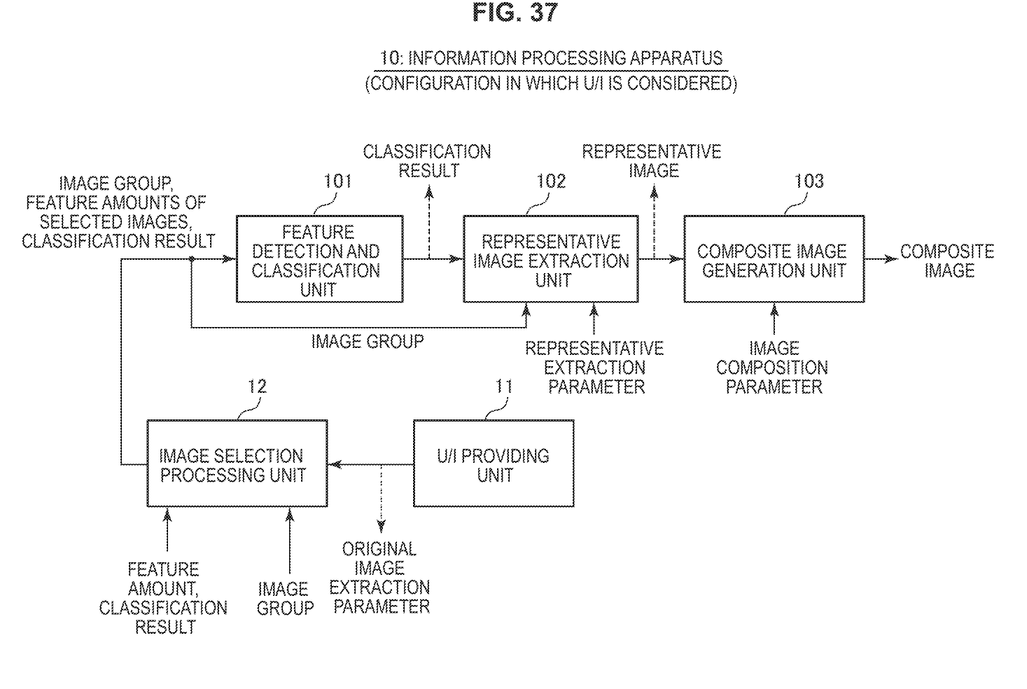

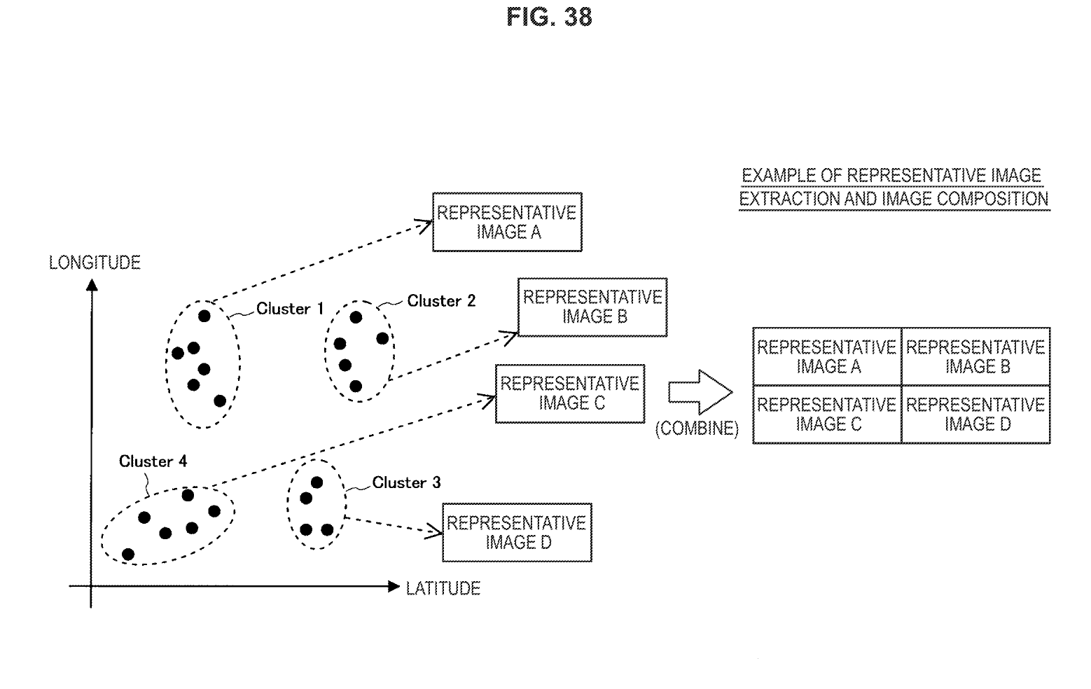

Next, the functional configuration (example of a configuration in which a U/I is considered) of the information processing apparatus 10 capable of realizing the image classification technology according to the embodiment will be described with reference to FIG. 37. Next, the functional configuration and operation of the information processing apparatus 10 capable of realizing the image classification technology in consideration of the U/I according to the embodiment will be described in more detail with reference to FIGS. 38 to 44.

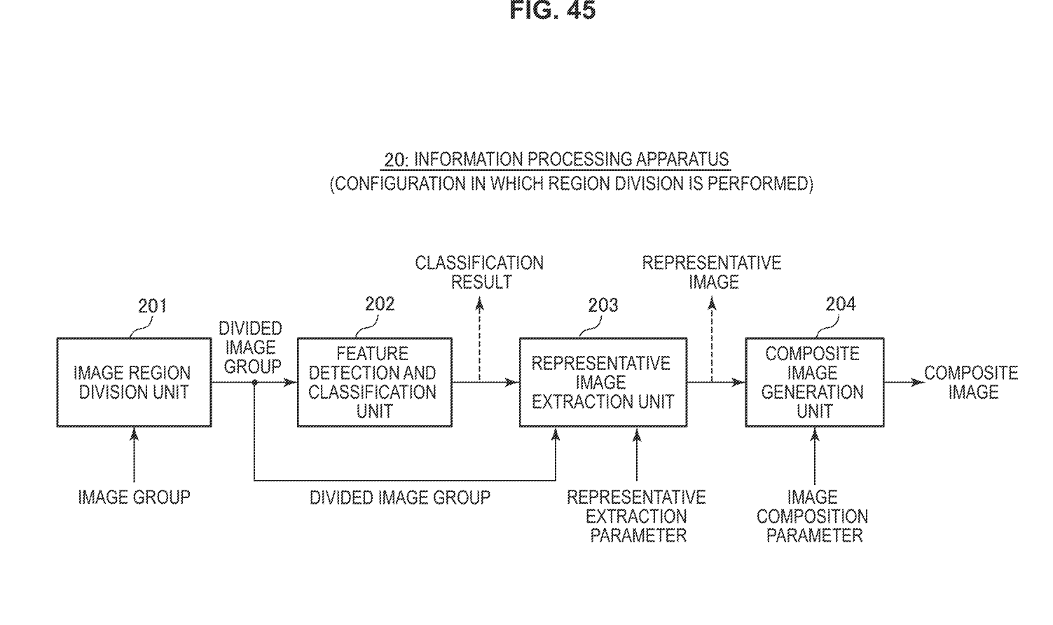

Next, a functional configuration of an information processing apparatus 20 capable of realizing an image classification technology in consideration of region division according to the embodiment will be described with reference to FIG. 45. Next, the functional configuration and operation of the information processing apparatus 20 capable of realizing the image classification technology in consideration of the region division according to the embodiment will be described in more detail with reference to FIGS. 46 to 49.

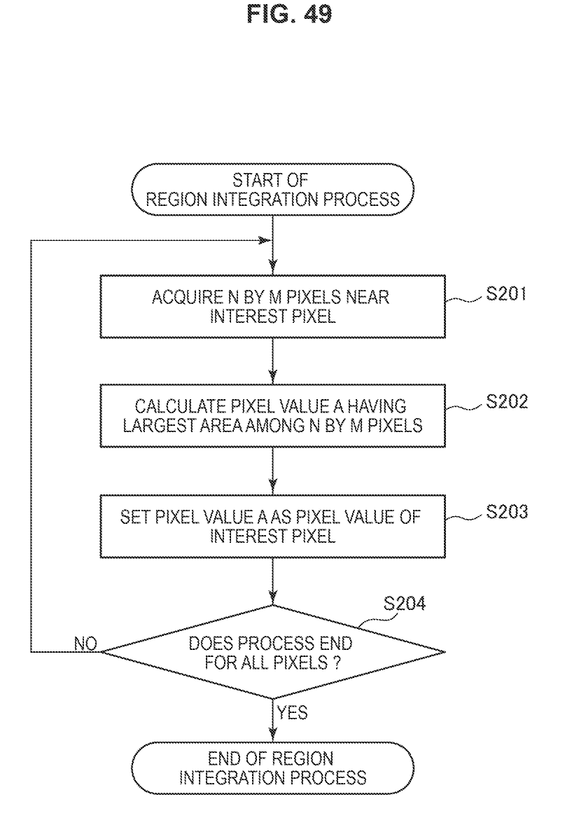

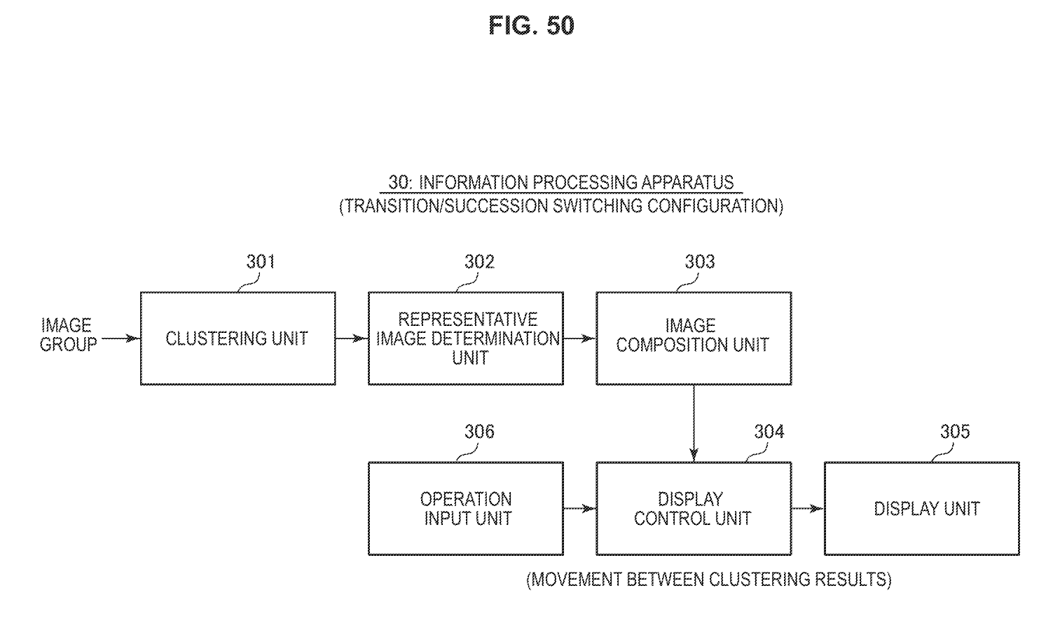

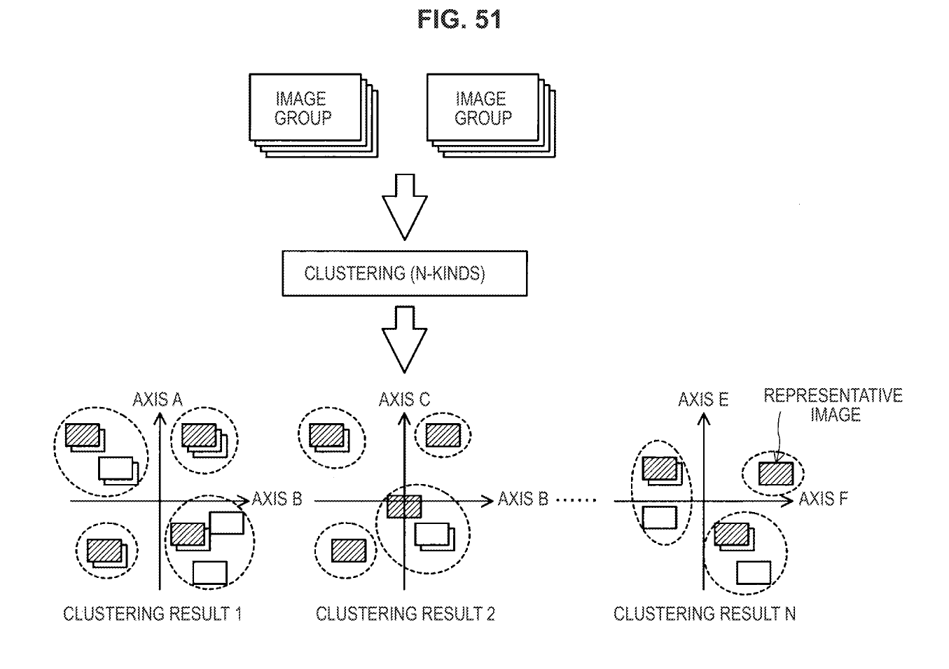

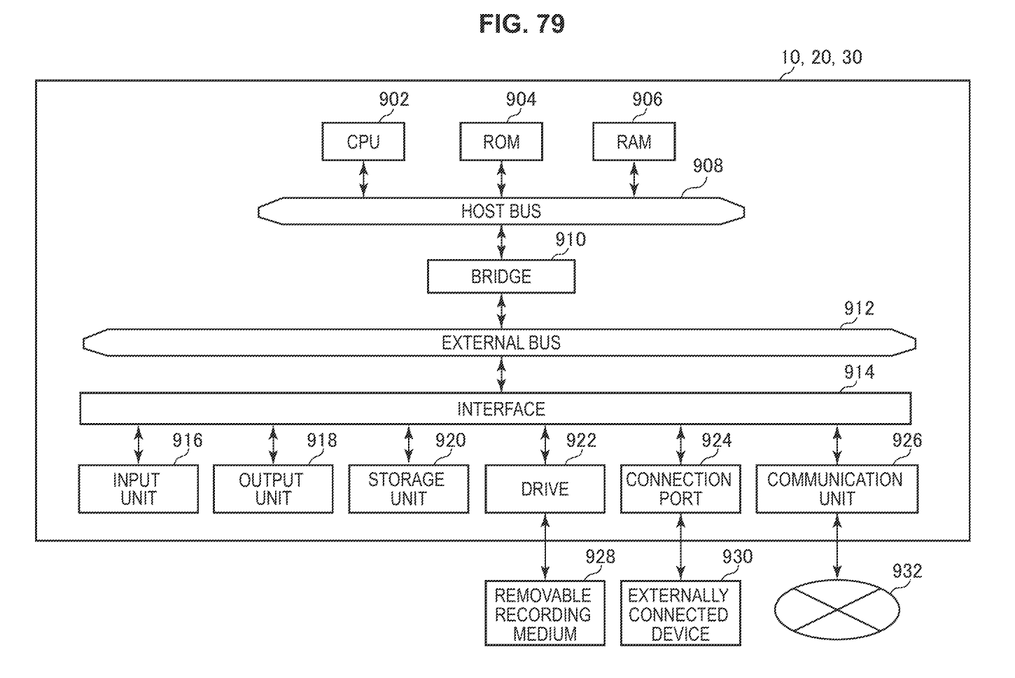

Next, a functional configuration of an information processing apparatus 30 capable of realizing an overlook-image generation technology applied from the image classification technology according to the embodiment will be described with reference to FIG. 50. Next, the functional configuration and operation of the information processing apparatus 30 capable of realizing the overlook-image generation technology applied from the image classification technology according to the embodiment will be described in more detail with reference to FIGS. 51 to 78. Next, an example of a hardware configuration capable of realizing the image classification technology and the overlook-image generation technology according to the embodiment will be described with reference to FIG. 79. Finally, the summarization of the technical spirit and essence of the embodiment and operational advantages obtained from the technical spirit and essence will be described in brief.

### (Description Items)

1. Preview
1-1. Overview of Image Classification Technology
1-2. Overview of Overlook-Image Generation Technology
1-3. System Configuration

2. Details of Image Classification Technology
2-1. Exemplary Configuration #1 (Case in Which Region Division Is Not Considered)
   2-1-1. General Configuration of Information Processing Apparatus 10
   2-1-2. Preprocessing When Applied to Moving Image
   2-1-3. Detailed Configuration and Operation of Information Processing Apparatus 10
   2-1-4. Configuration and Operation in Which U/I Is Considered
2-2. Exemplary Configuration #2 (Case in Which Region Division Is Considered)
   2-2-1. General Configuration of Information Processing Apparatus 20
   2-2-2. Detailed Configuration and Operation of Information Processing Apparatus 20

3. Details of Overlook-Image Generation Technology
3-1. Entire Configuration and Operation of Information Processing Apparatus
3-2. Detailed Configuration and Operation of Information Processing Apparatus 30

4. Example of Hardware Configuration

5. Summarization

<1. Preview>

First, the overview of an image classification technology and the overview of an overlook-image generation technology according to the embodiment will be described. Further, the configuration of a system capable of realizing the image classification technology and the overlook-image generation technology according to the embodiment will be described in brief.

[1-1. Overview of Image Classification Technology]

The image classification technology according to the embodiment relates to a technology of clustering images or image regions based on an image feature amount. In the following description, a technology of extracting representative images of clusters and combining the extracted representative images to generate a composite image will also be introduced. Further, an example of the configuration of a user interface that prepares a plurality of combinations (hereinafter referred to as rules) of feature amount coordinate axes and extracts a desired image group by freely reorganizing the rules or layers using a result obtained by performing image hierarchical clustering on the rules will also be introduced.

[1-2. Overview of Overlook-Image Generation Technology]

On the other hand, the overlook-image generation technology according to this embodiment relates to a display control method of easily understanding the contents of an image group using the result of the hierarchical clustering based on an image feature amount. In the following description, for example, a method of realizing a user interface to extract a desired image group by freely reorganizing the rules or layers or a method of generating a composite image very suitable to view the image group in an overlook manner will be introduced. The overlook-image generation technology to be described here is applied from the image classification technology.

[1-3. System Configuration]

The image classification technology and the overlook-image generation technology according to the embodiment are able to be realized, for example, using a single computer or a plurality of computers connected to each other via a network. Further, the image classification technology and the overlook-image generation technology according to the embodiment are able to be realized using a system or the like in which a cloud computing system and an information terminal are combined. Furthermore, the image classification technology and the overlook-image generation technology according to the embodiment are able to be realized by a system in which a terminal apparatus that acquires and displays display data on which the image clustering result is reflected is combined.

The overview of the image classification technology, the overview of the overlook-image generation technology, and the configuration of the system capable of realizing these technologies according to the embodiment have been described. Hereinafter, the image classification technology and the overlook-image generation technology according to the embodiment will sequentially be described in detail.

<2. Details of Image Classification Technology>

The image classification technology according to the embodiment will be described below.

[2-1. Exemplary Configuration #1 (Case in Which Region Division Is Not Considered)]

First, a configuration (exemplary configuration #1) in which an image feature amount is considered using one image as a unit will be described.

(2-1-1. General Configuration of Information Processing Apparatus 10 (FIG. 1))

The general configuration of an information processing apparatus 10 capable of realizing the image classification technology according to the embodiment will be described with reference to FIG. 1. FIG. 1 is a diagram illustrating the general configuration of the information processing apparatus 10 capable of realizing the image classification technology according to the embodiment.

As shown in FIG. 1, the information processing apparatus 10 mainly includes a feature detection and classification unit 101, a representative image extraction unit 102, and a composite image generation unit 103.

When an image group to be clustered is input to the information processing apparatus 10, the input image group is input to the feature detection and classification unit 101 and the representative image extraction unit 102. The feature detection and classification unit 101 to which the image group is input detects an image feature amount from each of the images included in the input image group and clusters the images based on the detected image feature amount. A result (hereinafter, classification result) of the clustering performed by the feature detection and classification unit 101 is input to the representative image extraction unit 102.

The representative image extraction unit 102 to which the image group and the classification result are input extracts a representative image of each cluster based on the input image group and the classification result. The representative image of each cluster extracted by the representative image extraction unit 102 is input to the composite image generation unit 103. When the representative image of each cluster is input, the composite image generation unit 103 combines the input representative images to generate a composite image. The composite image generated by the composite image generation unit 103 is displayed on a display device (not shown). The display device may be a display mounted on the information processing apparatus 10 or may be a display of a terminal apparatus that can exchange information via a network or the like.

The general configuration of the information processing apparatus 10 has been described.

(2-1-2. Preprocessing When Applied to Moving Image (FIG. 2))

Next, referring to FIG. 2, preprocessing will be described when the image classification technology according to the embodiment is applied to a moving image. FIG. 2 is a diagram illustrating the preprocessing when the image classification technology according to the embodiment is applied to a moving image. Further, a system may be configured such that the preprocessing can be performed by an apparatus other than the information processing apparatus 10.

As shown in FIG. 2, the information processing apparatus 10 starting the preprocessing acquires an initial frame image of the moving image and sets the initial frame image as the latest representative image (S101). Next, the information processing apparatus 10 acquires a difference between the latest representative image and an interest frame image (S102). The difference between the images can be obtained by an evaluation expression such as a sum of squared difference (SSD), a sum of absolute difference (SAD), or a normalized cross-correlation.

Next, the information processing apparatus 10 determines whether the difference obtained in step S102 is less than or equal to a predetermined threshold value (S103). When the difference is less than or equal to the predetermined threshold value, the information processing apparatus 10 causes the process to proceed to step S105. Conversely, when the difference is not less than or equal to the predetermined threshold value, the information processing apparatus 10 causes the process to proceed to step S104.

When the process proceeds to step S104, the information processing apparatus 10 sets the interest frame image as the latest representative image (S104). Next, the information processing apparatus 10 determines whether the process ends for all of the frames (S105). When the process ends for all of the frames, the information processing apparatus 10 retains the image group extracted as the representative image and ends the preprocessing. Conversely, when the process does not end for all of the frames, the information processing apparatus 10 causes the process to proceed to step S106. When the process proceeds to step S106, the information processing apparatus 10 updates the interest frame to a subsequent frame (S106) and causes the process to proceed to step S101.

The preprocessing has been described when the image classification technology is applied to the moving image.

(2-1-3. Detailed Configuration and Operation of Information Processing Apparatus 10 (FIGS. 3 to 36))

Next, the detailed configuration and operation of the information processing apparatus 10 will be described with reference to FIGS. 3 to 36. FIGS. 3 to 36 are diagrams illustrating the detailed configuration and operation of the information processing apparatus 10.

### (Configuration and Operation of Feature Detection and Classification Unit 101)

First, FIG. 3 is referred to. As shown in FIG. 3, the feature detection and classification unit 101 mainly includes an image feature detection unit 111 and a feature classification unit 112. The image feature detection unit 111 detects an image feature amount of each image included in the input image group. The image feature amount detected by the image feature detection unit 111 is input to the feature classification unit 112. When the image feature amount is input, the feature classification unit 112 clusters the images based on the input image feature amount and outputs the clustering result (the classification result). This will be described in detail below.

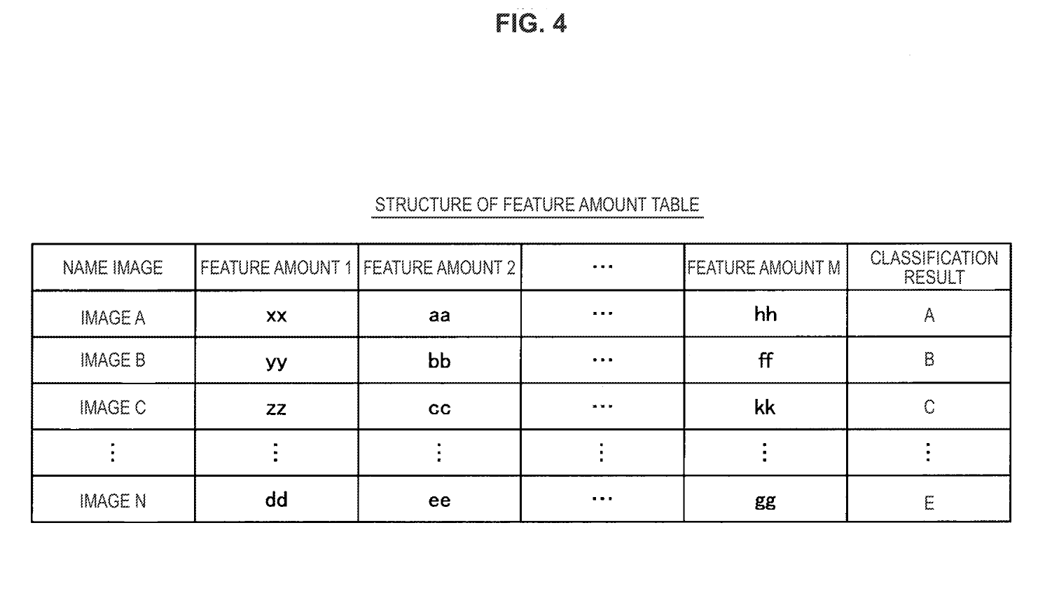

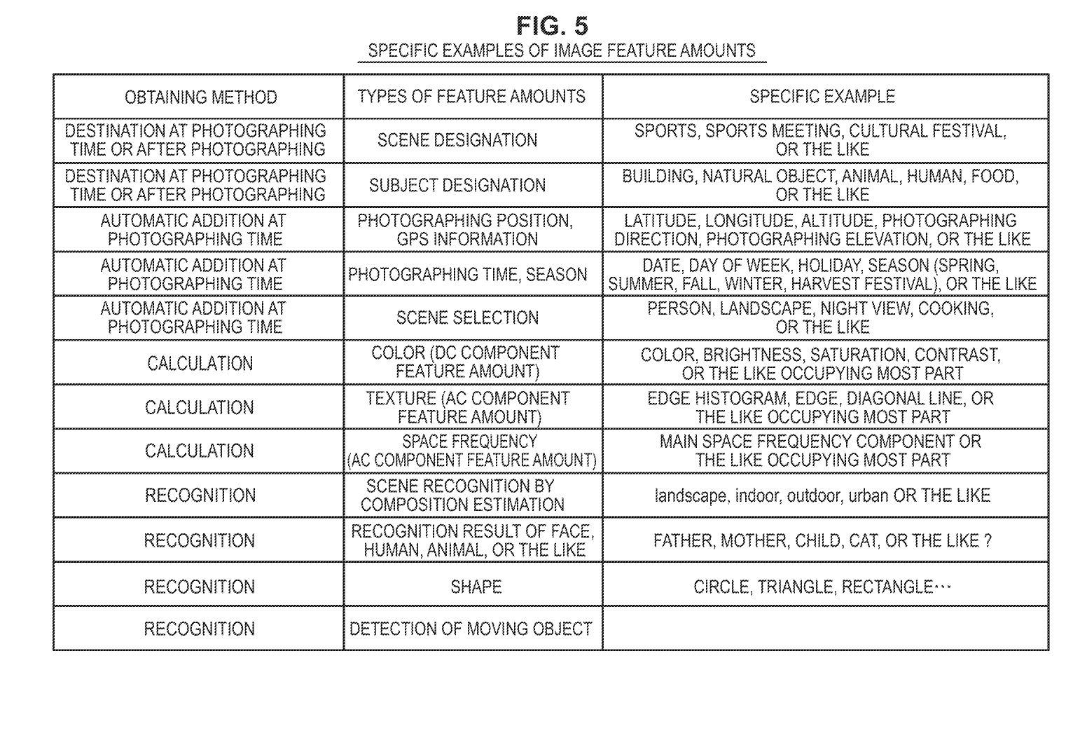

The detection result of the image feature amount obtained by the image feature detection unit 111 is able to be collected as a feature amount table shown in FIG. 4. In the example of FIG. 4, a plurality of image feature amounts (feature amounts 1 to M) are associated with classification results in each image. Here, the field of the classification result is appended by the feature classification unit 112 after the clustering result is obtained by the feature classification unit 112. Further, examples of the image feature amounts are shown in FIG. 5. As shown in FIG. 5, a plurality of kinds of image feature amounts are present and a plurality of methods of calculating the image feature amounts are also present.

### (Detection of DC Component Feature Amount)

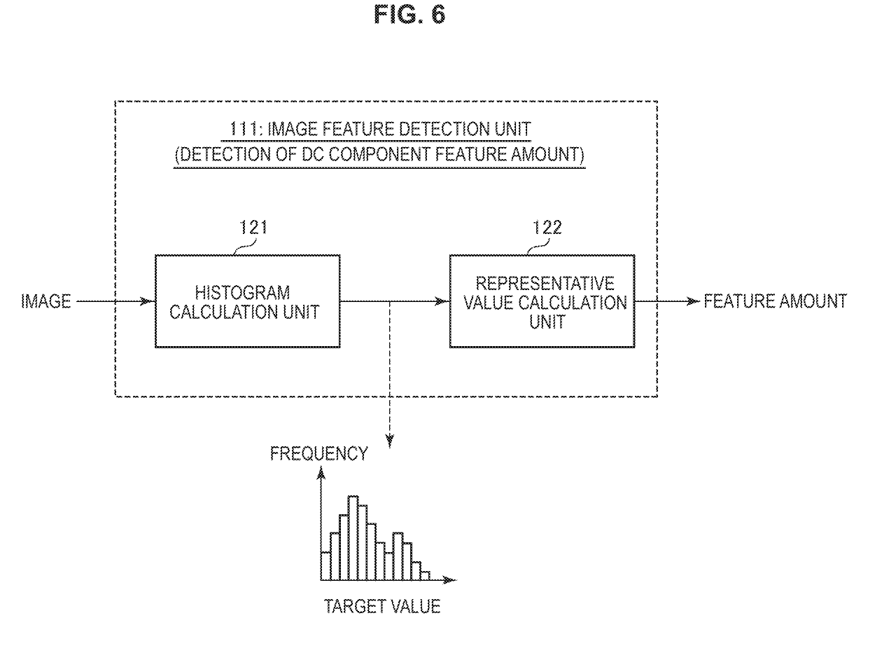

For example, when a DC component feature amount is used as the image feature amount, the image feature detection unit 111 has a configuration shown in FIG. 6. In this case, as shown in FIG. 6, the image feature detection unit 111 mainly includes a histogram calculation unit 121 and a representative value calculation unit 122.

The histogram calculation unit 121 converts the format of an image into a predetermined format to acquire a histogram. For example, when the histograms of brightness, saturation, and hue are acquired, the histogram calculation unit 121 converts an image into an HSV color space and calculates the histograms using the converted value. Further, a histogram of contrast or the like is acquired, the histogram calculation unit 121 calculates the contrast value of N by M pixels near an interest pixel, considers the calculated contrast value as the contrast value of the interest pixel, and calculates the histogram. Information regarding the calculated histogram is input to the representative value calculation unit 122.

When the information regarding the histogram is input, the representative value calculation unit 122 calculates the representative value from the input histogram. For example, the representative value calculation unit 122 calculates a highest frequency value, an average value, a dispersion value, a standard deviation, or the like as the representative value. The calculated representative value calculated by the representative value calculation unit 122 is output as the image feature amount of the input image.

### (Detection of Texture Component Feature Amount)

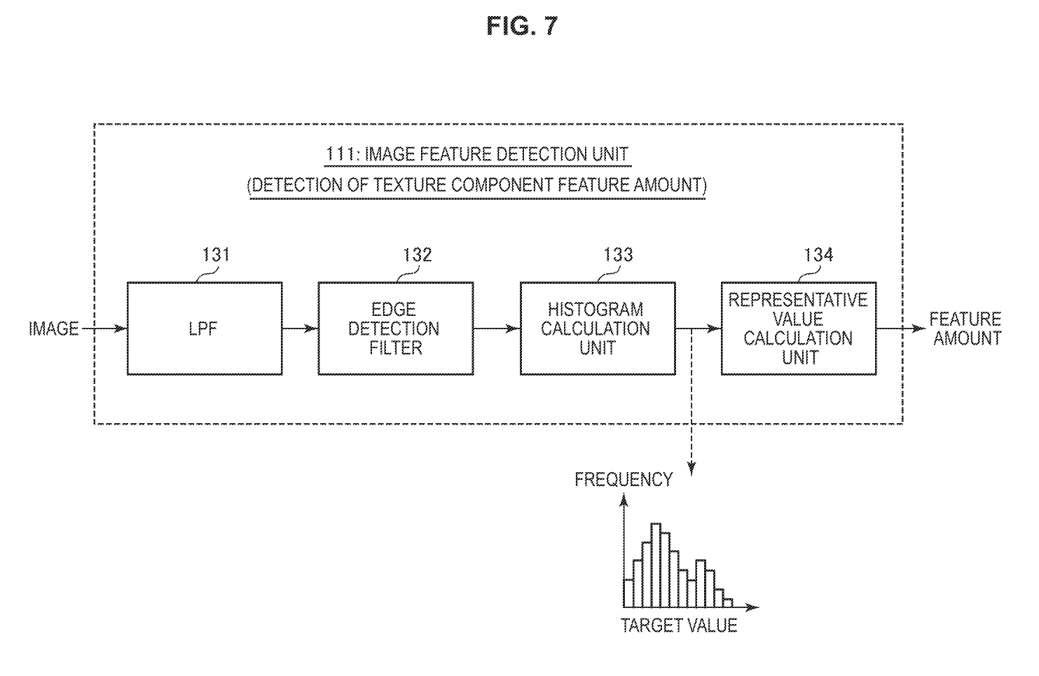

When a texture component feature amount is used as the image feature amount, the image feature detection unit 111 has a configuration shown in FIG. 7. In this case, as shown in FIG. 7, the image feature detection unit 111 mainly includes a lowpass filter 131, an edge detection filter 132, a histogram calculation unit 133, and a representative value calculation unit 134.

First, the input image passes through the lowpass filter 131 so that a high-frequency component is cut. The image in which the high-frequency component is cut by the lowpass filter 131 is input to the edge detection filter 132. For example, a filter of Sobel, Prewitt, Roberts cross, Laplacian, or Canny is used as the edge detection filter 132. Edge information detected by the edge detection filter 132 is input to the histogram calculation unit 133.

For example, the histogram calculation unit 133 to which the edge information is input generates a histogram based on the edge information. Information regarding the histogram generated by the histogram calculation unit 133 is input to the representative value calculation unit 134. When the information regarding the histogram is input, the representative value calculation unit 134 calculates a representative value from the input histogram. For example, the representative value calculation unit 134 calculates a highest frequency value, an average value, a dispersion value, a standard deviation, or the like as the representative value. The representative value calculated by the representative value calculation unit 134 is output as the image feature amount of the input image.

### (Detection of Space Frequency Feature Amount)

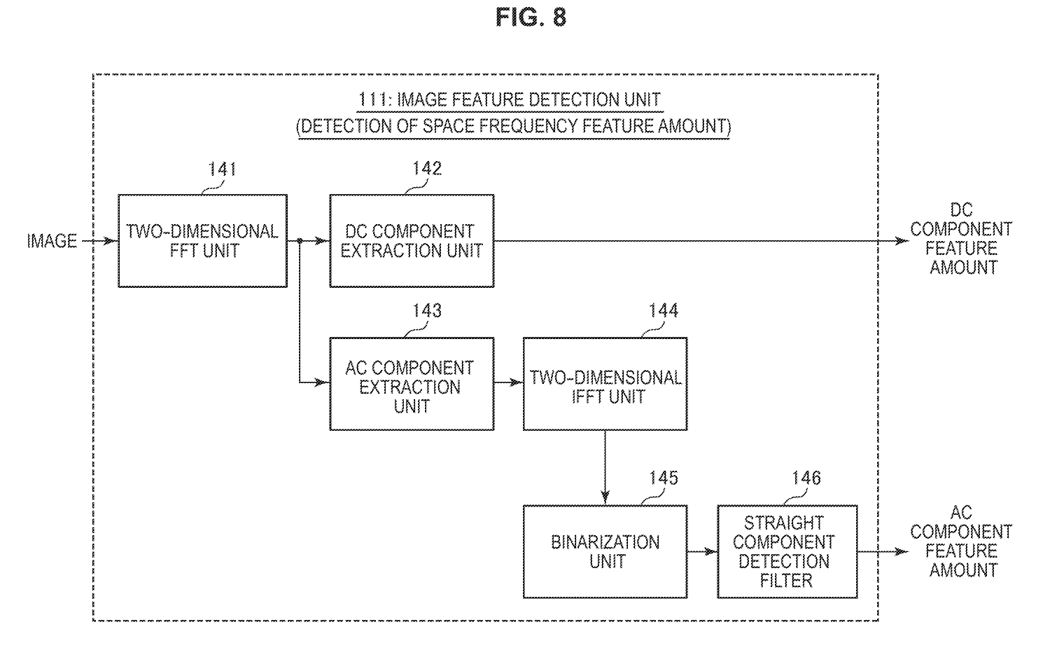

When a space frequency feature amount is used as the image feature amount, the image feature detection unit 111 has a configuration shown in FIG. 8. In this case, as shown in FIG. 8, the image feature detection unit 111 mainly includes a two-dimensional FFT unit 141, a DC component extraction unit 142, an AC component extraction unit 143, a two-dimensional IFFT unit 144, a binarization unit 145, and a straight component detection filter 146.

First, the input image is converted from a space region to a frequency region by the two-dimensional FFT unit 141. An output (hereinafter referred to as an FFT output) from the two-dimensional FFT unit 141 is input to the DC component extraction unit 142 and the AC component extraction unit 143. The DC component extraction unit 142 to which the FFT output is input extracts a DC component from the FFT output and outputs the extracted DC component as a DC component feature amount. Further, the AC component extraction unit 143 extracts an AC component from the FFT output and inputs the extracted AC component to the two-dimensional IFFT unit 144. The two-dimensional IFFT unit 144 converts the frequency region of the input AC component into a space region and inputs the result as an FFT output to the binarization unit 145. The binarization unit 145 binarizes the input FFT output.

The output (hereinafter, a binarization output) of the binarization unit 145 is input to the straight component detection filter 146. When the binarization output is input, the straight component detection filter 146 detects a straight component from the binarization output. For example, a filter of Hough conversion or the like is able to be used as the straight component detection filter 146.

A straight line detected by the straight component detection filter 146 represents the characteristics of a space frequency band that considerably occupies the space frequency region. For example, the detection of a horizontal line indicates that a plurality of strong horizontal edges are present in a circular image. That is, when the straight lines are calculated, the edges occupying a great number in the circular image are calculated. Therefore, the detection result of the straight lines is able to be used as an image feature amount. Further, the detection result of the straight lines detected by the straight component detection filter 146 is output as an AC component feature amount.

### (Detection of Face Feature Amount)

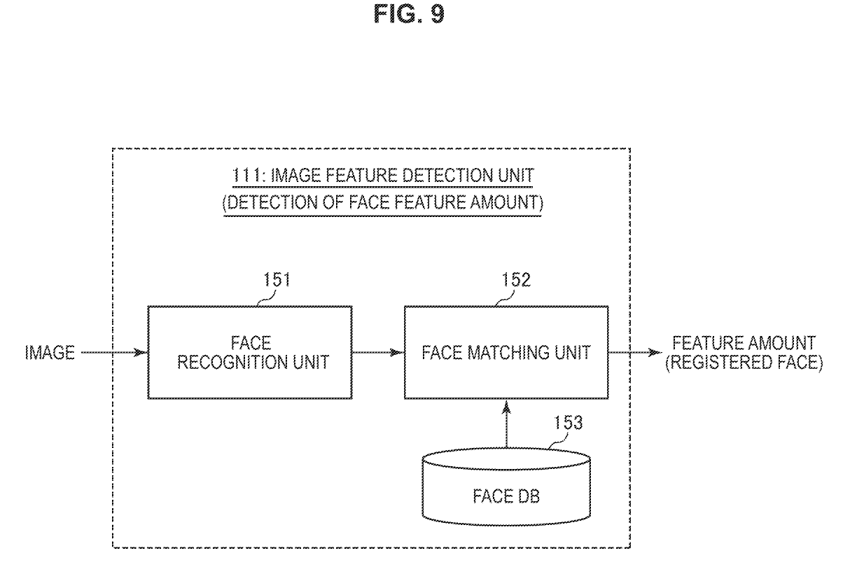

When a face feature amount is used as the image feature amount, the image feature detection unit 111 has a configuration shown in FIG. 9. In this case, as shown in FIG. 9, the image feature detection unit 111 mainly includes a face recognition unit 151, a face matching unit 152, and a face database 153.

First, an image is input to the face recognition unit 151. When the image is input, the face recognition unit 151 recognizes a face included in the input image using any face recognition technology. The face recognition result obtained by the face recognition unit 151 is input to the face matching unit 152. When the face recognition result is input, the face matching unit 152 recognizes who has the face included in the image by verifying the input face recognition result and information regarding faces registered in the face database 153. For example, the faces of family members, friends, or the like are registered in the face database 153. In this case, when the faces of family members, friends, or the like are included in the image, the detection result is output as the image feature amount.

### (Detection of Scene Recognition Feature Amount)

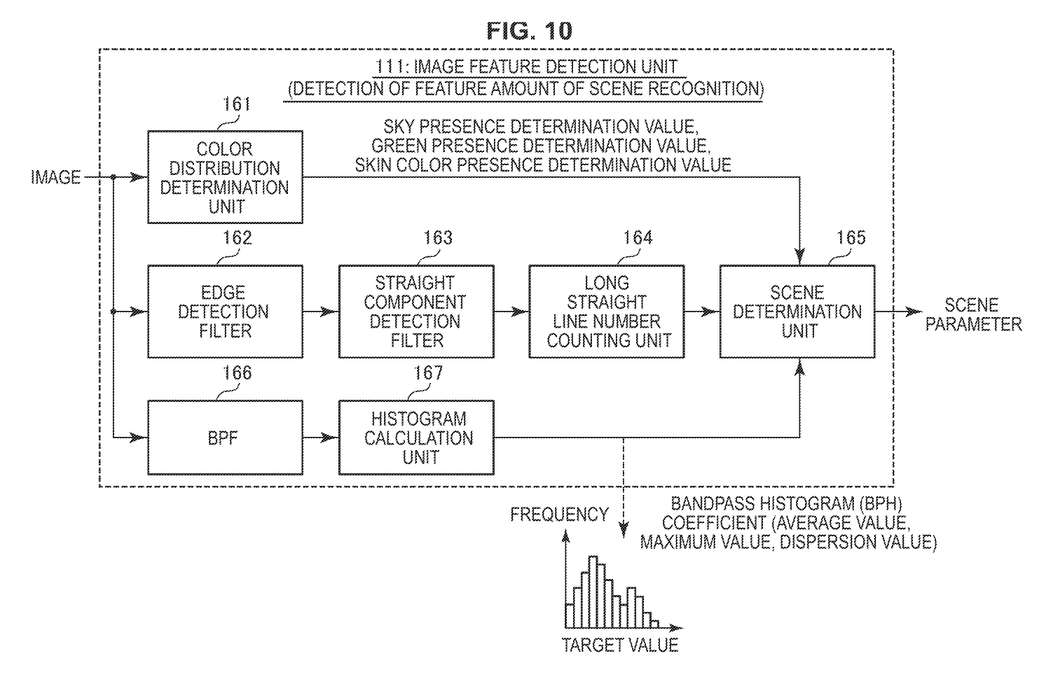

When a scene recognition feature amount is used as the image feature amount, the image feature detection unit 111 has a configuration shown in FIG. 10. In this case, as shown in FIG. 10, the image feature detection unit 111 mainly includes a color distribution determination unit 161, an edge detection filter 162, a straight component detection filter 163, a long straight line number counting unit 164, a scene determination unit 165, a bandpass filter 166, and a histogram calculation unit 167.

First, the input image is input to the color distribution determination unit 161, the edge detection filter 162, and the bandpass filter 166. The color distribution determination unit 161 determines a color distribution of the input image and inputs the determination result to the scene determination unit 165. The edge detection filter 162 detects edge information from the input image and inputs the detection result to the straight component detection filter 163. The straight component detection filter 163 detects straight lines from the input detection result of the edge information and inputs the detection result to the long straight line number counting unit 164.

The long straight line number counting unit 164 counts the number of long straight lines from the input detection result of the straight lines and inputs the count result to the scene determination unit 165. The component of the input image passing through the bandpass filter 166 is input to the histogram calculation unit 167. Further, when many natural objects are imaged, the output of the bandpass filter is estimated to be strong. The histogram calculation unit 167 generates a histogram of edge information of the input component and inputs information (hereinafter referred to as a BPH coefficient) regarding the generated histogram to the scene determination unit 165.

The scene determination unit 165 determines a scene based on the determination result of the color distribution determination unit 161, the output of the long straight line number counting unit 164, and the BPH coefficient. For example, the scene determination unit 165 determines a corresponding scene from a scene group of landscape, indoor, outdoor, urban, portrait, or the like. For example, since a scene image of urban or indoor is assumed to have many artificial objects, an output (the number of long lines) of the long straight line number counting unit 164 can be used as a determination value.

For example, the scene determination unit 165 determines a scene in such a manner that “the scene determination unit 165 determines an urban scene, a landscape scene, and a portrait scene when many long straight lines are present, when the upper portion of an image has a high sky presence ratio and the lower portion of the image has a high green presence ratio, and when a skin color occupies a large area, respectively.” The determination result of the scene determination unit 165 is output as a scene parameter.

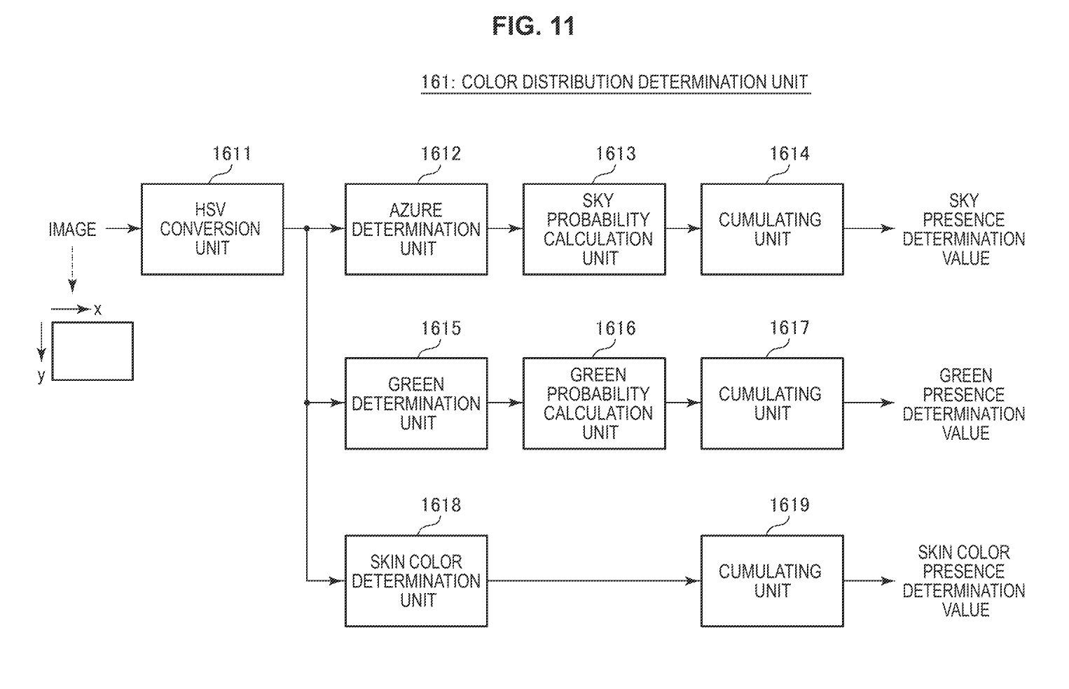

Next, the configuration of the color distribution determination unit 161 will be described in more detail with reference to FIG. 11. FIG. 11 is a diagram illustrating the configuration of the color distribution determination unit 161 in more detail.

As shown in FIG. 11, the color distribution determination unit 161 mainly includes an HSV conversion unit 1611, an azure determination unit 1612, a sky probability calculation unit 1613, cumulating units 1614, 1617, and 1619, a green determination unit 1615, a green probability calculation unit 1616, and a skin color determination unit 1618.

The image input to the color distribution determination unit 161 is first input to the HSV conversion unit 1611. The HSV conversion unit 1611 converts the input image to an expression of an HSV format. The image expressed in the HSV format by the HSV conversion unit 1611 is input to the azure determination unit 1612, the green determination unit 1615, and the skin color determination unit 1618. First, the azure determination unit 1612 determines whether an interest image is azure within the range of a hue H. When an interest pixel is azure, a flag value flag of “flag=1” is output. Conversely, when the interest pixel is not azure, a flag value flag of “flag=0” is output. The flag value flag output by the azure determination unit 1612 is input to the sky probability calculation unit 1613.

Based on the input flag value flag, the sky probability calculation unit 1613 calculates a probability “Ps(px)=(height−y)/height×flag” that an interest pixel px is sky. Here, “height” is the height of an image and y is the coordinate of the interest pixel in the height direction. The probability Ps(px) calculated by the sky probability calculation unit 1613 is input to the cumulating unit 1614. Likewise, while the interest pixel is moved in the entire image, the flag value flag and the probability Ps of each interest pixel are calculated in sequence and are input to the cumulating unit 1614. The cumulating unit 1614 cumulates the probabilities Ps calculated for all of the pixels of the image and outputs the cumulative value as a sky presence determination value.

Likewise, the green determination unit 1615 determines whether an interest pixel is green. When the interest pixel is green, the flag value flag of “flag=1” is output. Conversely, when the interest pixel is not green, the flag value flag of “flag=0” is output. The flag value flag output by the green determination unit 1615 is input to the green probability calculation unit 1616. Based on the input flag value flag, the green probability calculation unit 1616 calculates a probability “Pg(px)=y/height×flag” that the interest pixel px is green. The probability Pg(px) calculated by the green probability calculation unit 1616 is input to the cumulating unit 1617.

Likewise, while the interest pixel is moved in the entire image, the flag value flag and the probability Pg are calculated in sequence and are input to the cumulating unit 1617. The cumulating unit 1617 cumulates the probabilities Pg calculated for all of the pixels of the image and outputs the cumulative value as a sky presence determination value.

The skin color determination unit 1618 determines whether the interest pixel is skin-colored. When the interest pixel is skin-colored, the flag value flag of “flag=1” is output. Conversely, when the interest pixel is not skin-colored, the flag value flag of “flag=0” is output. The flag value flag output by the skin color determination unit 1618 is input to the cumulating unit 1619. Further, while the interest pixel is moved in the entire image, the flag value flag is calculated in sequence and is input to the cumulating unit 1619. The cumulating unit 1619 cumulates the flag values calculated for all of the pixels of the image and outputs the cumulative value as a skin color presence determination value.

As described above, the determination results (the sky presence determination value, the green presence determination value, and the skin color presence determination value) of the color distribution determination unit 161 are used to determine a scene. For example, when the azure occupies the upper portion of an image and the green color occupies the lower portion of the image, the scene of the image is determined to be a “landscape” scene. To perform this determination, a determination reference of determining where the azure and the green colors are mainly distributed is calculated. Further, with regard to the skin color, the relevance with the position in the image is low, and the area itself of the skin color occupying the image is used as the skin color presence determination value.

The configuration of the color distribution determination unit 161 has been described.

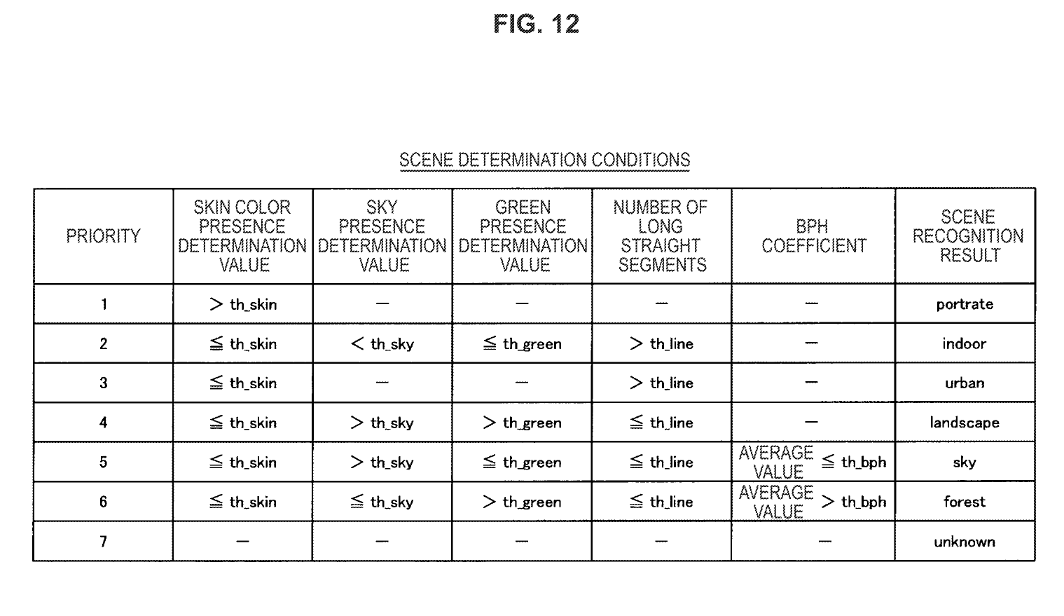

Next, specific examples of scene determination conditions used for the scene determination unit 165 to determine a scene will be introduced with reference to FIG. 12.

FIG. 12 is a diagram illustrating specific examples of the scene determination conditions used for the scene determination unit 165 to determine a scene.

In FIG. 12, th_skin indicates a skin color presence determination threshold value. In addition, th_sky indicates a sky presence determination threshold value. In addition, th_green indicates a green presence determination threshold value. In addition, th_line indicates a long straight line presence determination threshold value. In addition, th_bph indicates a natural object presence determination threshold value. In the drawing, a portion in which “−” is written is assumed not to be considered. In the example of FIG. 12, a scene determination process is assumed to be performed in accordance with a priority. Of course, the priority can be appropriately changed as necessary.

As described above, the skin color presence determination value, the sky presence determination value, the green presence determination value, the number of long straight lines, and the BPH coefficient are input to the scene determination unit 165. In the example of FIG. 12, the scene determination unit 165 first determines whether skin color determination value>th_skin. When skin color determination value>th_skin, the scene determination unit 165 determines that the scene of a target image is “portrait” and outputs the determination result as a scene recognition result. When skin color determination value th_skin, the scene determination unit 165 determines whether all of the conditions “skin color determination value<th_sky,” “green presence determination value th_green,” and “number of long straight lines>th_line” are satisfied. When all of the conditions are satisfied, the scene determination unit 165 determines that the scene of the target image is “indoor” and outputs the determination result as the scene recognition result.

Likewise, when the input values do not satisfy the determination conditions of the second priority, the scene determination unit 165 determines whether the input values satisfy the determination conditions of the third priority. When the input values do not satisfy the determination conditions of the third priority, the scene determination unit 165 determines whether the input values satisfy the determination conditions of the fourth priority. Thus, the scene determination unit 165 sequentially verifies the determination conditions in accordance with the priority and outputs the scene recognition result when the determination conditions are satisfied. In the example of FIG. 12, when the determination conditions of the first to sixth priorities are all satisfied, the scene determination unit 165 outputs, as the scene recognition result, “unknown” indicating that the scene of the target image is not able to be recognized.

The specific example of the scene determination condition used for the scene determination unit 165 to determine a scene has been introduced. Of course, any scene determination condition other than the determination conditions of the introduced specific example can be set. Further, the scene determination unit 165 may calculate a ratio between each input value and each threshold value as a scene recognition probability and output the calculated scene recognition probability as the scene recognition result. In this case, the scene recognition probability may be converted into multivalue data and output.

### (Hierarchical Clustering)

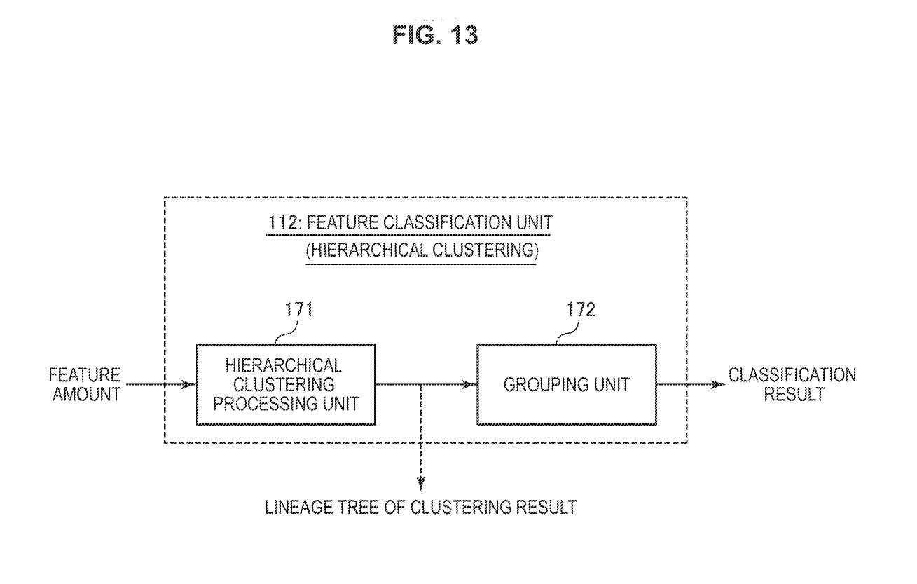

Next, the configuration and operation of the feature classification unit 112 that can classify the feature amounts based on hierarchical clustering (for example, a shortest distance method or a Ward's method) will be described with reference to FIGS. 13 to 23. FIGS. 13 to 23 are diagrams illustrating the configuration and the operation of the feature classification unit 112 that can classify the feature amounts based on the hierarchical clustering.

As shown in FIG. 13, the feature classification unit 112 mainly includes a hierarchical clustering processing unit 171 and a grouping unit 172.

When the image feature amount is input to the feature classification unit 112, the hierarchical clustering processing unit 171 classifies the images into clusters in accordance with the hierarchical clustering based on the input image feature amount. In this case, a lineage tree of the clustering result is generated and input to the grouping unit 172. When the lineage tree of the clustering result is input, the grouping unit 172 groups cluster components of the lineage tree based on the lineage tree of the cluster result. The grouping unit 172 outputs the grouping result as a classification result.

Hereinafter, the operation of the hierarchical clustering processing unit 171 will be described in more detail with reference to FIG. 14. FIG. 14 is a diagram illustrating the operation of the hierarchical clustering processing unit 171 in more detail.

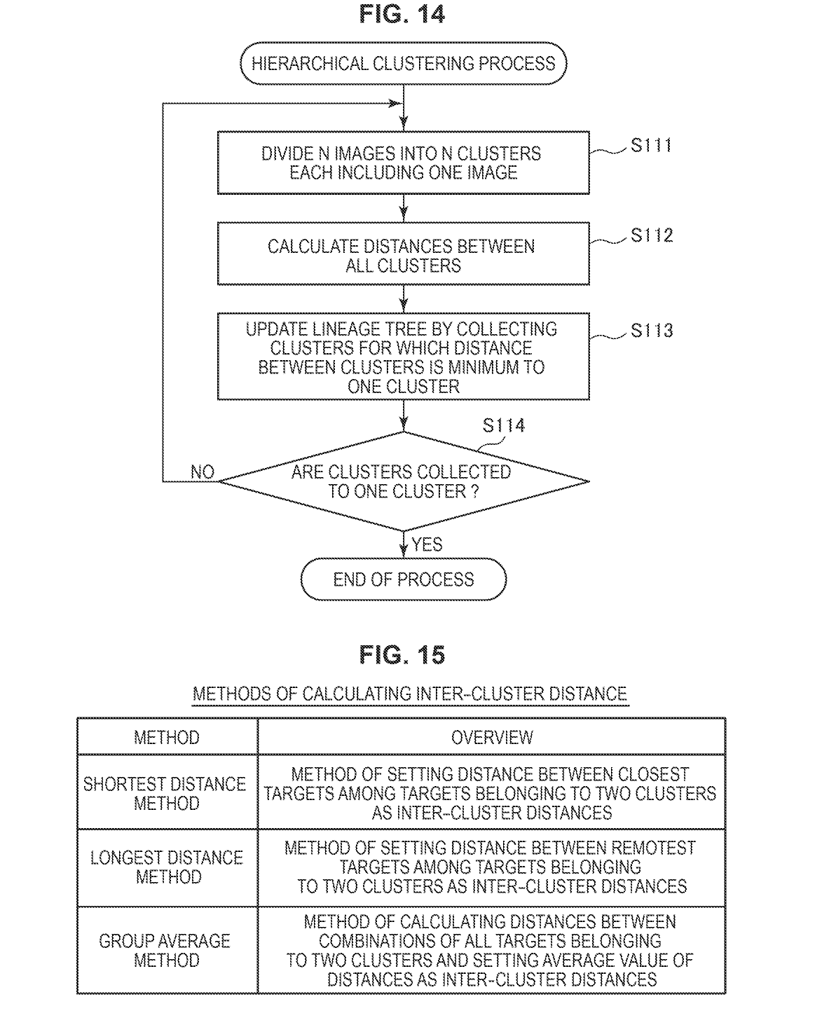

As shown in FIG. 14, the hierarchical clustering processing unit 171 starting the hierarchical clustering divides N images into N clusters which each include only one image (S111). Next, the hierarchical clustering processing unit 171 calculates all of the inter-cluster distances (S112). For example, the hierarchical clustering processing unit 171 calculates the inter-cluster distances in accordance with methods shown in FIG. 15.

Next, the hierarchical clustering processing unit 171 updates the lineage tree by collecting the clusters for which the distance between the clusters is the minimum to one cluster (S113). Next, the hierarchical clustering processing unit 171 determines whether the clusters are collected to one cluster (S114). When the clusters are collected to one cluster, the hierarchical clustering processing unit 171 ends the hierarchical clustering process. Conversely, when the clusters are not collected to one cluster, the hierarchical clustering processing unit 171 returns the process to step S111.

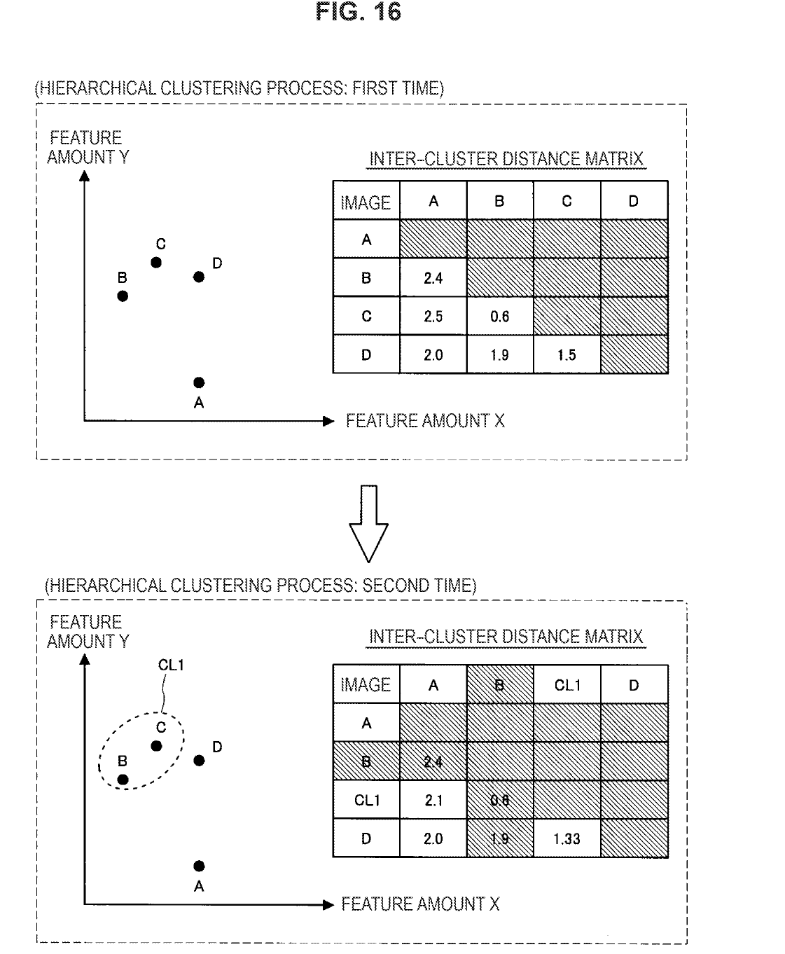

For example, as shown in FIG. 16, in the first hierarchical clustering process, images corresponding to points A to D disposed on a feature amount space can be associated with clusters A to D based on the image feature amounts. The inter-cluster distances are expressed by an inter-cluster distance matrix shown in FIG. 16. To facilitate the description, the feature amount space is expressed two-dimensionally. In effect, however, a multi-dimensional feature amount space is used.

Referring to the inter-cluster distance matrix shown in the upper drawing of FIG. 16, the inter-cluster distance 0.6 between the clusters B and C is the minimum. Therefore, in the second hierarchical clustering process, the clusters B and C are integrated to be collected to one cluster CL1. Then, the inter-cluster distances between the cluster CL1, and the clusters A and D are calculated and the inter-cluster distance matrix is updated.

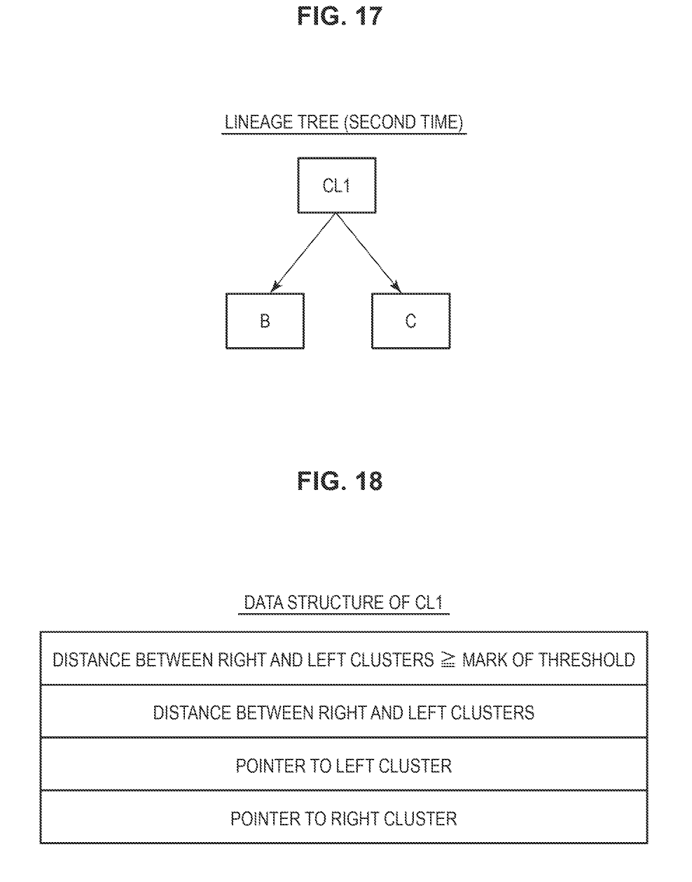

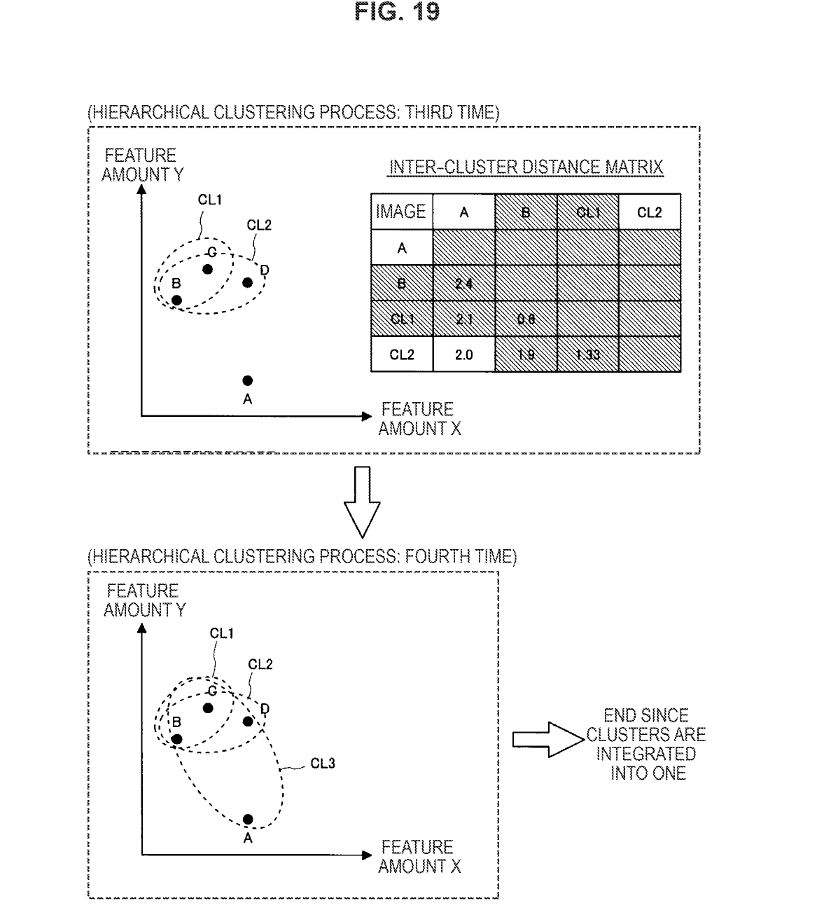

The lineage tree created in the second hierarchical clustering process is expressed as in FIG. 17. That is, in the second hierarchical clustering process, the structure of the lineage tree in which the clusters B and C belong to the cluster CL1 is created as shown in FIG. 17. For example, the cluster CL1 is expressed in a data structure shown in FIG. 18. In the example of FIG. 18, a data structure of a mark indicating whether two clusters belonging to the cluster CL1 satisfy “inter-cluster distance≧threshold value,” the inter-cluster distance, a pointer to the left cluster, and a pointer to the right cluster is expressed. By using the data structure, the attribute of the cluster CL1 can be expressed accurately.

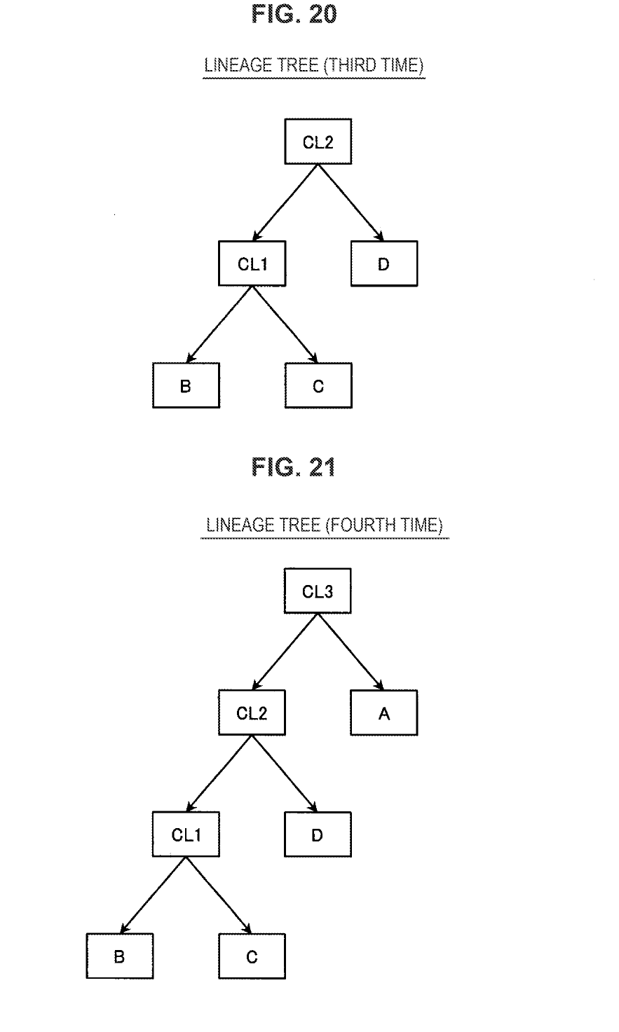

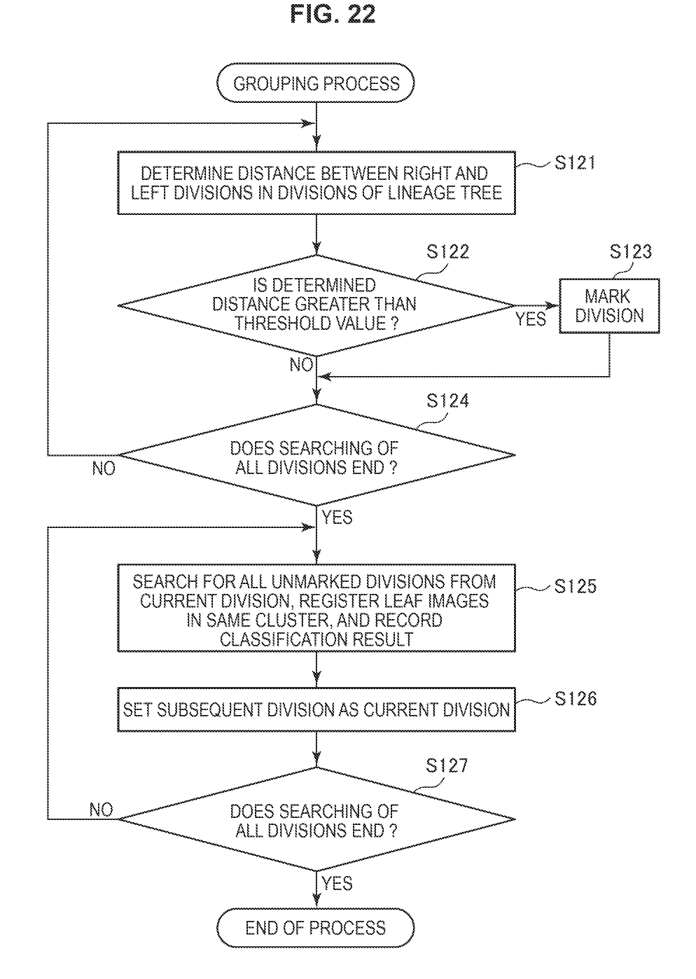

Next, referring to the inter-cluster distance matrix shown in the lower drawing of FIG. 16, the inter-cluster distance 1.33 between the clusters CL1 and D is the minimum. Therefore, in the third hierarchical clustering process, the clusters CL1 and D are integrated to be collected to one cluster CL2 (see the upper drawing of FIG. 19). Then, the inter-cluster distance between the cluster CL2 and the cluster A is calculated and the inter-cluster distance matrix is updated. At this time, the lineage tree created in the third hierarchical clustering process has a structure shown in FIG. 20. When the fourth hierarchical clustering process is performed, all of the clusters are integrated into one cluster CL3, as in the lower drawing of FIG. 19. At this time, the lineage tree created in the fourth hierarchical clustering process has a structure shown in FIG. 21.

In the shown example, since the clusters are integrated into one cluster in the fourth hierarchical clustering process, the hierarchical clustering process ends. In this way, the hierarchical clustering process is performed. Information regarding the lineage tree indicating the result of the hierarchical clustering process is input to the grouping unit 172.

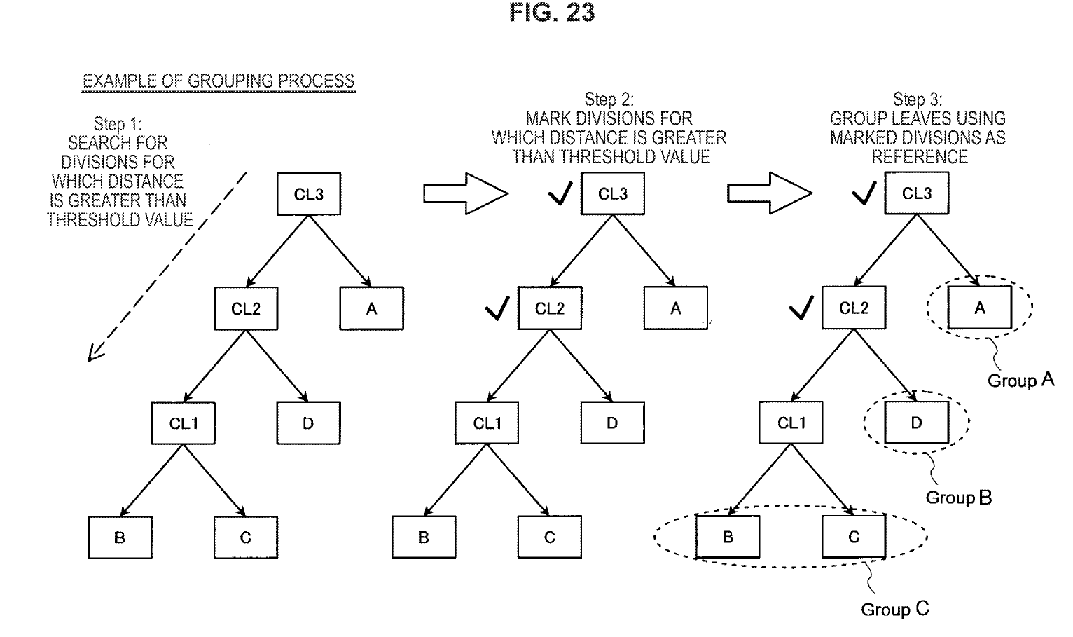

Next, the operation of the grouping unit 172 will be described in more detail with reference to FIG. 22. FIG. 22 is a diagram illustrating the operation of the grouping unit 172 in more detail.

As shown in FIG. 22, the grouping unit 172 first determines a distance (inter-cluster distance) between right and left divisions in the divisions of the lineage tree (S121). Next, the grouping unit 172 determines whether the distance determined in step S121 is greater than a threshold value (S122). When the determined distance is greater than the threshold value, the grouping unit 172 causes the process to proceed to step S123. Conversely, when the determined distance is less than the threshold value, the grouping unit 172 causes the process to proceed to step S124. When the process proceeds to step S123, the grouping unit 172 marks the division and causes the process to proceed to step S124.

When the process proceeds to step S124, the grouping unit 172 determines whether searching for all the divisions ends (S124). When searching for all the divisions ends, the grouping unit 172 causes the process to proceed to step S125. Conversely, when searching for all the divisions does not end, the grouping unit 172 causes the process to proceed to step S121. When the process proceeds to step S125, the grouping unit 172 searches for all of the unmarked divisions from the current division, registers leaf images (that is, images corresponding to the cluster dangling from the divisions) to the same cluster, and records the classification result (S125).

Next, the grouping unit 172 sets the subsequent division as the current division (S126). Next, the grouping unit 172 determines whether to end the searching of all the divisions (S127). When the searching of all the divisions ends, the grouping unit 172 outputs the grouping result as the classification result and ends the series of processes relevant to the grouping process. Conversely, when the searching of all the divisions does not end, the grouping unit 172 causes the process to proceed to step S125.

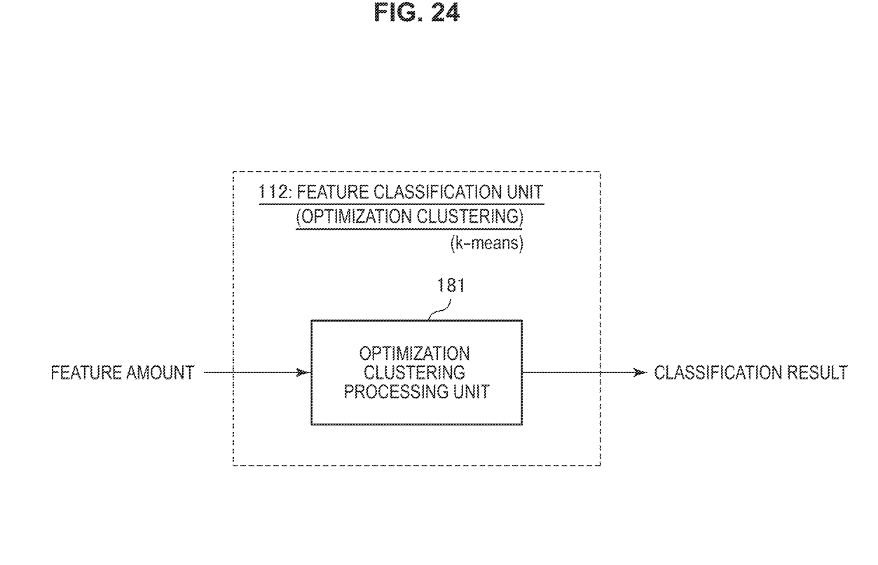

The contents of the above-described processes are expressed schematically in FIG. 23. As shown in FIG. 23, divisions for which the distance is greater than the threshold value are searched for in the first step of the grouping process. Next, the division for which the distance is greater than the threshold value is marked in the second step of the grouping process. Next, the leaf components dangling from the divisions are grouped using the divisions marked in the third step of the grouping process as a reference. By performing the grouping process in such a flow, the classification result of the images can be obtained.

### (Optimization Clustering)

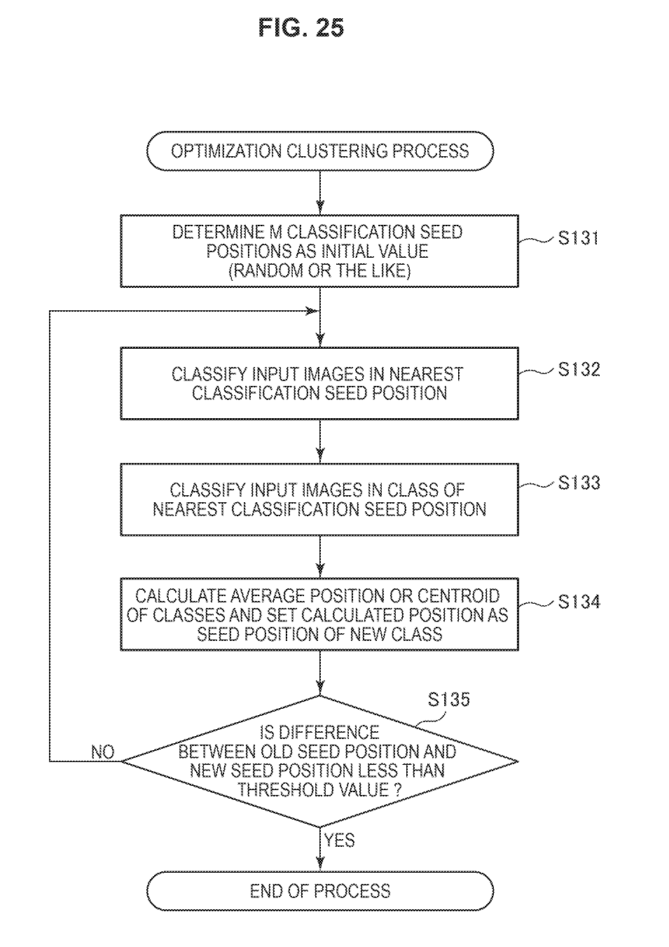

As well as the hierarchical clustering described above, an optimization clustering method such as a k-means method can be applied to the clustering process performed by the feature classification unit 112. In this case, as shown in FIG. 24, the feature classification unit 112 mainly includes an optimization clustering processing unit 181. Hereinafter, the operation of the optimization clustering processing unit 181 will be described in detail with reference to FIG. 25.

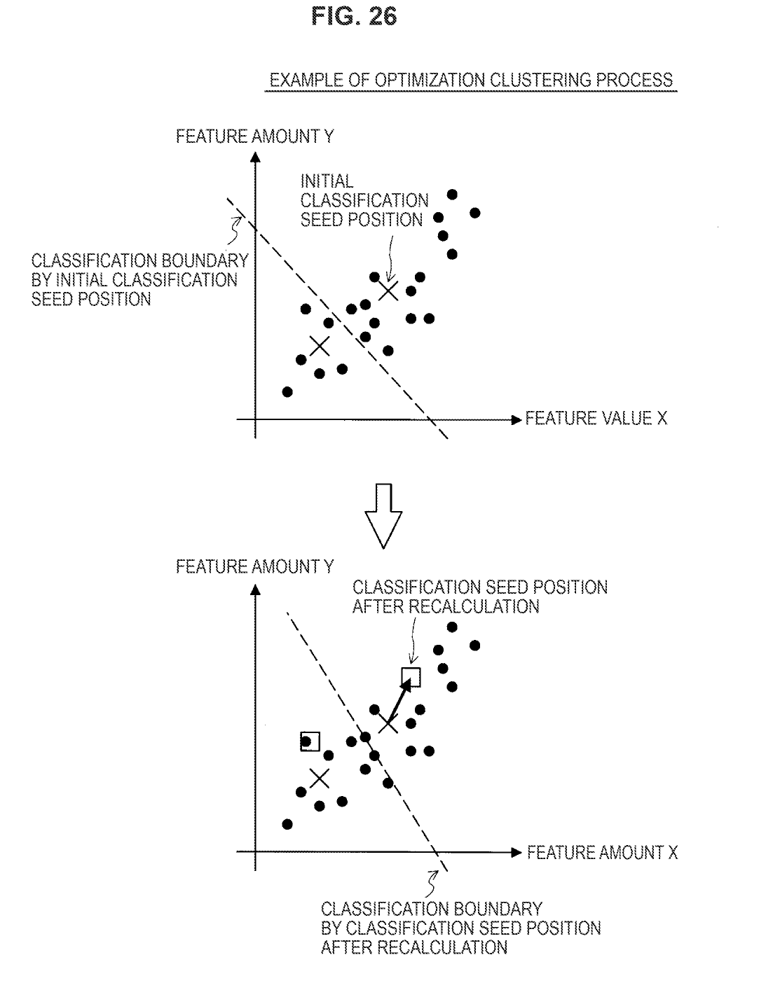

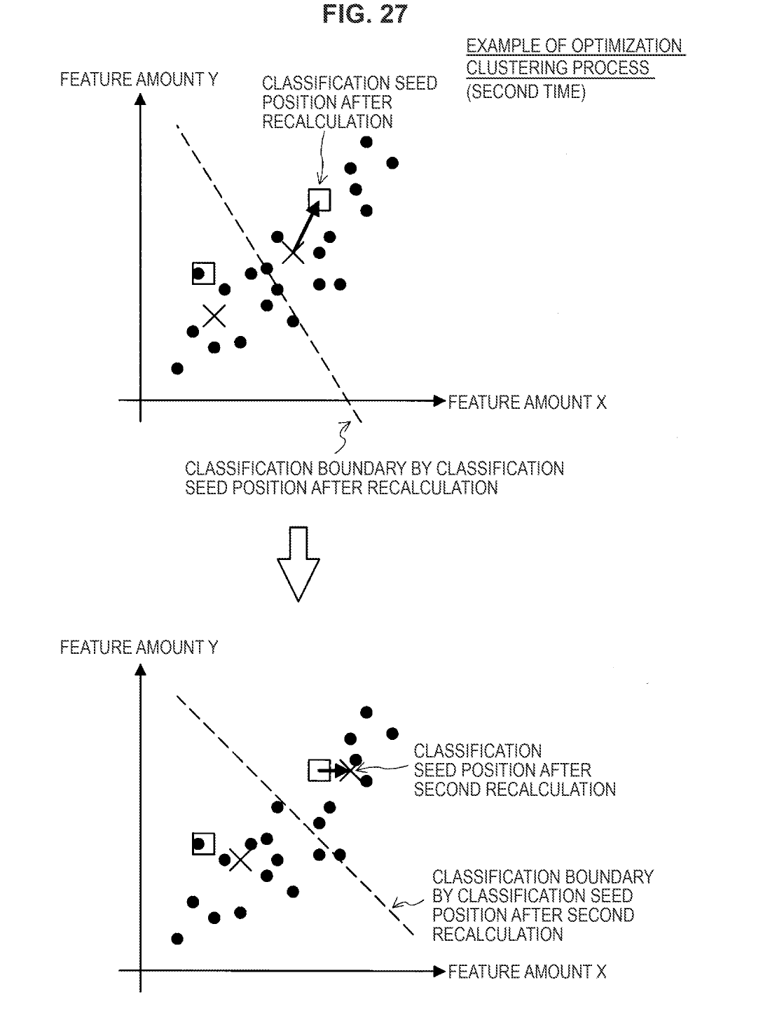

As shown in FIG. 25, the optimization clustering processing unit 181 first determines M classification seed positions as an initial value (S131). At this time, for example, the optimization clustering processing unit 181 determines the M classification seed positions at random (see the upper drawing of FIG. 26). Next, the optimization clustering processing unit 181 classifies the input images in the nearest classification seed position (S132). Next, the optimization clustering processing unit 181 classifies the input images in classes of the nearest classification seed position (S133).

Next, the optimization clustering processing unit 181 calculates the average position or the centroid of the classes and sets the position as the seed position of a new class (S134: see the lower drawing of FIG. 26). Next, the optimization clustering processing unit 181 determines whether a difference between the old seed position and the new seed position is less than a predetermined threshold value (S135). When the difference is less than the predetermined threshold value, the optimization clustering processing unit 181 ends the series of processes relevant to the optimization clustering process. Conversely, when the difference is greater than the predetermined threshold value, the optimization clustering processing unit 181 causes the process to proceed to step S132.

Specifically, as shown in FIG. 26, the optimization clustering process is performed to update the classification seed position, and determination of a threshold value is performed on a difference between the classification seed position before the updating and the classification seed position after the updating. When the difference is greater than the threshold value, as in FIG. 27, the classification seed position is updated again, and determination of the threshold value is performed on the difference between the classification seed position before the updating and the classification seed position after the updating. For example, when the difference between the classification seed position before the updating and the classification seed position after the updating is less than the threshold value after the second updating process, the optimization clustering process ends in a state in which the classification seed position after the updating is obtained as in the lower drawing of FIG. 27.

The configuration and operation of the feature classification unit 112 capable of classifying the feature amounts in accordance with the optimization clustering method have been described. To facilitate the description, the two-dimensional feature amount space has been exemplified. In effect, however, a multi-dimensional feature amount space is used.

The configuration and operation of the feature detection and classification unit 101 have been described.

### (Configuration and Operation of Representative Image Extraction Unit 102)

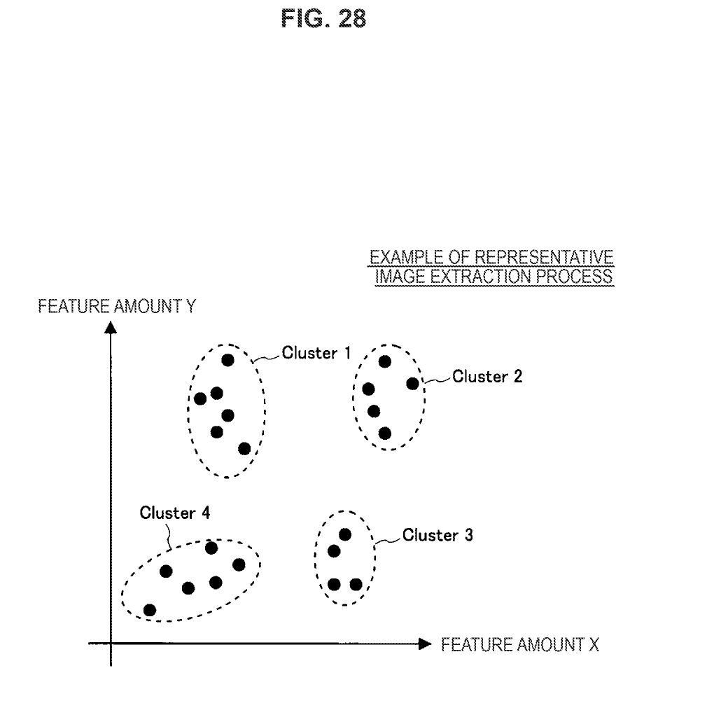

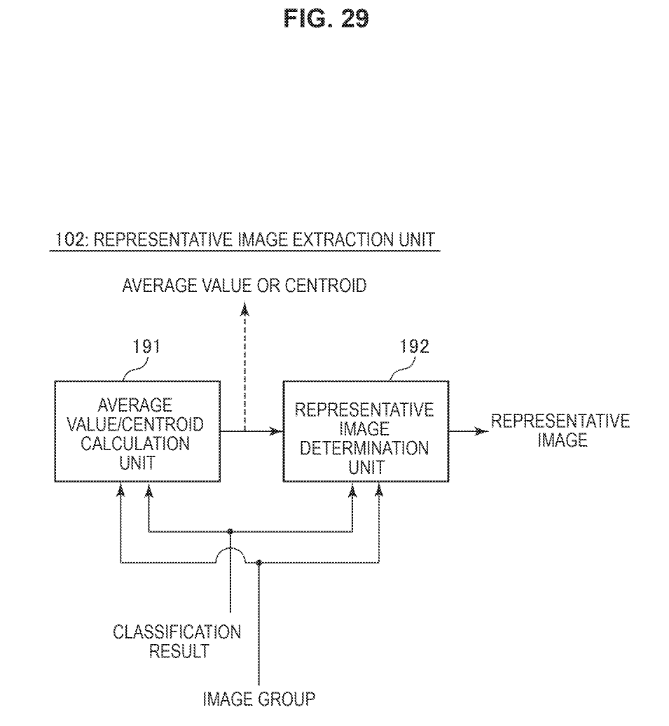

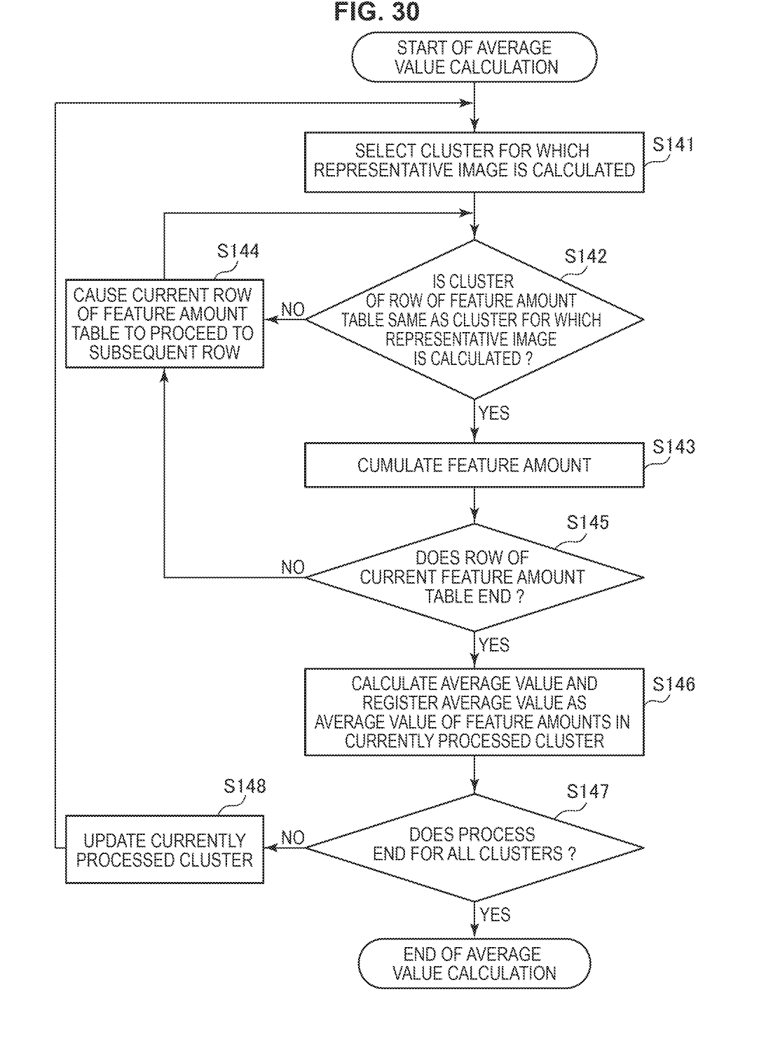

Next, the configuration and operation of the representative image extraction unit 102 will be described. The representative image extraction unit 102 extracts a representative image of each cluster based on the clustering result (see FIG. 28) obtained by the feature detection and classification unit 101. For example, the representative image extraction unit 102 extracts the representative image from each cluster by calculating the average value or centroid of the feature amounts of the images of each cluster as the axis of the cluster and selecting the image having the feature amount closest to the calculated value. As another example, the representative image extraction unit 102 may be configured to extract, as the representative image, a noticeable image such as an image in which the highest saturation region is dominant. Hereinafter, the configuration of the representative image extraction unit 102 will be described in more detail with reference to FIG. 29.

As shown in FIG. 29, the representative image extraction unit 102 mainly includes an average value/centroid calculation unit 191 and a representative image determination unit 192.

The image group considered as a clustering target and the clustering result are input to the average value/centroid calculation unit 191 and the representative image determination unit 192. When receiving the image group and the clustering result, the average value/centroid calculation unit 191 first calculates the average value or the centroid of the feature amounts of the images of each cluster. The average value or the centroid of the feature amounts calculated by the average value/centroid calculation unit 191 is input to the representative image determination unit 192. When the average value or the centroid of the feature amounts is input, for example, the representative image determination unit 192 determines, as the representative image, an image having a feature amount closest to the input average value or the input centroid of the feature amounts and outputs information regarding the determined representative image.

Next, the operation of the average value/centroid calculation unit 191 will be described in more detail with reference to FIG. 30. Here, the configuration of the average value/centroid calculation unit 191 calculating the average value of the feature amount will be exemplified. FIG. 30 is a diagram illustrating the operation of the average value/centroid calculation unit 191 in more detail.

As shown in FIG. 30, the average value/centroid calculation unit 191 starting an average value calculation process selects a cluster for which the representative image is calculated (S141). Next, the average value/centroid calculation unit 191 determines whether the cluster of a row of the current feature amount table is the same as the cluster for which the representative image is calculated (S142). When both the clusters are the same, the average value/centroid calculation unit 191 causes the process to proceed to step S143. Conversely, when both the clusters are not the same, the average value/centroid calculation unit 191 causes the process to proceed to step S144. When the process proceeds to step S143, the average value/centroid calculation unit 191 performs a feature amount cumulating process (S143).

Next, the average value/centroid calculation unit 191 determines whether the process ends for the row of the current feature amount table (S145). When the process ends for the row of the current feature amount, the average value/centroid calculation unit 191 causes the process to proceed to step S146. Conversely, when the process does not end for the row of the current feature amount, the average value/centroid calculation unit 191 causes the process to proceed to step S144. When the process proceeds to step S144, the average value/centroid calculation unit 191 updates the current feature amount table (S144) and causes the process to proceed to step S142.

When the process proceeds to step S146, the average value/centroid calculation unit 191 calculates the average value and registers the average value as the average value of the feature amounts in the currently processed cluster (S146). Next, the average value/centroid calculation unit 191 determines whether the process ends for all of the clusters (S147). When the process ends for all of the clusters, the average value/centroid calculation unit 191 ends the series of processes relevant to the average value calculation process. Conversely, when the process does not end for all of the clusters, the average value/centroid calculation unit 191 causes the process to proceed to step S148. When the process proceeds to step S148, the average value/centroid calculation unit 191 updates the currently processed cluster (S148) and causes the process to proceed to step S141.

The operation of the average value/centroid calculation unit 191 has been described.

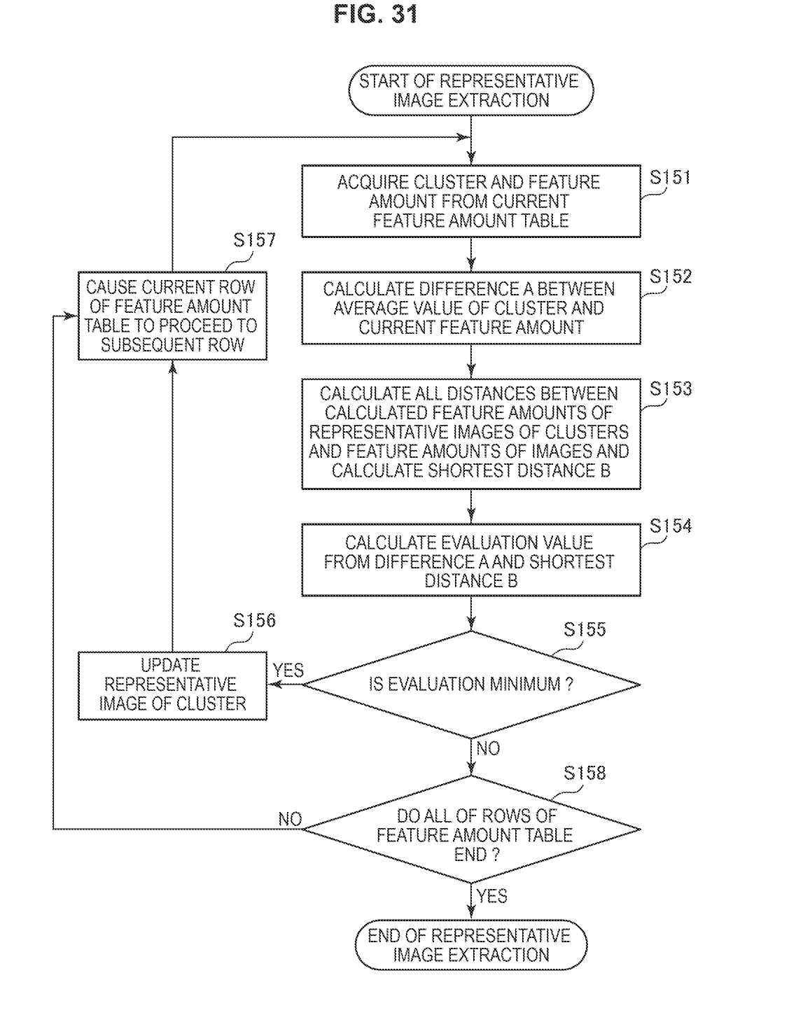

Next, the operation of the representative image determination unit 192 will be described in more detail with reference to FIG. 31. FIG. 31 is a diagram illustrating the operation of the representative image determination unit 192 in more detail.

As shown in FIG. 31, the representative image determination unit 192 starting the representative image extraction process acquires the cluster and the feature amount from the current feature amount table (S151). Next, the representative image determination unit 192 calculates a difference A between the average value of the cluster and the current feature amount (S152). Next, the representative image determination unit 192 calculates all of the distances between the calculated feature amounts of the representative images of the clusters and the feature amounts of the images and calculates the shortest distance B among the distances (S153). Next, the representative image determination unit 192 calculates an evaluation value based on the difference A and the shortest distance B (S154).

Next, the representative image determination unit 192 determines whether the evaluation value calculated in step S154 is the minimum (S155). When the evaluation value is the minimum, the representative image determination unit 192 causes the process to proceed to step S156. Conversely, when the evaluation value is not the minimum, the representative image determination unit 192 causes the process to proceed to step S158. When the process proceeds to step S156, the representative image determination unit 192 updates the representative image of the cluster (S156). Next, the representative image determination unit 192 updates the current row of the feature amount table to the subsequent row (S157) and causes the process to proceed to step S151.

When the process proceeds from step S155 to step S158, the representative image determination unit 192 determines whether all of the rows of the feature amount table end (S158). When all of the rows of the feature amount table end, the representative image determination unit 192 ends the series of processes relevant to the representative image extraction process. Conversely, when all of the rows of the feature amount table do not end, the representative image determination unit 192 causes the process to proceed to step S157.

The operation of the representative image determination unit 192 has been described.

The configuration and operation of the representative image extraction unit 102 have been described.

### (Configuration and Operation of Composite Image Generation Unit 103)

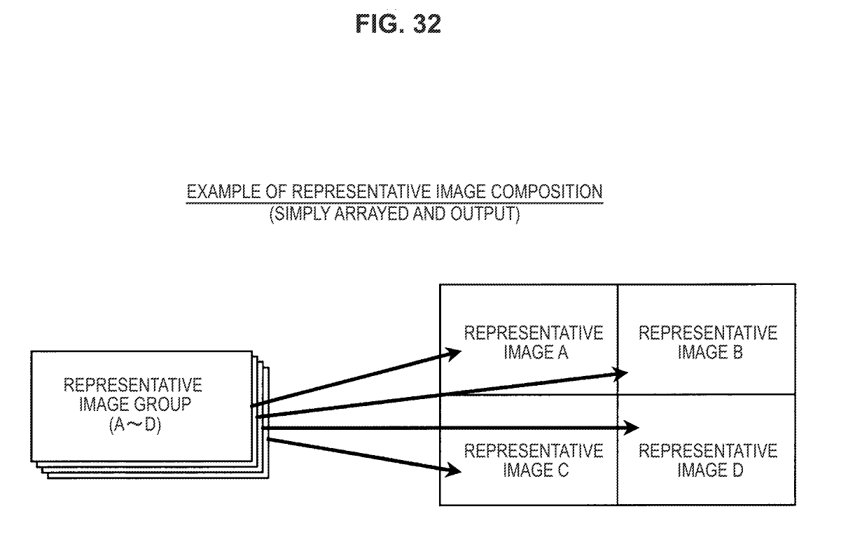

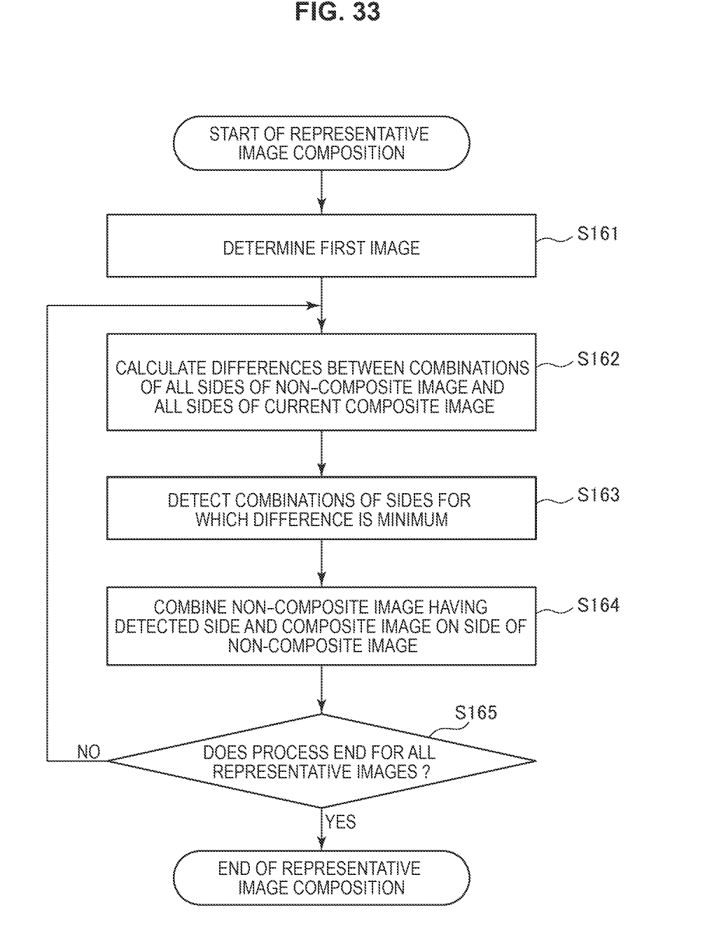

Next, the configuration and operation of the composite image generation unit 103 will be described. The composite image generation unit 103 combines the representative images extracted from the clusters to generate a composite image. As a method of generating the composite image, for example, a method of simply arraying the plurality of representative images and combining the representative images can be considered, as in FIG. 32. Here, an image composition method of seamless combining the plurality of representative images will be introduced. When the image composition method is applied, the operation of the composite image generation unit 103 is performed, as in FIG. 33.

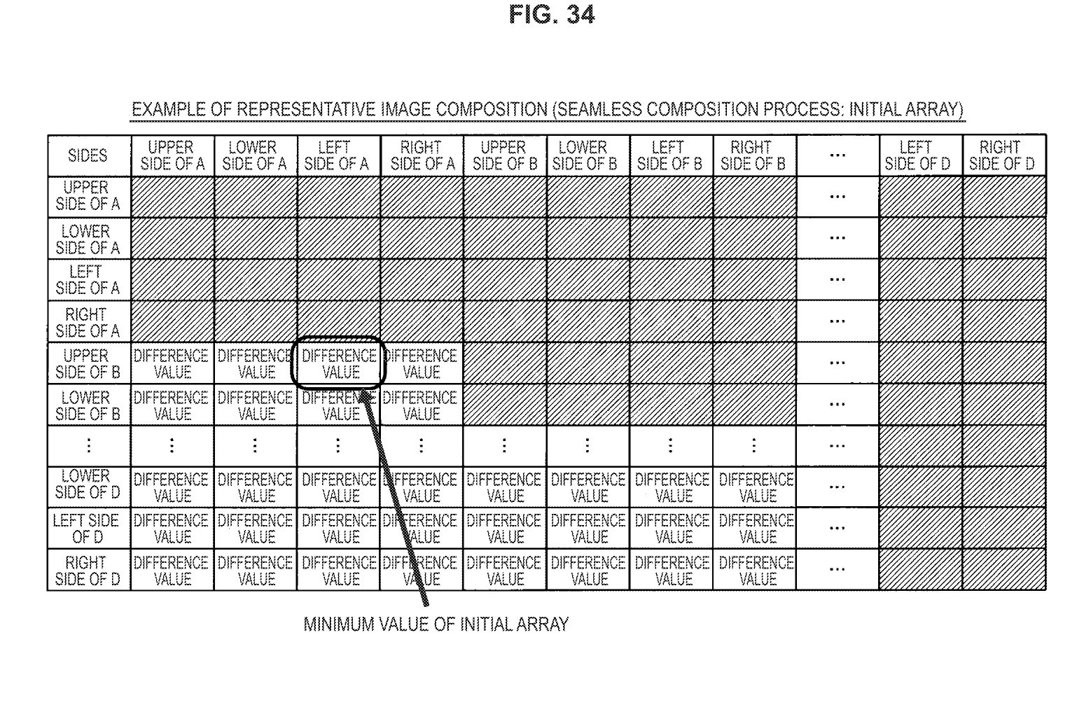

As shown in FIG. 33, the composite image generation unit 103 starting the process of combining the representative images first determines the first representative image (S161). Next, the composite image generation unit 103 calculates differences between combinations of all the sides of a non-composite image and all the sides of the current composite image (S162: see FIG. 34). The differences between the images can be obtained by an expression of calculating the degree of difference, such as a sum of squared difference (SSD), a sum of absolute difference (SAD), or a normalized cross-correlation (NCC). Next, the composite image generation unit 103 detects a combination of the sides for which the difference calculated in step S162 is the minimum (S163: see FIG. 34).

Next, the composite image generation unit 103 combines a non-composite image having the side detected in step S163 and the composite image on the side of the non-composite image (S164). At this time, the composite image generation unit 103 expands, contracts, or rotates one image as necessary, so that the composite boundaries can be the minimum to combine the sides of the images in the minimum superimposed manner. Further, to make the boundaries natural, the composite image generation unit 103 performs an LPF process, a morphing process, or the like on the composite boundary portions. Thus, the composite boundaries do not stand out in the process.

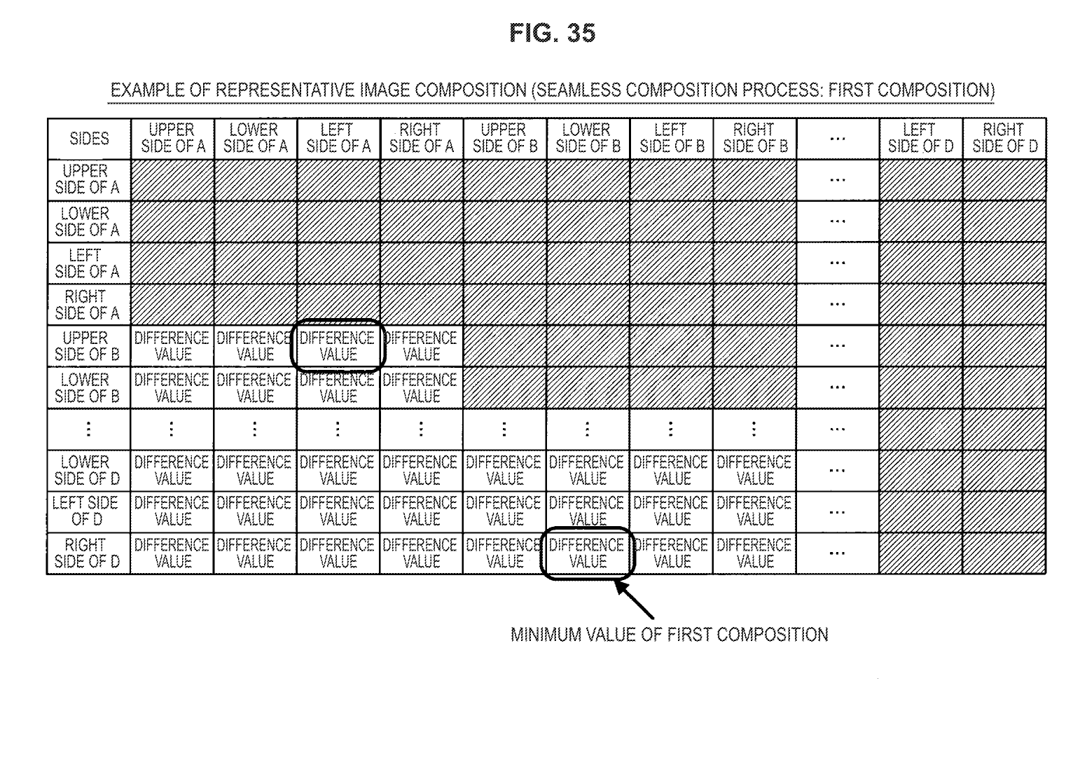

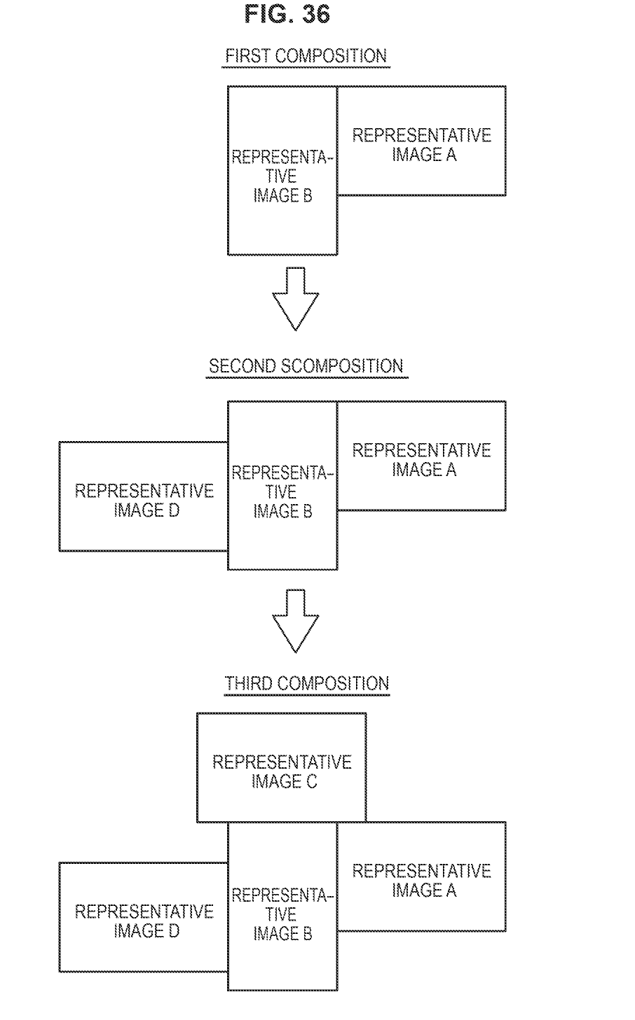

Next, the composite image generation unit 103 determines whether the process ends for all of the representative images (S165). When the process ends for all of the representative images, the composite image generation unit 103 ends the series of processes relevant to the process of combining the representative image. Conversely, when the process does not end for all of the representative images, the composite image generation unit 103 causes the process to proceed to step S162 and performs the processes of steps S162 to S165 again. For example, as shown in FIG. 35, the minimum value of the difference calculated again after the composition process performed once can be detected at a position different from that of the minimum value (see FIG. 34) of the difference calculated based on the initial array. Further, the image is further combined based on the detection result. Likewise, the representative images are combined sequentially and the composite image to be output finally is generated, as shown in FIG. 36.

The configuration and operation of the composite image generation unit 103 have been described.

The detailed configuration and operation of the information processing apparatus 10 have been described.

(2-1-4. Configuration and Operation in Which U/I Is Considered (FIGS. 37 to 44))

Hereinafter, the configuration and operation of the information processing apparatus 10 configured to choose an image to be clustered viewing a composite image via a user interface (hereinafter referred to as a U/I) and adjust various parameters will be described. In this case, the information processing apparatus 10 is modified to have a configuration shown in FIG. 37.

As shown in FIG. 37, the information process apparatus 10 is different from the information processing apparatus 10 shown in FIG. 1 in that a U/I providing unit 11 and an image selection processing unit 12 are provided. Thus, the configuration of the U/I provided by the U/I providing unit 11 and a process or the like of changing a clustering result realized using the U/I will be described with reference to FIGS. 37 to 44.

First, FIG. 37 is referred to. For example, a case in which the U/I selecting images to be clustered from an image group input to the information processing apparatus 10 is provided will be considered. In this case, when an image is selected using the U/I provided by the U/I providing unit 11, a parameter (an original image extraction parameter: ID or the like) used to extract the selected image is input to the image selection processing unit 12. When the original image extraction parameter is input, the image selection processing unit 12 extracts images (selected images) used for the clustering from the original image group based on the input original image extraction parameter. Then, the image selection processing unit 12 inputs an image group including the selected images, a feature amount of each of the selected images, a classification result, and the like to the feature detection and classification unit 101 and the like.

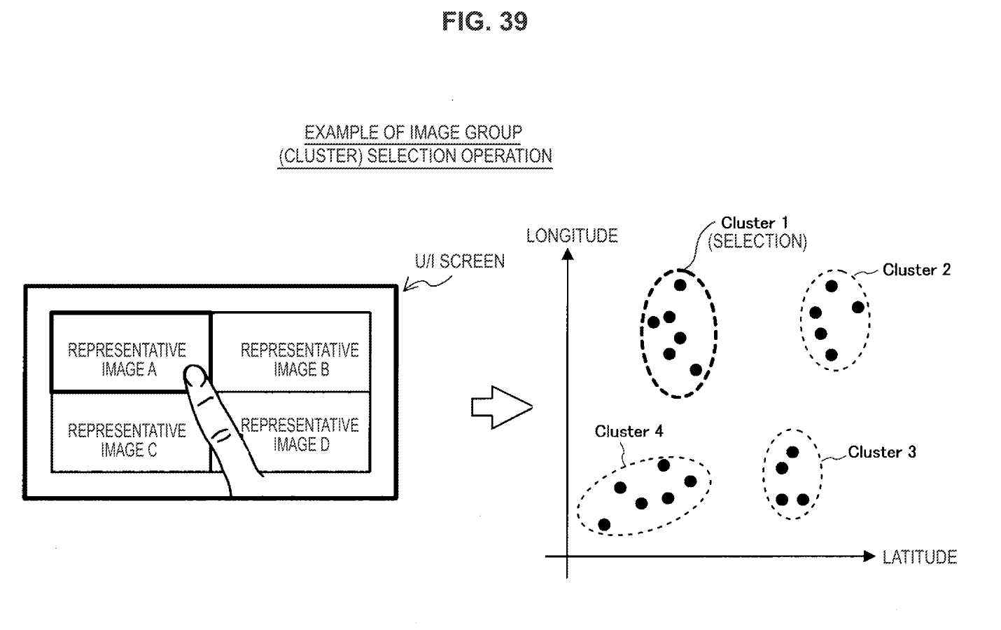

The image group including the selected images is clustered. However, the configurations and operations of the feature detection and classification unit 101, the representative image extraction unit 102, and the composite image generation unit 103 are substantially the same as the configurations and operations in the information processing apparatus 10 shown in FIG. 1. Accordingly, as shown in FIG. 38, clusters can be generated and the representative images of the clusters can be obtained. Then, the representative images of the clusters are combined to generate the composite image. The generated composite image is displayed on a U/I screen, as shown in FIG. 39. In this case, the display of the composite image is realized through the function of the U/I providing unit 11.

The U/I providing unit 11 receives a user's input on the U/I screen on which the composite image is displayed, as shown in FIG. 39. When one representative image is selected from the composite images, the cluster corresponding to the selected representative image is selected. In the example of FIG. 39, an operation of selecting representative image A of Cluster 1 is performed to select Cluster 1. Here, touch input on a touch panel is exemplified as an example of the input method. However, an input method may be performed using a mouse, a pointing device, or the like.

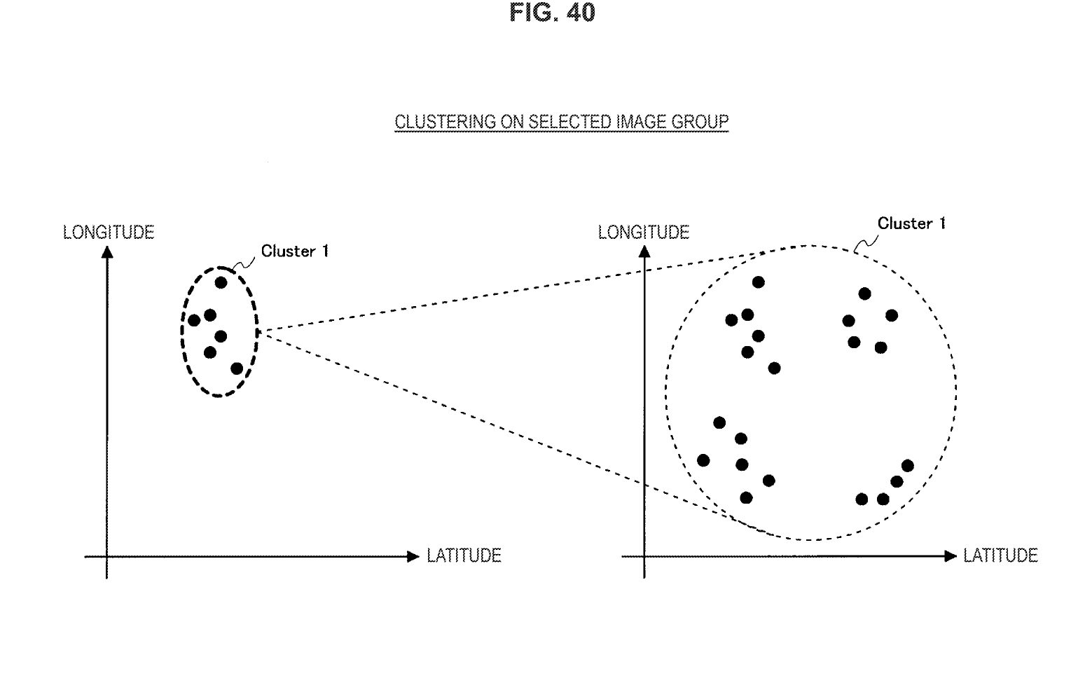

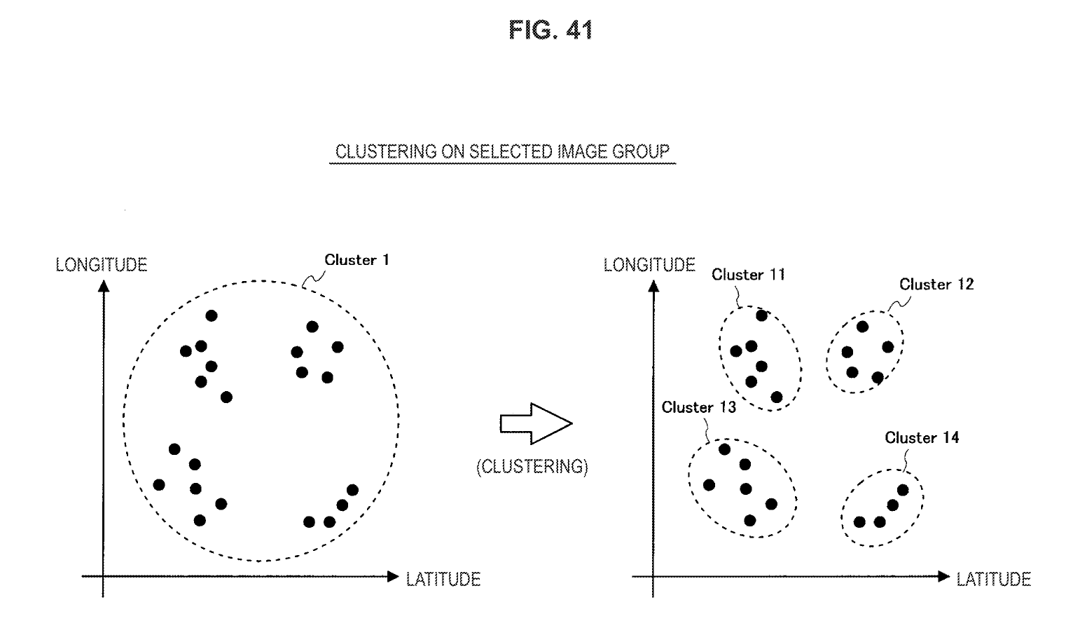

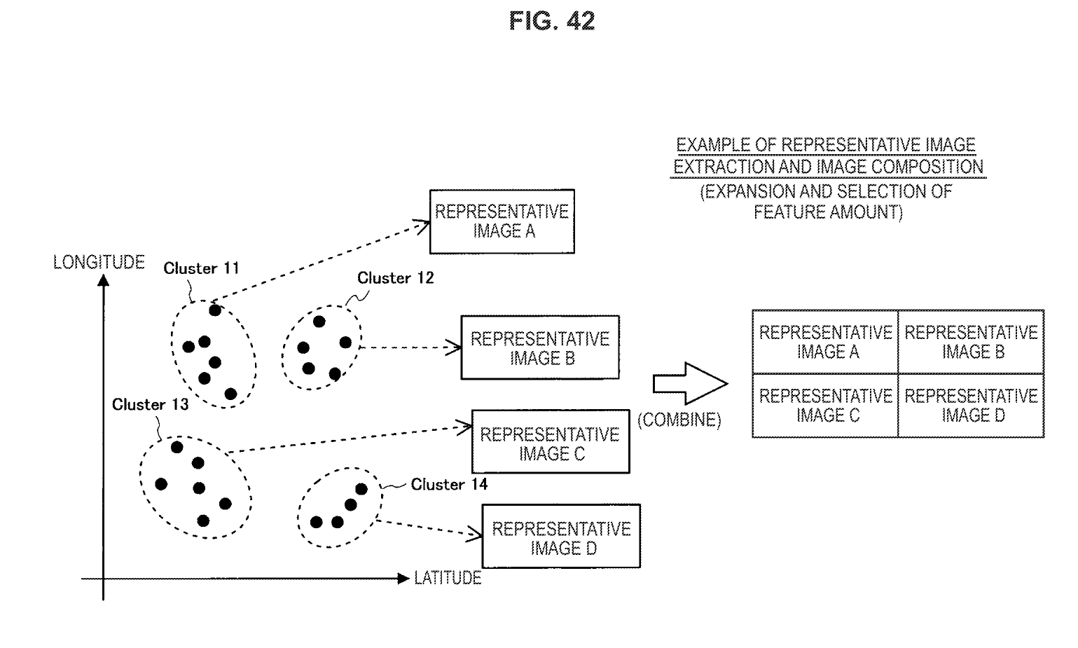

When one cluster is selected, as described above, for example, an image group included in the selected cluster is extracted and the clustering process is performed again, as necessary, as in FIG. 40 (see FIG. 41). In the example of FIG. 40, it may be misunderstood that the number of images belonging to Cluster 1 increases. However, the number of images in the cluster does not increase, but a resolution is merely increased to display the images in detail. When the clustering process is performed on the selected image group, as in FIG. 41, the representative images of the clusters are extracted and the extracted representative images are combined to generate a composite image, as in FIG. 42.

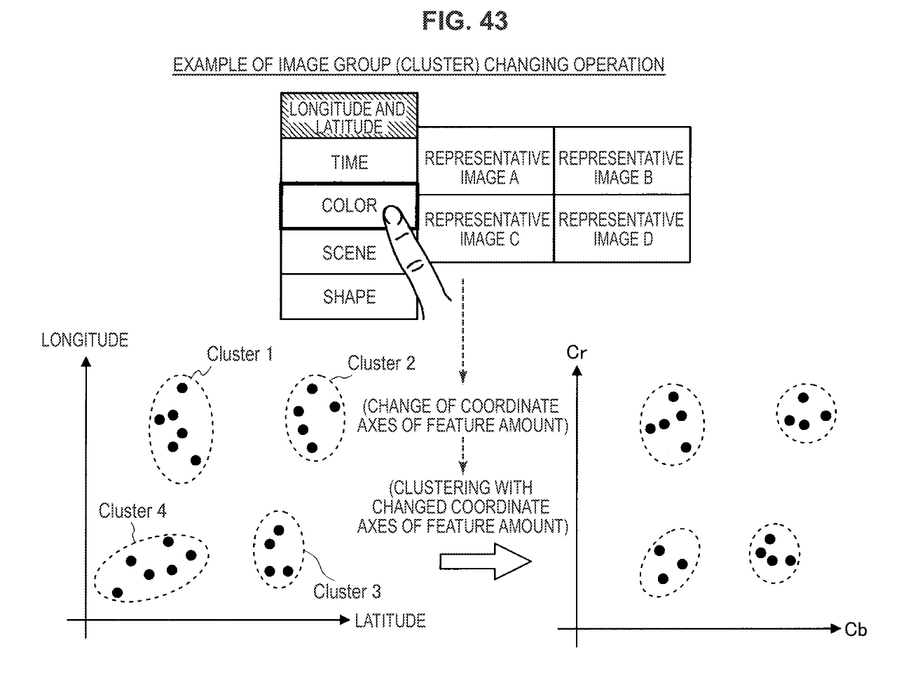

In the above-described example, the coordinate axes of the feature amount space are not changed and the U/I configuration is shown to change the resolution. On the other hand, as shown in FIG. 43, a U/I configuration can be considered to change the coordinate axes of the feature amount space. When the U/I configuration shown in FIG. 43 is applied, a user can change a kind of feature amount which serves as a reference of the clustering. In the example of FIG. 43, an operation of changing the clustering result based on the “longitude and latitude” to a clustering result based on “color (Cb, Cr)” and the result are schematically shown.

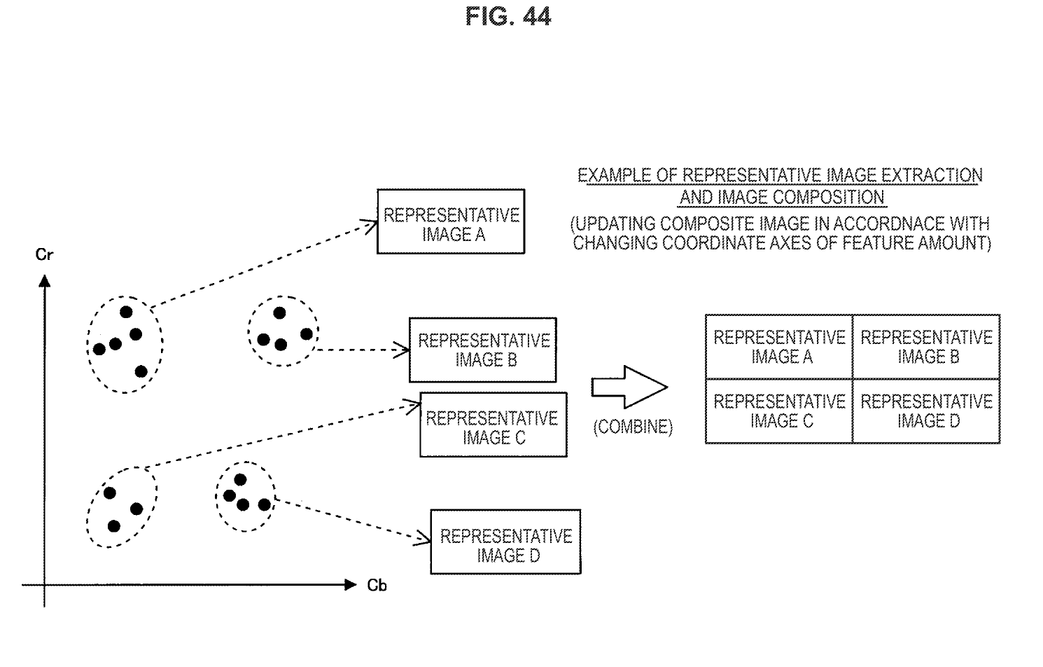

First, when the user operates the U/I to select a kind of desired feature amount, a clustering process is performed using the coordinate axes corresponding to the selected kind of feature amount as the reference. Therefore, as shown in FIG. 43, a new clustering result can be obtained. Next, as shown in FIG. 44, the representative images of the clusters are extracted based on the new clustering result, and the representative images of the clusters are combined. Then, the U/I display is updated by the newly generated composite image. By adopting the U/I configuration, the user can view the classification result of the images seamlessly based on various classification references (corresponding to the above-described rules).

The configuration and operation of the information processing apparatus 10 in which the U/I is considered have been described.

The configuration in which an image feature amount is considered using one image as a unit has been described.

[2-2. Exemplary Configuration #2 (Case in Which Region Division Is Considered)]

Next, a configuration (exemplary configuration #2) in which a plurality of division regions are subjected to the clustering process.

(2-2-1. General Configuration of Information Processing Apparatus 20 (FIG. 45))

The general configuration of an information processing apparatus 20 capable of realizing an image classification technology according to the embodiment will be described with reference to FIG. 45. FIG. 45 is a diagram illustrating the general configuration of the information processing apparatus 20 capable of realizing the image classification technology according to the embodiment.

As shown in FIG. 45, the information processing apparatus 20 mainly includes an image region division unit 201, a feature detection and classification unit 202, a representative image extraction unit 203, and a composite image generation unit 204.

When an image group to be clustered is input to the information processing apparatus 20, the input image group is input to the image region division unit 201. When the image group is input to the image region division unit 201, the image region division unit 201 divides each image included in the input image group into a plurality of regions and generates a divided image group. The divided image group generated by the image region division unit 201 is input to the feature detection and classification unit 202 and the representative image extraction unit 203. When the divided image group is input, the feature detection and classification unit 202 detects an image feature amount from each of the divided images of the input divided image group and clusters the images based on the detected image feature amounts. The result (classification result) of the clustering performed by the feature detection and classification unit 202 is input to the representative image extraction unit 203.

When the divided image group and the classification result are input, the representative image extraction unit 203 extracts a representative image of each cluster based on the input divided image group and the classification result. The representative image of each cluster extracted by the representative image extraction unit 203 is input to the composite image generation unit 204. When the representative image of each cluster is input, the composite image generation unit 204 combines the input representative images to generate a composite image. The composite image generated by the composite image generation unit 204 is displayed on a display device (not shown). The display device may be a display mounted on the information processing apparatus 20 or may be a display of a terminal apparatus that can exchange information via a network or the like.

The general configuration of the information processing apparatus 20 has been described. The configuration of the information processing apparatus 20 other than the configuration used to use the divided images is substantially the same as the configuration of the above-described information processing apparatus 10. As a region division method applicable to the embodiment, various methods can be considered. For example, a method of using an N-digitized image to be described below, a method to which the clustering method is applied, and a method to which a graph theorem is applied can be considered.

(2-2-2. Detailed Configuration and Operation of Information Processing Apparatus 20 (FIGS. 46 to 49))

Next, the detailed configuration and operation of the information processing apparatus 20 will be described with reference to FIGS. 46 to 49. FIGS. 46 to 49 are diagrams illustrating the detailed configuration and operation of the information processing apparatus 20.

### Configuration and Operation of Feature Detection and Classification Unit 202

First, FIG. 46 is referred to. As shown in FIG. 46, the feature detection and classification unit 202 mainly includes an image feature detection unit 211 and a feature classification unit 212. The image feature detection unit 211 detects an image feature amount of each divided image included in the input divided image group. The image feature amount detected by the image feature detection unit 211 is input to the feature classification unit 212. When the image feature amount is input, the feature classification unit 212 clusters the divided images based on the input feature amounts and outputs the clustering result (classification result).

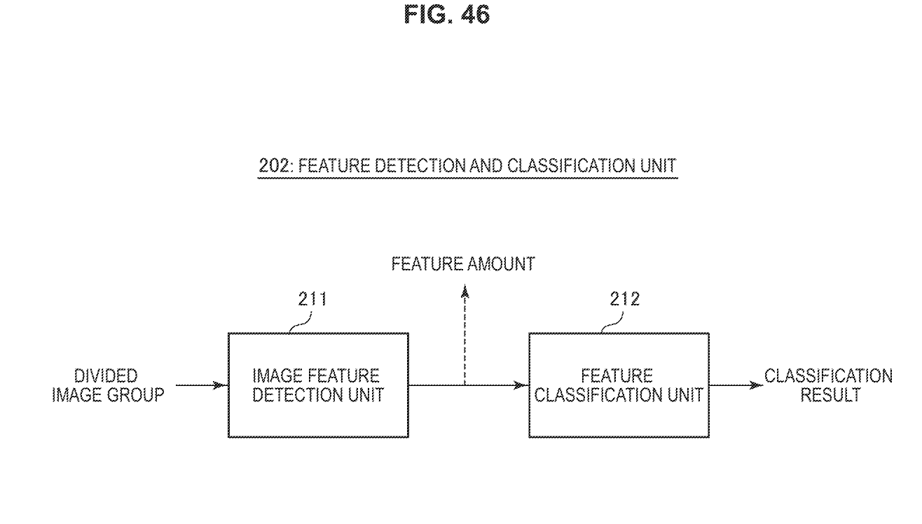

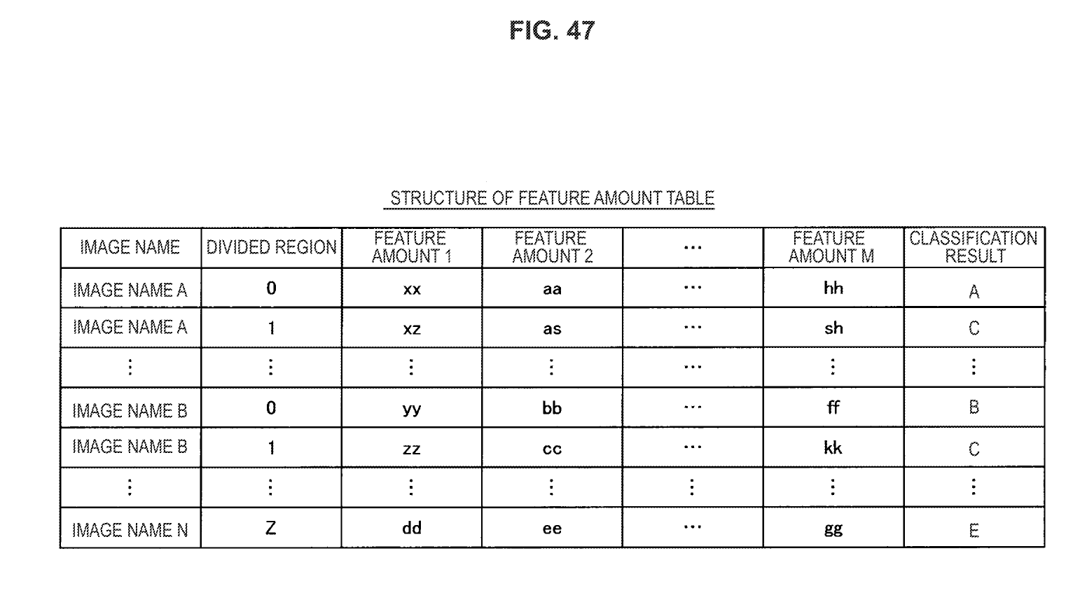

The detection result of the image feature amount obtained by the image feature detection unit 211 is able to be collected as a feature amount table shown in FIG. 47. In the example of FIG. 47, a plurality of image feature amounts (feature amounts 1 to M) are associated with classification results in each divided region of each image. Here, the field of the classification result is appended by the feature classification unit 212 after the clustering result is obtained by the feature classification unit 212. A main difference between the feature amount table shown in FIG. 47 and the feature amount table shown in FIG. 4 is that identification information (“division region” field) used to specify the divided region is added. That is, one kind of identification information used to identify each divided image is added.

The configuration and operation of the feature detection and classification unit 202 have been described. Further, the divided images are clustered, but the feature detection and classification unit 202 can have substantially the same configuration as the above-described feature detection and classification unit 101.

### Configuration and Operation of Image Region Division Unit 201

Next, FIG. 48 is referred to. As shown in FIG. 48, the image region division unit 201 mainly includes an N-digitized processing unit 221, a region integration processing unit 222, and a region division processing unit 223.

When the image to be divided is input to the image region division unit 201, the input image is input to the N-digitized processing unit 221. The N-digitized processing unit 221 generates an N-digitized image by performing N-digitization on the input image. The N-digitized image generated by the N-digitized processing unit 221 is input to the region integration processing unit 222. When the N-digitized image is input, the region integration processing unit 222 integrates a pixel considered as noise in the N-digitized image to another pixel value. As an integration method to be performed, for example, a method of using a maximum appearance pixel color filter to be described below is considered.

The image (hereinafter referred to as an N-digitized image) subjected to the integration process by the region integration processing unit 222 is input to the region division processing unit 223. The region division processing unit 223 performs region division such that the pixels having the same pixel value among the pixels of the input N-digitized image is included in the same region, and then outputs the divided image corresponding to each divided region.

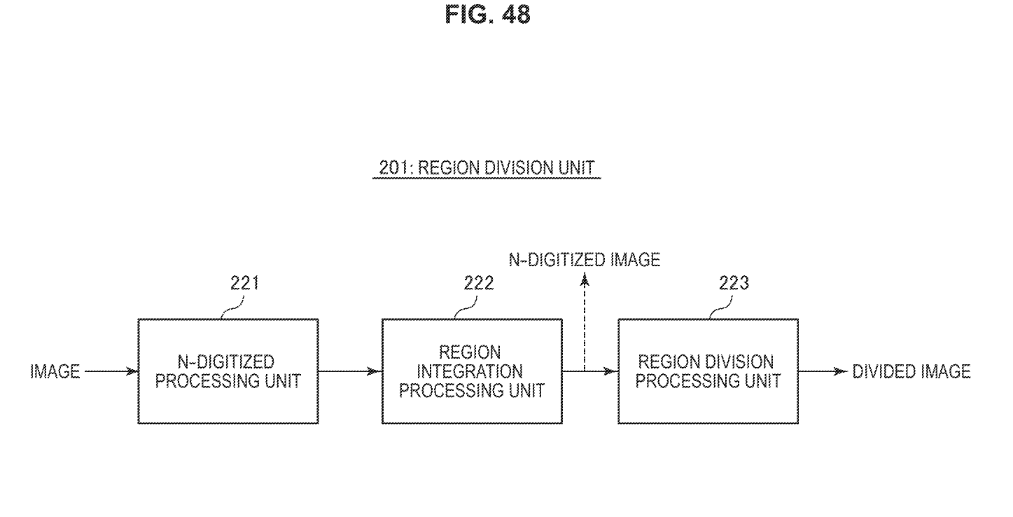

Hereinafter, the flow of a region integration process performed by the image region division unit 201 will be described with reference to FIG. 49. As shown in FIG. 49, the image region division unit 201 first acquires N by M pixels near an interest pixel (S201). Next, the image region division unit 201 calculates a pixel value A having the largest area among the N by M pixels acquired in step S201 (S202). Next, the image region division unit 201 sets the pixel value A calculated in step S202 as the pixel value of the interest pixel (S203). Next, the image region division unit 201 determines whether the process ends for all of the pixels (S204). When the process ends for all of the pixels, the image region division unit 201 ends the series of processes relevant to the region integration. Conversely, when the process does not end for all of the pixels, the image region division unit 201 causes the process to proceed to step S201.

The configuration and operation of the image region division unit 201 have been described.

The detailed configuration and operation of the information processing apparatus 20 having the configuration in which the plurality of divided regions are subjected to the clustering process have been described.

<3. Details of Overlook-Image Generation Technology>

Hereinafter, an overlook-image generation technology according to the embodiment will be described in detail.

[3-1. Entire Configuration and Operation of Information Processing Apparatus 30 (FIG. 50)]

First, the general configuration of an information processing apparatus 30 capable of realizing the overlook-image generation technology according to the embodiment will be described with reference to FIG. 50. FIG. 50 is diagram illustrating the general configuration of the information processing apparatus 30 capable of realizing the overlook-image generation technology according to the embodiment.

As shown in FIG. 50, the information processing apparatus 30 mainly includes a clustering unit 301, a representative image determination unit 302, an image composition unit 303, a display control unit 304, a display unit 305, and an operation input unit 306.

When an image group to be clustered is input to the information processing apparatus 30, the input image group is input to the clustering unit 301. When the image group is input, the clustering unit 301 clusters the input image group.

As a clustering method applicable to the process of the clustering unit 301, for example, a Nearest Neighbor method, a k-means method, an EM algorithm, or a neural network support vector machine can be used. Examples of the available axis of the image feature amount include a color (RGB or the like), an edge (a size, a direction, or the like of the pixel value of a neighboring pixel), a texture (a total sum of difference values of adjacent pixels of a pixel within a given range), object information (a segmentation result, a size or position of a region, or the like), composition information (information regarding landscape, a structural object, or the like estimated from a positional relation between image feature amounts), and meta-information (a time, a place (GPS information or the like), a tag given by a user, or the like).

The clustering result obtained by the clustering unit 301 is input to the representative image determination unit 302. When the clustering result is input, the representative image determination unit 302 determines the representative image of each cluster based on the input clustering result. For example, the representative image determination unit 302 determines the representative image of each cluster using the image feature amount used in the clustering, the maximum value, the minimum value, or the centroid of an evaluation value, or the like. The representative image of each cluster determined by the representative image determination unit 302 is input to the image composition unit 303.

When the representative image of each cluster is input, the image composition unit 303 combines the input representative images of the cluster to generate a composite image. The composite image generated by the image composition unit 303 is input to the display control unit 304. When the composite image is input, the display control unit 304 displays the input composite image on the display unit 305. Further, when one representative image included in the composite image via the operation input unit 306 is selected, the display control unit 304 acquires the composite image based on a one-layer detailed clustering result of the cluster corresponding to the representative image and displays the acquired composite image on the display unit 305.

When the representative image included in the composite image based on the most detailed clustering result is selected, the display control unit 304 changes the axes (rules) of the image feature amounts, acquires the composite image obtained from the clustering result based on the changed axes, and displays the acquired composite image on the display unit 305. Further, even when an operation of changing the axes is performed through the operation input unit 306, the display control unit 304 acquires the composite image obtained from the clustering result based on the changed axes and displays the acquired composite image on the display unit 305. The display control unit 304 may retain the clustering result based on various axes or the composite image.

The configuration of the information processing apparatus 30 has been described.

[3-2. Detailed Configuration and Operation of Information Processing Apparatus 30 (FIGS. 51 to 78)]

Next, the detailed configuration and operation of the information processing apparatus 30 will be described with reference to FIGS. 51 to 78. FIGS. 51 to 78 are diagrams illustrating the detailed configuration and operation of the information processing apparatus 30.

In FIG. 51, the functions of the clustering unit 301 and the representative image determination unit 302 are schematically shown. First, when an image group is provided, the clustering unit 301 clusters the provided image group. At this time, for example, the clustering unit 301 performs clustering based on N-kinds of rules (combinations of axes) to obtain N-kinds of clustering results. In the example of FIG. 51, a clustering result (clustering result 1) is shown on a feature amount space that has axes A and B. Further, in each clustering result shown in FIG. 51, a hatched rectangle indicates a representative image.

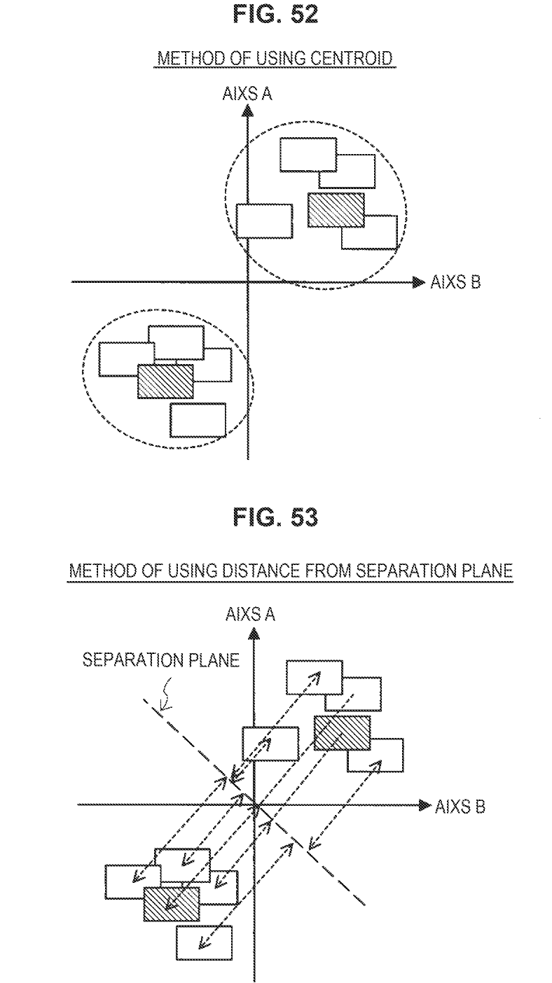

As a method of determining the representative image, for example, as in FIG. 52, a method of selecting an image closest to the centroid of an image belonging to each cluster and determining the selected image as a representative image can be considered. For example, clustering based on the k-means method is performed on images distributed in a feature amount space defined by axes A and B, and the image closest to the centroid of the feature image space from an image in each of the obtained clusters is determined as the representative image. As shown in FIG. 53, clustering by SVM is performed on images distributed in a feature amount space defined by the axes A and B, and the image with the largest distance between a separation plane and each image among the images in each of the obtained clusters is determined as the representative image.

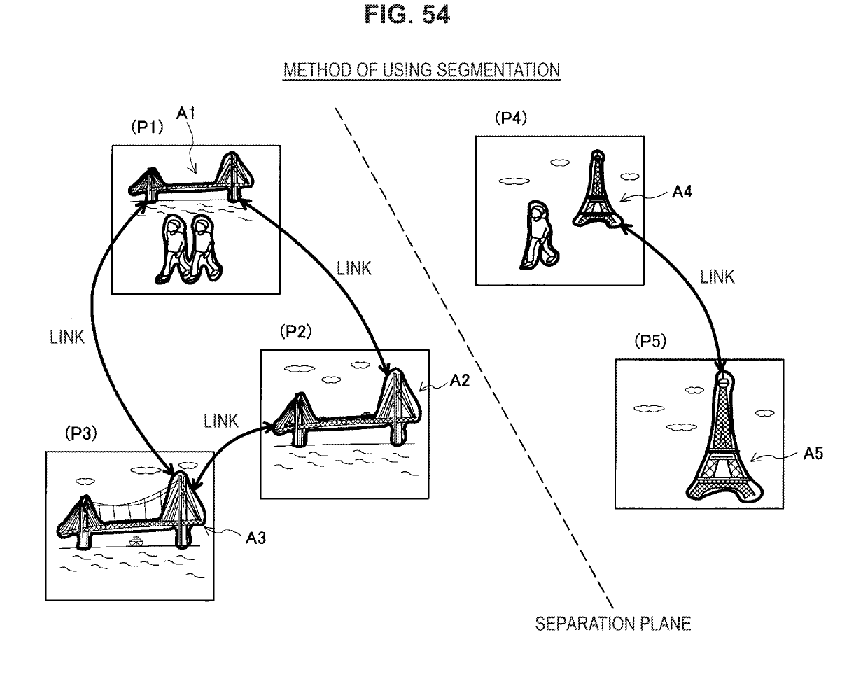

The representative image determination unit 302 may be configured to determine a representative image in accordance with a method using segmentation. Here, the method of determining a representative image using the segmentation will be described with reference to FIGS. 54 to 56.

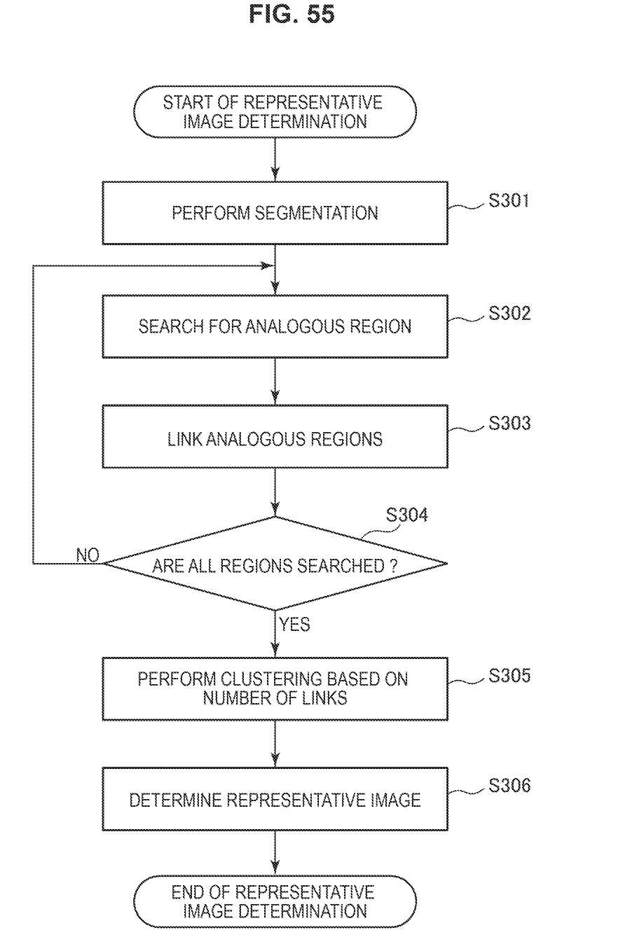

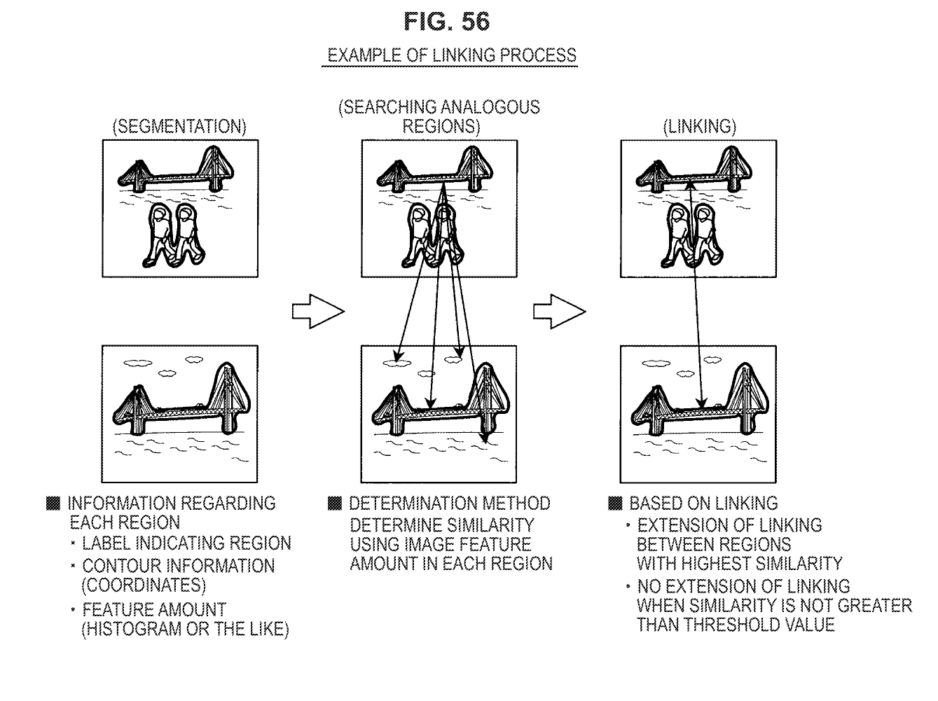

First, FIG. 55 is referred to. FIG. 55 is diagram illustrating the flow of a process performed by the representative image determination unit 302. As shown in FIG. 55, the representative image determination unit 302 first performs segmentation on an image (S301: see FIG. 56). Specifically, as shown in FIG. 54, regions of an artificial object, a natural object, a person, and the like are extracted from each image based on an edge, a texture, a color, or the like through the segmentation process. As a segmentation method, for example, a mean shift method, a graph cut method, or the like can be used.

Next, the representative image determination unit 302 searches for an analogous region in each of the divided regions of each image (S302: see FIG. 56). For example, the representative image determination unit 302 sets, as the analogous region, a region having colors (RGB) within the region or a histogram shape (bin of the maximum frequency, the maximum value, the minimum value, an average value, or the like) of edge information which is the most similar (small difference, that is, high similarity). Further, the representative image determination unit 302 may exclude a region of a sky or a ground from the colors and edge from search candidates and perform the searching process only on major subjects. Next, the representative image determination unit 302 links the analogous regions (in both directions), as in FIG. 54 and stores the similarity (S303: see FIG. 56).

Next, the representative image determination unit 302 determines whether all of the regions which are the search candidates are searched (S304). When all of the regions are searched, the representative image determination unit 302 causes the process to proceed to step S305. Conversely, when not all of the regions are searched, the representative image determination unit 302 causes the process to proceed to step S302. When the process proceeds to step S305, the representative image determination unit 302 performs the clustering based on the number of links and performs the clustering hierarchically from the image with the large number of links (S305). Next, the representative image determination unit 302 determines the representative image of each cluster (S306) and ends the series of processes relevant to the determination of the representative image. At this time, for example, the representative image determination unit 302 sets an image including the region most linked with other regions as the representative image.

The functions of the clustering unit 301 and the representative image determination unit 302 have been described.

(Movement Between Clustering Result)

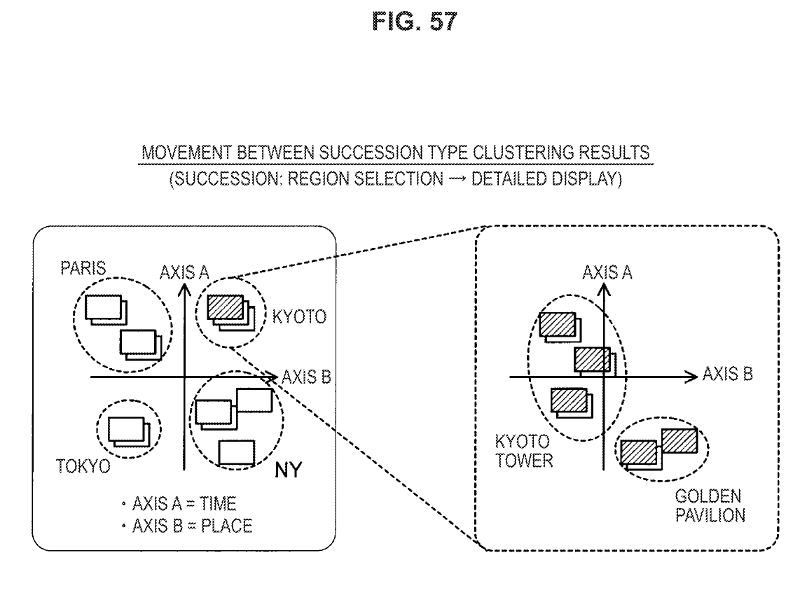

Next, movement between succession type clustering results and movement between transition type clustering results will be described with reference to FIGS. 57 to 65. FIGS. 57 to 65 are diagrams illustrating the movement between succession type clustering results and the movement between transition type clustering results.

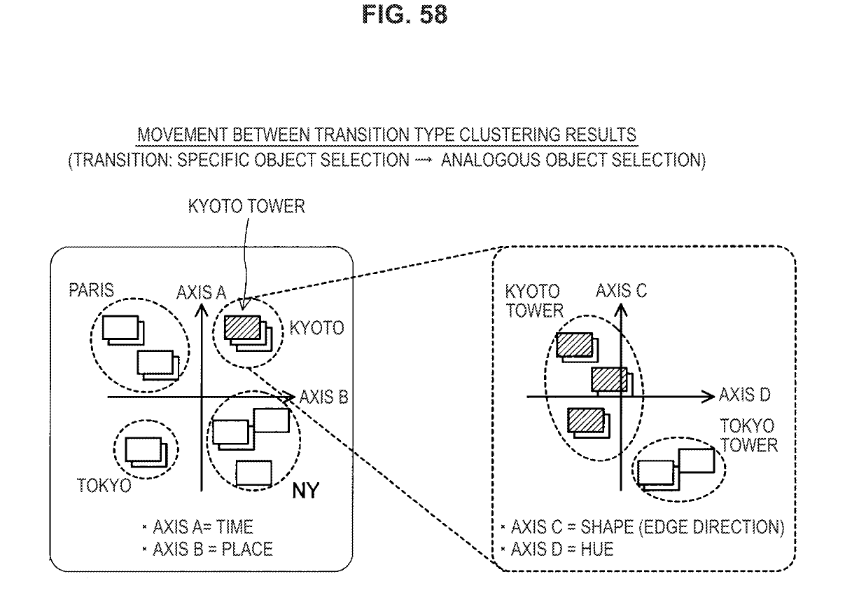

As the movement between the clustering results, there are two kinds of movement methods. One of the movement methods is a method of performing movement between the clustering results changing a resolution without a change in the coordinate axes of a feature amount space. This method is referred to as a “succession type” method below, as shown in FIG. 57. The other is a method of performing the movement between the clustering results changing the coordinate axes of a feature amount space, as shown in FIG. 58. This method is referred to as a “transition type” method. The movement between the clustering results is performed in the flow of the process shown in FIG. 59.

As in FIG. 59, when the movement between the clustering results starts, the information processing apparatus 30 performs the clustering on a target image group (S311). At this time, the information processing apparatus 30 performs the clustering in accordance with N-kinds of axes (rules) and obtains N-types of clustering results. Further, the information processing apparatus 30 determines the representative image of each cluster. Next, the information processing apparatus 30 combines the representative images of the clusters and displays the composite image (S312). Thereafter, when a user selects the images in a given cluster (S313), the information processing apparatus 30 determines whether the number of images of the selected cluster is less than or equal to a threshold value (S314).

When the number of images of the selected cluster is less than or equal to a threshold value, the information processing apparatus 30 causes the process to proceed to step S316. Conversely, when the number of images of the selected cluster is not less than or equal to a threshold value, the information processing apparatus 30 causes the process to proceed to step S315. When the process proceeds to step S315, the information processing apparatus 30 performs the movement between the succession type clustering results (S315) and causes the process to proceed to step S312. On the other hand, when the process proceeds to step S316, the information processing apparatus 30 performs the movement between the transition type clustering results (S316) and causes the process to proceed to step S312. The movement between the clustering results may be performed using the prepared clustering results or the clustering results may be calculated every time.

In the case of the method shown in FIG. 59, when the movement between the transition type clustering results is performed, completely different clustering results are displayed (hard switching). However, the movement between the clustering results should be performed while the original clustering results remain in some cases. Accordingly, a method (soft switching: see FIG. 60) of acquiring images from another clustering result and adding the acquired images to the original clustering result is suggested.

In the case of the soft switching, as in FIG. 60, when the movement between the clustering results starts, the information processing apparatus 30 performs the clustering on a target image group (S321). At this time, the information processing apparatus 30 performs the clustering in accordance with N-kinds of axes (rules) and obtains N-types of clustering results. Further, the information processing apparatus 30 determines the representative image of each cluster. Next, the information processing apparatus 30 combines the representative images of the clusters and displays the composite image (S322). Thereafter, when a user selects the images in a given cluster (S323), the information processing apparatus 30 determines whether the number of images of the selected cluster is less than or equal to a threshold value (S324).

When the number of images of the selected cluster is less than or equal to a threshold value, the information processing apparatus 30 causes the process to proceed to step S326. Conversely, when the number of images of the selected cluster is not less than or equal to a threshold value, the information processing apparatus 30 causes the process to proceed to step S325. When the process proceeds to step S325, the information processing apparatus 30 performs the movement between the transition type clustering results (S325) and causes the process to proceed to step S322. On the other hand, when the process proceeds to step S326, the information processing apparatus 30 acquires images from another clustering result, adds the acquired images to the original clustering result (S326), and causes the process to proceed to step S322. The movement between the clustering results may be performed using the prepared clustering results or the clustering results may be calculated every time.

The transition type or succession type may be selected through the U/I.

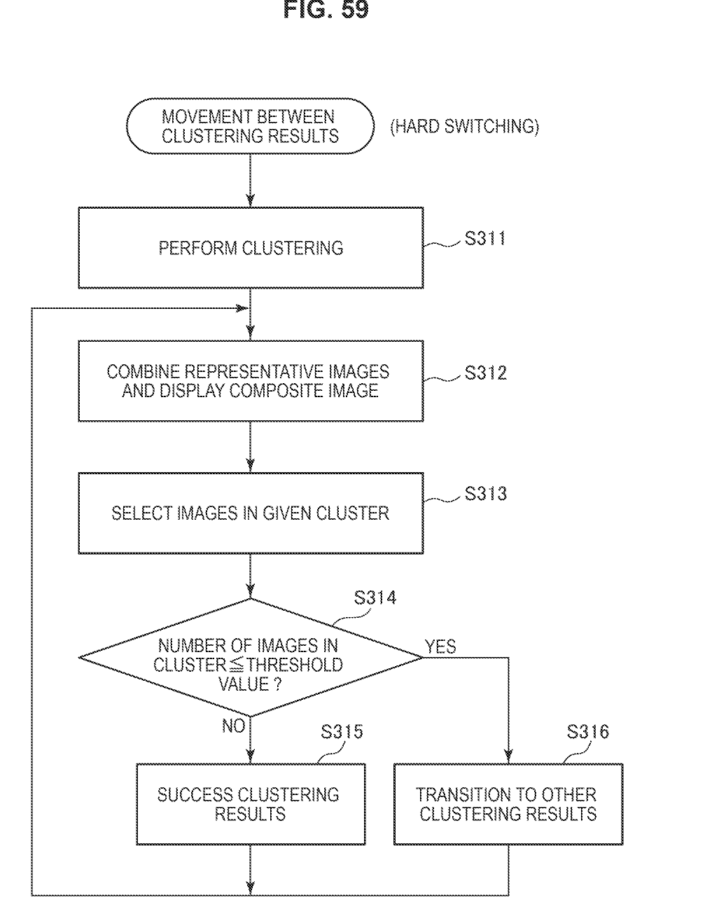

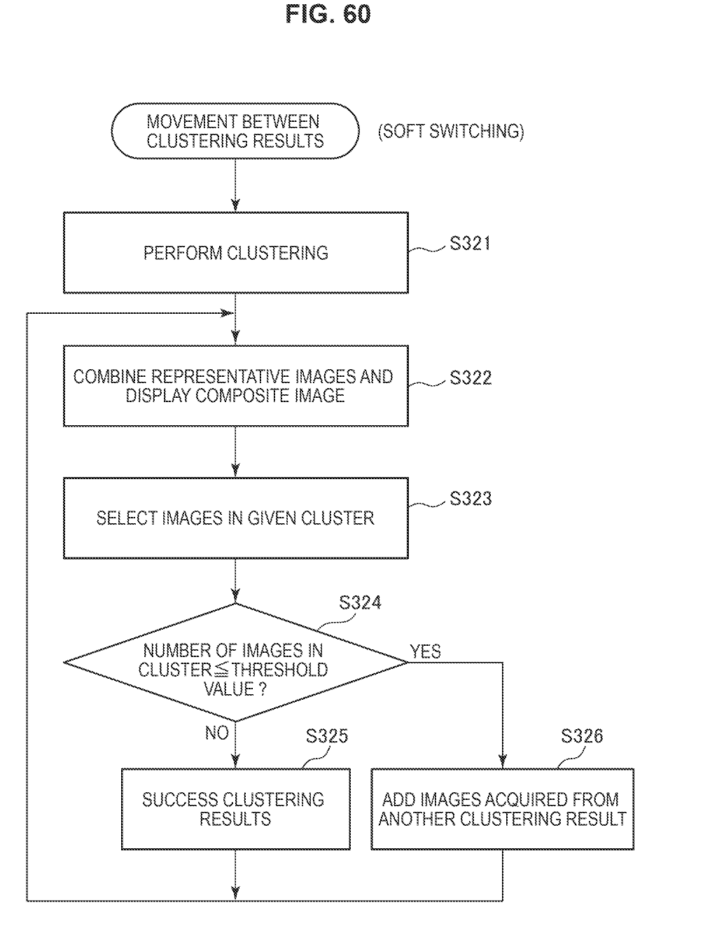

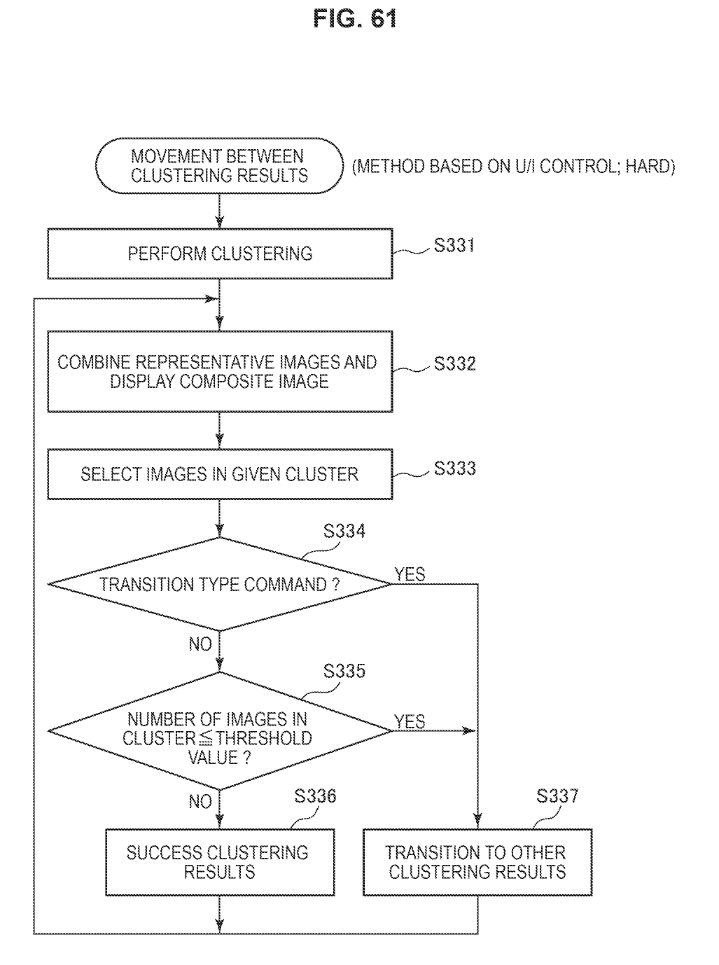

In the case of the hard switching, as in FIG. 61, when the movement between the clustering results starts, the information processing apparatus 30 performs the clustering on a target image group (S331). At this time, the information processing apparatus 30 performs the clustering in accordance with N-kinds of axes (rules) and obtains N-types of clustering results. Further, the information processing apparatus 30 determines the representative image of each cluster. Next, the information processing apparatus 30 combines the representative images of the clusters and displays the composite image (S332). Thereafter, when a user selects the images in a given cluster (S333), the information processing apparatus 30 determines whether the transition type is selected or the succession type is selected through the U/I (S334).

When the information processing apparatus 30 receives a transition type command issued at the time of selecting the transition type, the information processing apparatus 30 determines that the transition type is selected and causes the process to proceed to step S337. Conversely, when the information processing apparatus 30 receives a succession type command issued at the time of selecting the succession type, the information processing apparatus 30 determines that the succession type is selected and causes the process to proceed to step S335. When the process proceeds to step S335, the information processing apparatus 30 determines whether the number of images of the selected cluster is less than or equal to a threshold value (S335).

When the number of images of the selected cluster is less than or equal to a threshold value, the information processing apparatus 30 causes the process to proceed to step S337. Conversely, when the number of images of the selected cluster is not less than or equal to a threshold value, the information processing apparatus 30 causes the process to proceed to step S336. When the process proceeds to step S336, the information processing apparatus 30 performs the movement between the succession type clustering results (S336) and causes the process to proceed to step S332. On the other hand, when the process proceeds to step S337, the information processing apparatus 30 performs the movement between the transition type clustering results (S337) and causes the process to proceed to step S332. The movement between the clustering results may be performed using the prepared clustering results or the clustering results may be calculated every time.

In the case of the soft switching, as in FIG. 62, when the movement between the clustering results starts, the information processing apparatus 30 performs the clustering on a target image group (S341). At this time, the information processing apparatus 30 performs the clustering in accordance with N-kinds of axes (rules) and obtains N-types of clustering results. Further, the information processing apparatus 30 determines the representative image of each cluster. Next, the information processing apparatus 30 combines the representative images of the clusters and displays the composite image (S342). Thereafter, when a user selects the images in a given cluster (S343), the information processing apparatus 30 determines whether the transition type is selected or the succession type is selected through the U/I (S344).

When the information processing apparatus 30 receives a transition type command issued at the time of selecting the transition type, the information processing apparatus 30 determines that the transition type is selected and causes the process to proceed to step S347. Conversely, when the information processing apparatus 30 receives a succession type command issued at the time of selecting the succession type, the information processing apparatus 30 determines that the succession type is selected and causes the process to proceed to step S345. When the process proceeds to step S345, the information processing apparatus 30 determines whether the number of images of the selected cluster is less than or equal to a threshold value (S345).

When the number of images of the selected cluster is less than or equal to a threshold value, the information processing apparatus 30 causes the process to proceed to step S347. Conversely, when the number of images of the selected cluster is not less than or equal to a threshold value, the information processing apparatus 30 causes the process to proceed to step S346. When the process proceeds to step S346, the information processing apparatus 30 performs the movement between the succession type clustering results (S346) and causes the process to proceed to step S342. On the other hand, when the process proceeds to step S347, the information processing apparatus 30 acquires images from another clustering result, adds the images to the original clustering result (S347), and causes the process to proceed to step S342. The movement between the clustering results may be performed using the prepared clustering results or the clustering results may be calculated every time.

As a transition type selecting operation, for example, an operation or the like of designating a region by a dragging operation or a pinch-out operation can be considered, as shown in FIG. 63. In the example of FIG. 63, a touch panel is assumed to be used, but an operation performed using another input interface may be used instead. When the operation exemplified in FIG. 63 is performed, images included in the region designated by the dragging operation are selected and the transition type command is issued.

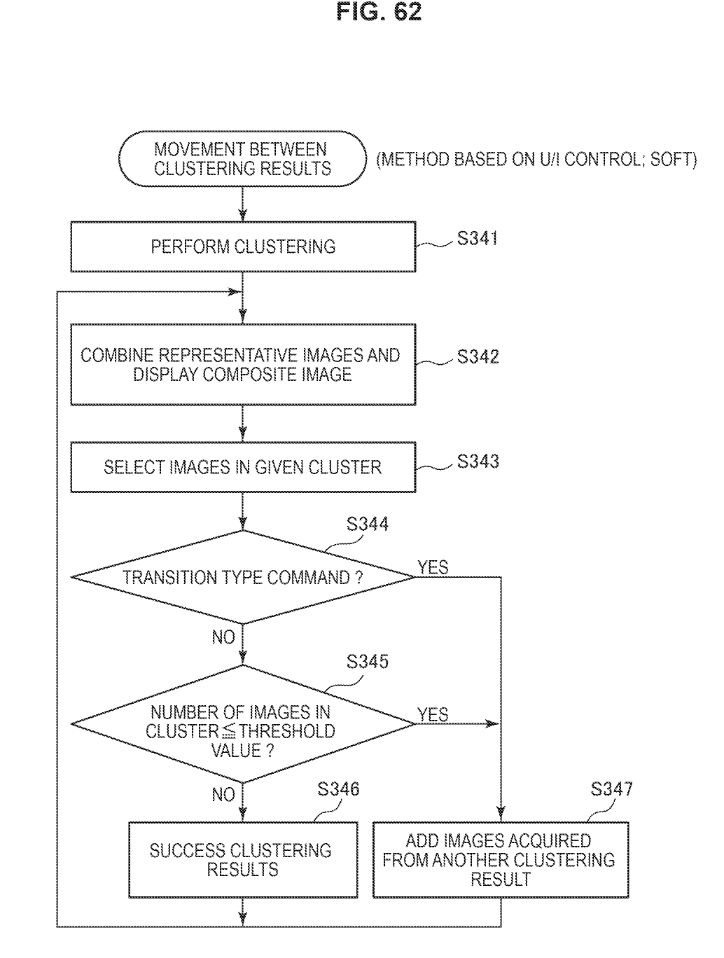

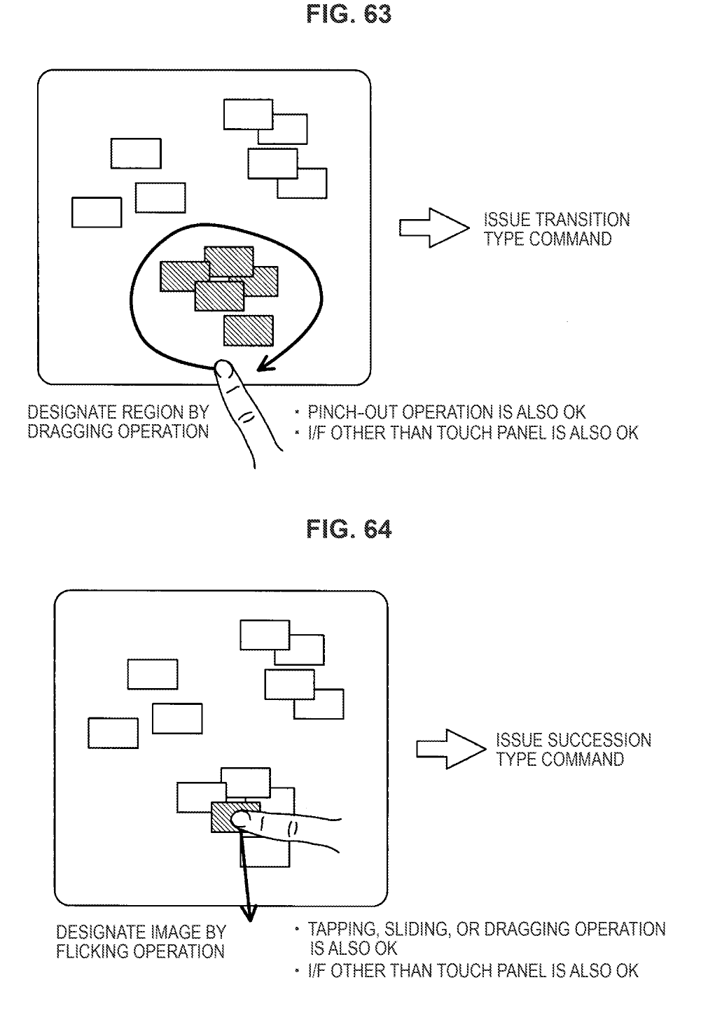

Further, as a succession type selecting operation, for example, an operation of the like of designating an image by a flicking operation, a tapping operation, a sliding operation, a dragging operation, or the like can be considered, as shown in FIG. 64. In the example, of FIG. 64, a touch panel is assumed to be used, but an operation performed using another input interface may be used instead. When the operation exemplified in FIG. 64 is performed, an image designated by the flicking operation is selected and the succession type command is issued.

As shown in FIG. 65, the transition type command or the succession type command may be configured to be issued in response to a prepared gesture. The gesture may be set in advance by a user or the gesture may be automatically set based on a use history of the user. As shown in FIG. 65, a command is configured to be issued, even when the gesture is performed on a composite image.

The movement between the succession type clustering results and the movement between the transition type clustering results have been described.

(Arraying Method and Composition Method when Combining)

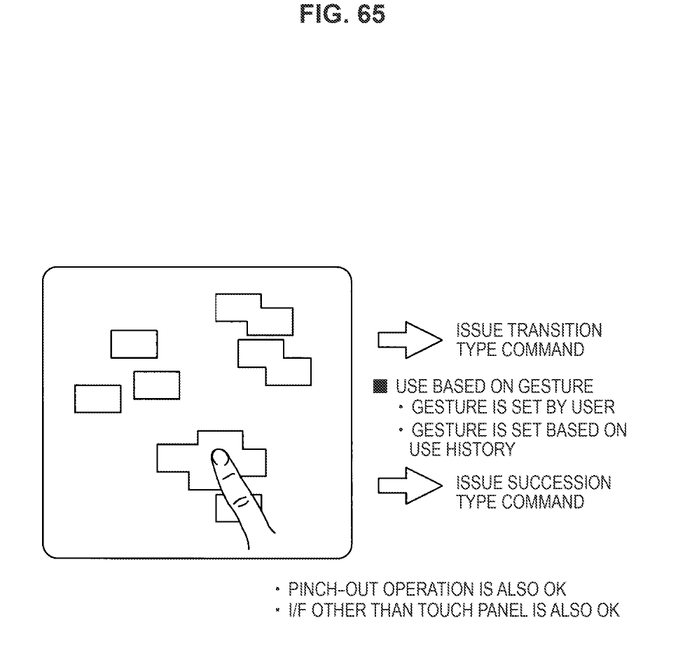

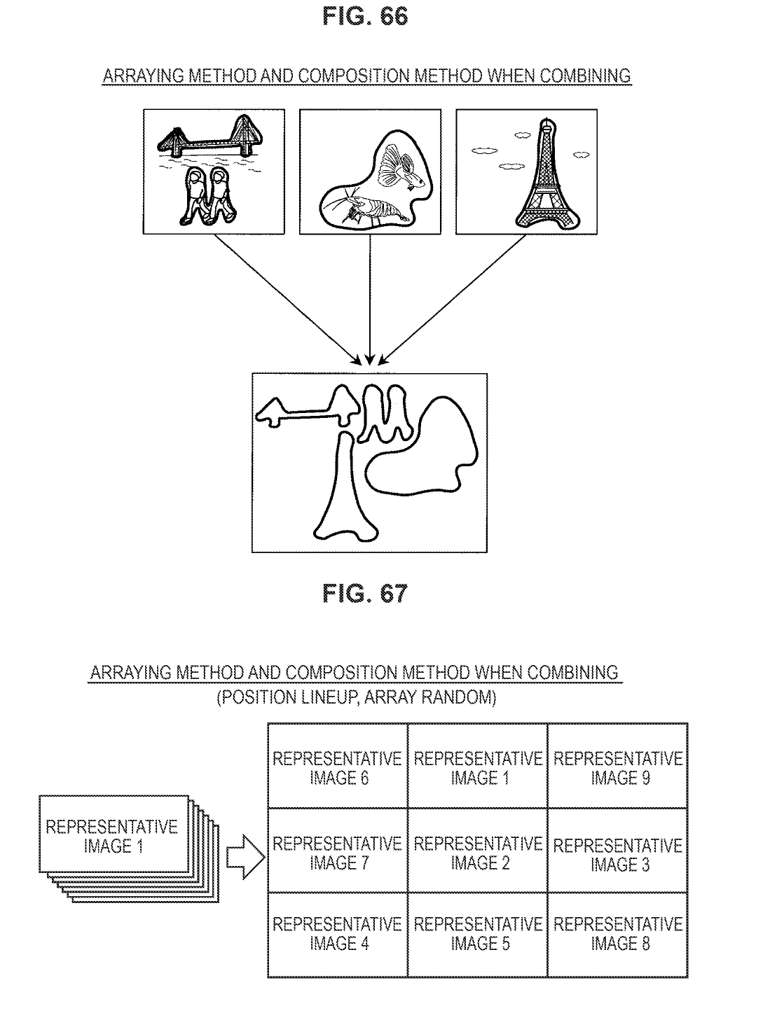

Next, an arraying method and a composition method at the time of combining the representative images will be described with reference to FIGS. 66 to 78. FIGS. 66 to 78 are diagrams illustrating the arraying method and the composition method at the time of combining the representative images. Hereinafter, a method of combining subject regions extracted from representative images and generating a composite image will be described, as shown in FIG. 66. Further, a method or the like of arraying and combining a plurality of representative images will be described as shown in FIGS. 67 and 68. These methods are realized mainly by the function of the image composition unit 303.

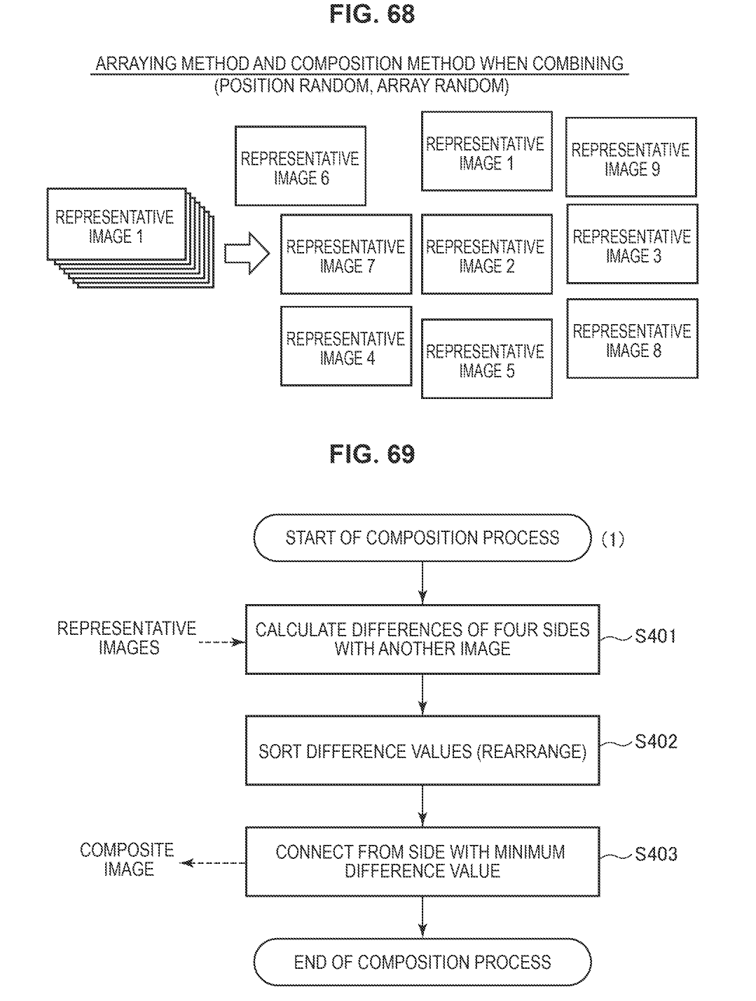

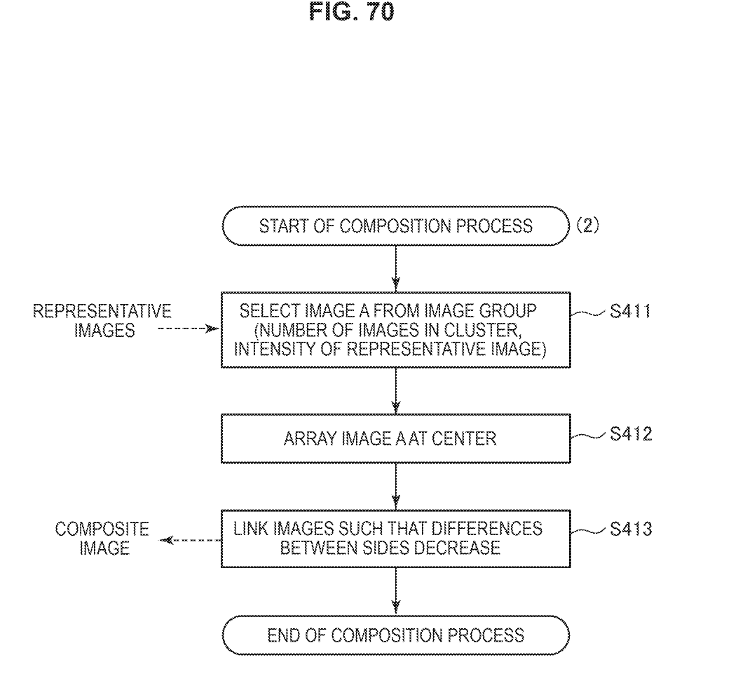

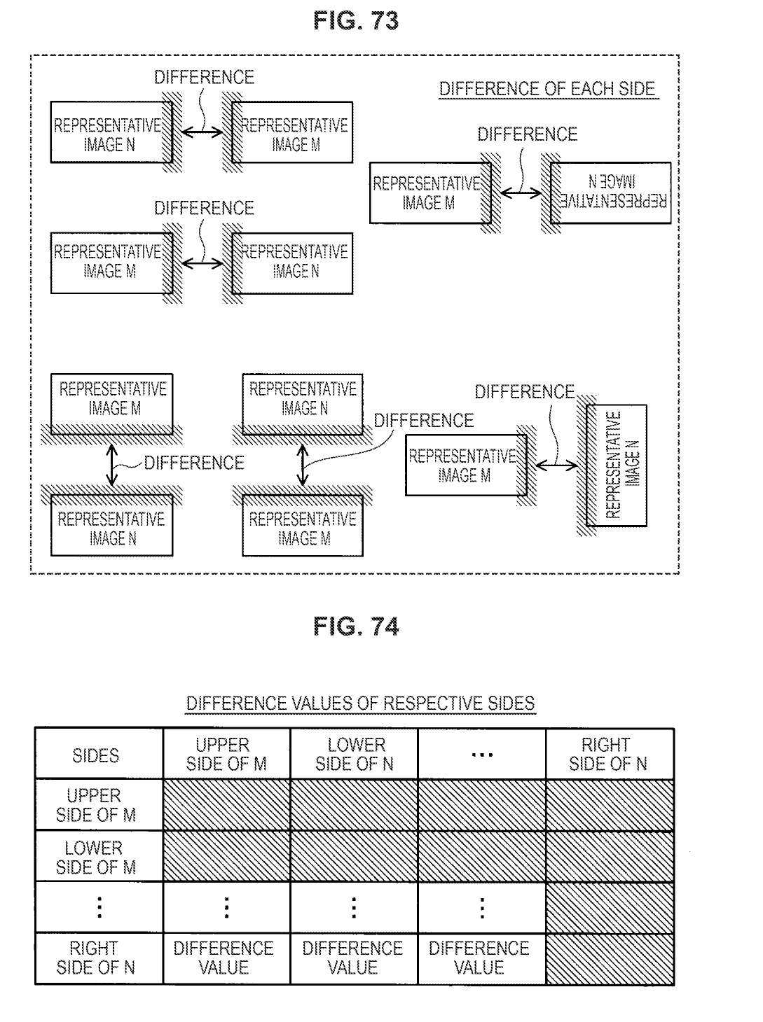

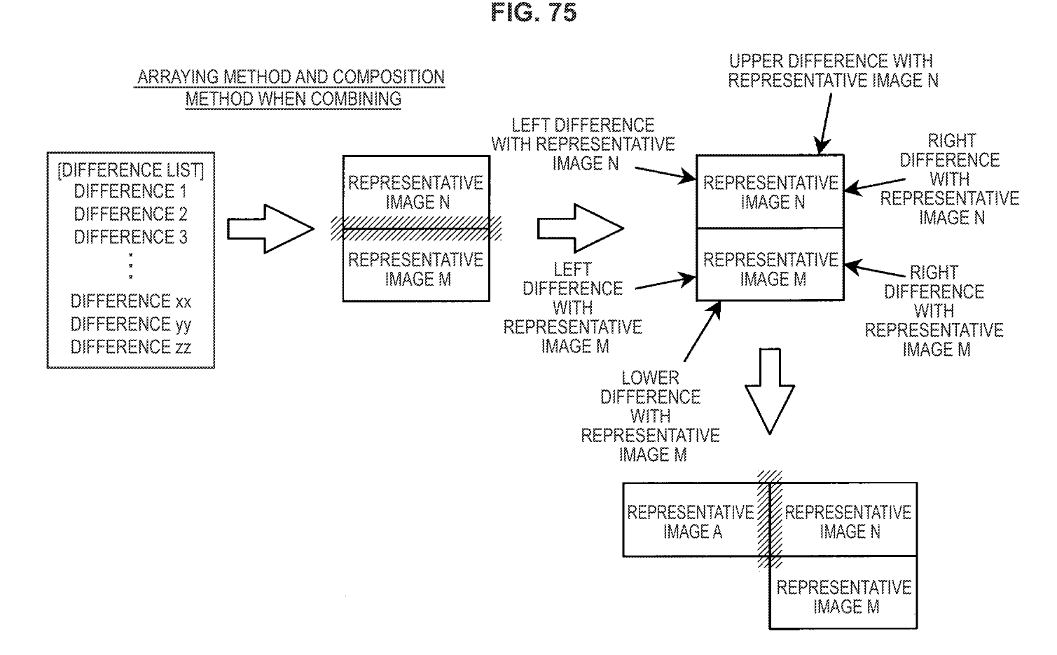

First, FIG. 69 is referred to. As in FIG. 69, when the composition process starts, the image composition unit 303 calculates differences of four sides between the representative image and another image (S401: see FIG. 73). For example, the calculated differences are retained as a table or a list shown in FIG. 74. Next, the image composition unit 303 sorts the difference values (S402). Next, the image composition unit 303 connects an image from the side with the minimum difference value (S403: see FIG. 75). The image composition unit 303 sequentially performs the processes of step S401 to step S403 on the connected image (composite image) to generate the final composite image.

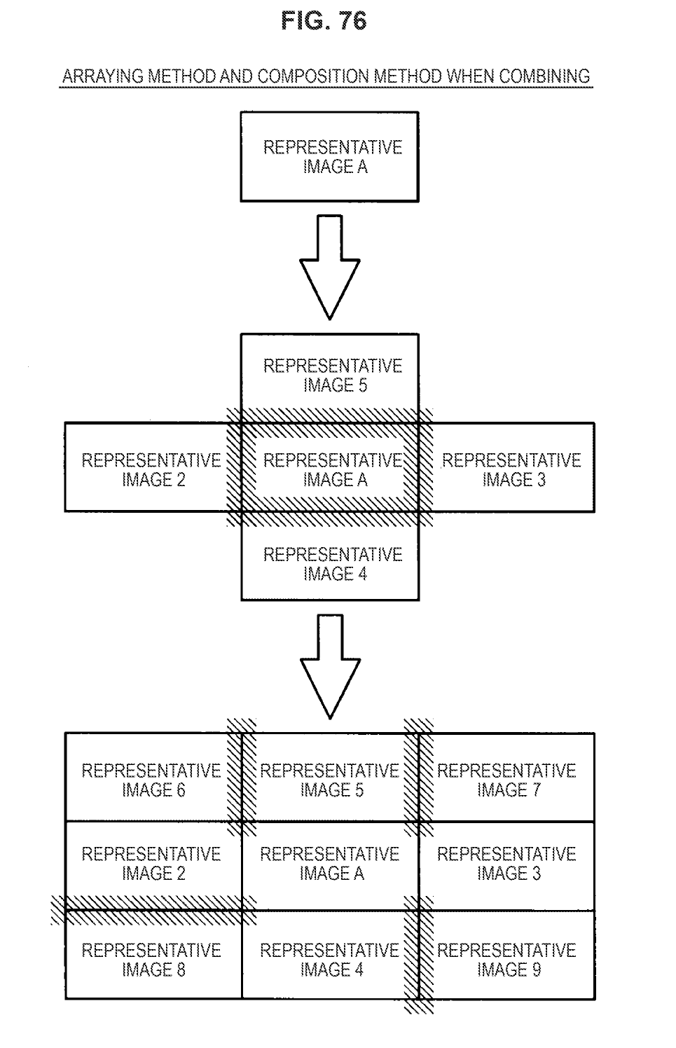

The contents of the process can be also modified as in FIG. 70. As shown in FIG. 70, the image composition unit 303 selects an image A from an image group (S411: see FIG. 76). Next, the image composition unit 303 arrays the image A at the center of the image group (S412: see FIG. 76). Next, the image composition unit 303 connect the images such that the differences between the sides decrease (S413: see FIG. 76) and generates the composite image.

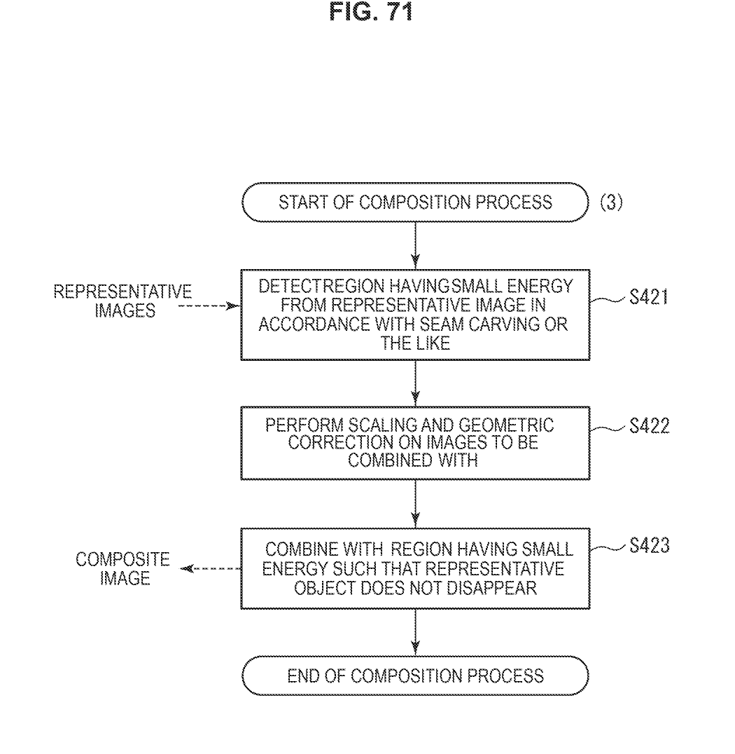

The contents of the process can be also modified as in FIG. 71. As shown in FIG. 71, the image composition unit 303 detects a region having small energy from the representative image in accordance with a seam carving method or the like (S421). Next, the image composition unit 303 performs scaling and geometric correction on the images to be combined (S422). Next, the image composition unit 303 combines the representative object with the region with the small energy such that the representative object does not disappear (S423). When such a method is used, the composite image shown in FIG. 66 is generated.

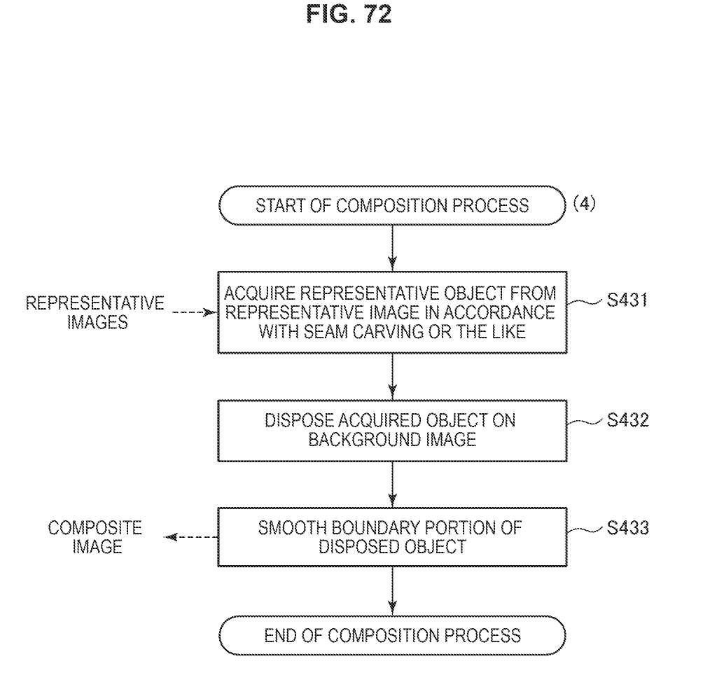

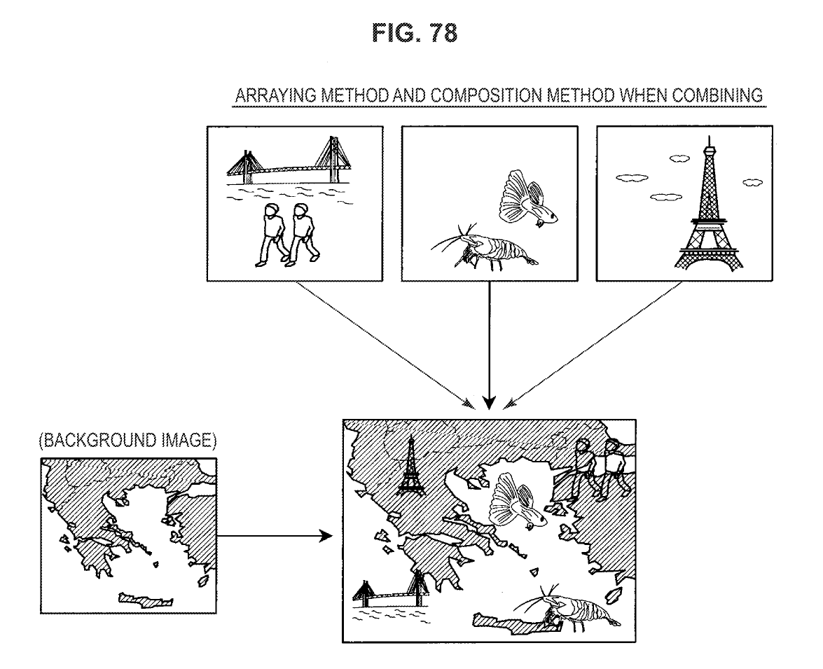

The contents of the process can be also modified, as in FIG. 72. As shown in FIG. 72, the image composition unit 303 cuts a representative object from a representative image in accordance with a seam carving method or the like (S431). Next, the image composition unit 303 disposes the cut object on a background image (S432). Next, the image composition unit 303 smoothes the boundary portion of the object disposed on the background image (S433). When such a method is used, the composite image shown in FIG. 78 is generated.

The method in FIG. 72 is summarized as follows.

(1) The periphery of an object in each representative image is cut by seam carving, graph cutting, or the like. (2) The objects are connected to each other. At this time, as the method of connecting the objects, for example, a method of connecting contour regions (regions for which the total sum of differences of each bin of a normalized histogram is small, the regions for which a difference of bin of the maximum frequency or a difference of a dispersion of a histogram is small, or the regions for which a difference absolute value between the contour regions is small) in which a color histogram in each contour region is close when the pixels (red dotted line portion) of the periphery (contour portion) of each object are divided into several contour regions (regions in which the red dotted line is partitioned by a blue line portion) can be considered.

(3) The objects are disposed. A method of disposing the objects, for example, one or a combination of a plurality of methods can be considered:
a method of centering an object with many connection portions with other objects;
a method of centering an object with the largest object area;
a method of centering an object determined to be a person using recognition of a structural object (region including many edges with a straight shape) or a face;
a method of centering an object designated by a user through a U/I operation; and
a method of arraying an object based on an assumed composition in which an object with abundant green is a ground and an object with abundant blue is a sky from color information (RGB) in an object region.

(4) As a method of displaying the composite image (an image in which the objects are connected), for example, the following methods can be considered:
a method of scaling the composite image so as to be within a display screen;
a method of scrolling and browsing a portion protruding to a portion other than the display screen through a U/I operation without performing the scaling; and
a method of performing scaling to a suitable size for a U/I operation and scrolling and browsing a portion protruding to a portion other than the display screen through the U/I operation.

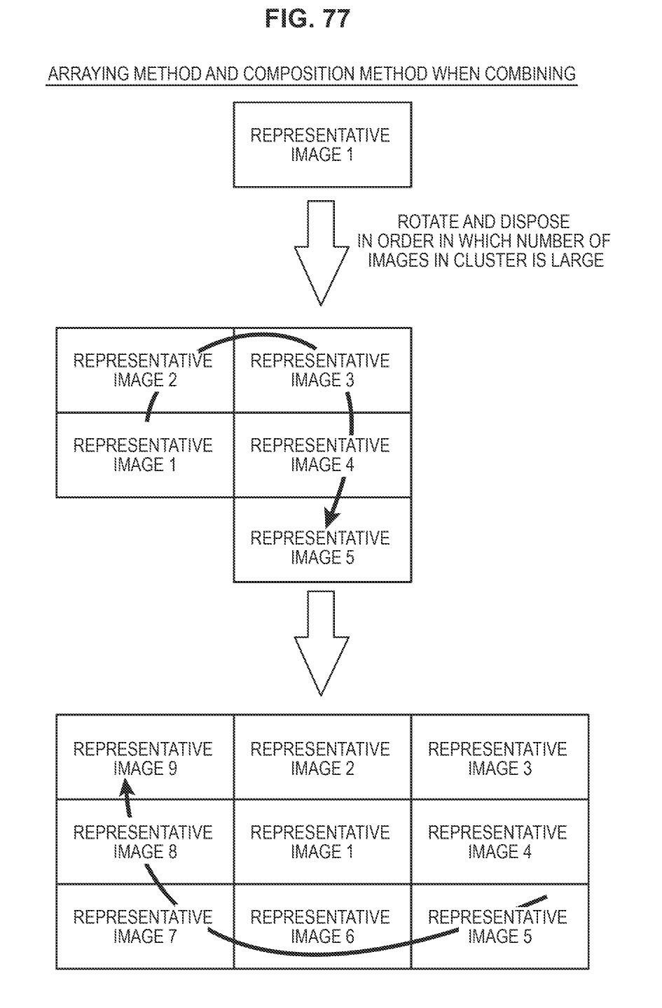

The arraying method and the composition method at the time of combining the representative images have been described. The arraying method and the composition method described above are merely examples. As shown in FIG. 77, a method of arranging the representative images in a rotation direction in the order in which the number of images in the cluster is large can be considered.

The overlook-image generation technology according to the embodiment has been described in detail.

<4: Example Hardware Configuration (FIG. 79)>

Functions of each constituent included in the information processing apparatuses 10, 20, and 30 described above can be realized by using, for example, the hardware configuration of the information processing apparatus shown in FIG. 79. That is, the functions of each constituent can be realized by controlling the hardware shown in FIG. 79 using a computer program. Additionally, the mode of this hardware is arbitrary, and may be a personal computer, a mobile information terminal such as a mobile phone, a PHS or a PDA, a game machine, or various types of information appliances. Moreover, the PHS is an abbreviation for Personal Handy-phone System. Also, the PDA is an abbreviation for Personal Digital Assistant.

As shown in FIG. 79, this hardware mainly includes a CPU 902, a ROM 904, a RAM 906, a host bus 908, and a bridge 910. Furthermore, this hardware includes an external bus 912, an interface 914, an input unit 916, an output unit 918, a storage unit 920, a drive 922, a connection port 924, and a communication unit 926. Moreover, the CPU is an abbreviation for Central Processing Unit. Also, the ROM is an abbreviation for Read Only Memory. Furthermore, the RAM is an abbreviation for Random Access Memory.

The CPU 902 functions as an arithmetic processing unit or a control unit, for example, and controls entire operation or a part of the operation of each structural element based on various programs recorded on the ROM 904, the RAM 906, the storage unit 920, or a removal recording medium 928. The ROM 904 is means for storing, for example, a program to be loaded on the CPU 902 or data or the like used in an arithmetic operation. The RAM 906 temporarily or perpetually stores, for example, a program to be loaded on the CPU 902 or various parameters or the like arbitrarily changed in execution of the program.

These structural elements are connected to each other by, for example, the host bus 908 capable of performing high-speed data transmission. For its part, the host bus 908 is connected through the bridge 910 to the external bus 912 whose data transmission speed is relatively low, for example. Furthermore, the input unit 916 is, for example, a mouse, a keyboard, a touch panel, a button, a switch, or a lever. Also, the input unit 916 may be a remote control that can transmit a control signal by using an infrared ray or other radio waves.

The output unit 918 is, for example, a display device such as a CRT, an LCD, a PDP or an ELD, an audio output device such as a speaker or headphones, a printer, a mobile phone, or a facsimile, that can visually or auditorily notify a user of acquired information. Moreover, the CRT is an abbreviation for Cathode Ray Tube. The LCD is an abbreviation for Liquid Crystal Display. The PDP is an abbreviation for Plasma Display Panel. Also, the ELD is an abbreviation for Electro-Luminescence Display.

The storage unit 920 is a device for storing various data. The storage unit 920 is, for example, a magnetic storage device such as a hard disk drive (HDD), a semiconductor storage device, an optical storage device, or a magneto-optical storage device. The HDD is an abbreviation for Hard Disk Drive.

The drive 922 is a device that reads information recorded on the removal recording medium 928 such as a magnetic disk, an optical disk, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an electronic device or an IC card on which a non-contact IC chip is mounted. The IC is an abbreviation for Integrated Circuit.

The connection port 924 is a port such as a USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Moreover, the USB is an abbreviation for Universal Serial Bus. Also, the SCSI is an abbreviation for Small Computer System Interface.

The communication unit 926 is a communication device to be connected to a network 932, and is, for example, a communication card for a wired or wireless LAN, Bluetooth (registered trademark), or WUSB, an optical communication router, an ADSL router, or a modem for various communication. The network 932 connected to the communication unit 926 is configured from a wire-connected or wirelessly connected network, and is the Internet, a home-use LAN, infrared communication, visible light communication, broadcasting, or satellite communication, for example. Moreover, the LAN is an abbreviation for Local Area Network. Also, the WUSB is an abbreviation for Wireless USB. Furthermore, the ADSL is an abbreviation for Asymmetric Digital Subscriber Line.

<5. Summary>

Finally, the technical spirit and essence according to the embodiment will be described in brief. The technical spirit and essence to be described below can be applied to various apparatuses such as PCs, cellular phones, portable game consoles, portable information terminals, information home appliances, car navigations systems, and photo frames.

The functional configuration of the above-described information processing apparatus can be expressed as follows. For example, a terminal apparatus described in (1) below can sequentially change the clustering results based on a first rule (combination of feature amount coordinates axes) to the detailed contents (the contents of a lower layer) and can also change the display to the clustering results based on a second rule. Therefore, a user operating the terminal apparatus can perform seamlessly an operation of searching for information and an operation of acquiring information from another view point.

Additionally, the present technology may also be configured as below.

(1) A terminal apparatus including:

a display unit that displays information regarding a representative content of each cluster located in lower layers of a cluster to which a selected representative content belongs when information regarding the representative content of each cluster in a predetermined layer is displayed in accordance with a result of hierarchical clustering based on a first rule and the information regarding the representative content is selected,

wherein, when a predetermined condition is satisfied, the information displayed on the display unit is changed to information regarding a representative content of each cluster extracted in accordance with a result of hierarchical clustering based on a second rule different from the first rule.

(2) The terminal apparatus according to (1), wherein the predetermined condition includes selecting information regarding a representative content of each cluster located in a lowest layer.
(3) The terminal apparatus according to (1) or (2), wherein the predetermined condition includes having being performed an operation of changing a rule.
(4) The terminal apparatus according to any one of (1) to (3),

wherein the hierarchical clustering is performed on a set of image contents, and

wherein the display unit displays a composite image obtained by combining representative images of all of clusters extracted as information regarding a representative content of each cluster.

(5) The terminal apparatus according to (4), wherein the hierarchical clustering is performed using a structural line of an object included in each image content as a feature amount.
(6) The terminal apparatus according to (4) or (5), wherein the hierarchical clustering is performed using each division image obtained by dividing each image content into regions as a unit based on a feature amount of each division image.
(7) An information processing apparatus including:

a display control unit that causes information regarding a representative content of each cluster located in lower layers of a cluster to which a selected representative content belongs to be displayed when information regarding the representative content of each cluster in a predetermined layer is displayed in accordance with a result of hierarchical clustering based on a first rule and the information regarding the representative content is selected,

wherein, when a predetermined condition is satisfied, the display control unit causes information regarding the representative content of each cluster to be displayed in accordance with a result of hierarchical clustering based on a second rule different from the first rule.

(8) The information processing apparatus according to (7), wherein the predetermined condition includes selecting information regarding a representative content of each cluster located in a lowest layer.
(9) The information processing apparatus according to (7) or (8), wherein the predetermined condition includes performing an operation of changing a rule.
(10) The information processing apparatus according to any one of (7) to (9), further including:

a clustering unit that clusters a set of contents in accordance with the first or second rule and extracts a representative content of each cluster in each layer; and

an image composition unit that combines images,

wherein the clustering unit performs the hierarchical clustering on a set of image contents,

wherein the image composition unit generates a composite image by combining representative images of all of the clusters extracted as information regarding the representative content of each cluster, and

wherein the display control unit causes the composite image to be displayed.

(11) The information processing apparatus according to (10), wherein the clustering unit performs the hierarchical clustering using a structural line of an object included in each image content as a feature amount.
(12) The information processing apparatus according to (10) or (11), wherein the clustering unit performs the hierarchical clustering using each division image obtained by dividing each of the image content into regions as a unit based on a feature amount of each division image.
(13) A display method including:

displaying information regarding a representative content of each cluster located in lower layers of a cluster to which a selected representative content belongs when information regarding the representative content of each cluster in a predetermined layer is displayed in accordance with a result of hierarchical clustering based on a first rule and the information regarding the representative content is selected; and

changing display information to information regarding a representative content of each cluster extracted in accordance with a result of hierarchical clustering based on a second rule different from the first rule when a predetermined condition is satisfied.

(14) A display control method including:

causing information regarding a representative content of each cluster located in lower layers of a cluster to which a selected representative content belongs to be displayed when information regarding the representative content of each cluster in a predetermined layer is displayed in accordance with a result of hierarchical clustering based on a first rule and the information regarding the representative content is selected; and

causing information regarding the representative content of each cluster to be displayed in accordance with a result of hierarchical clustering based on a second rule different from the first rule when a predetermined condition is satisfied.

(15) A method of operating at least one computing device, the method comprising:

selecting between a first clustering process and a second clustering process based on whether at least one condition is satisfied;

if the first clustering process is selected, performing the first clustering process on a first plurality of images to obtain a first clustering result, wherein the first clustering process uses first coordinate axes that were used in a previous clustering process; and

if the second clustering process is selected, performing the second clustering process on a second plurality of images to obtain a second clustering result, wherein the second clustering process uses second coordinate axes different from the first coordinate axes used in the previous clustering process.

(16) The method of (15), further comprising, prior to selecting between the first clustering process and the second clustering process:

displaying a composite image comprising a plurality of representative images that each represent a respective plurality of images; and

receiving input selecting at least one of the plurality of representative images;

wherein the at least one condition is related to the received input.

(17) The method of (15) or (16), wherein the at least one condition comprises whether the number of images in the respective plurality of images for the selected at least one of the plurality of representative images is greater than a threshold.
(18) The method of (15) to (17), wherein the at least one condition comprises whether the number of selected representative images is greater than a threshold.
(19) The method of (15) to (18), wherein the at least one condition comprises whether the received input was a particular type of operation.
(20) The method of (19), wherein the particular type of operation is a dragging operation or a pinch-out operation.
(21) The method of (19), wherein the particular type of operation is selected from the group consisting of a flicking operation, a tapping operation, a sliding operation, and a dragging operation.
(22) The method of (19), wherein the particular type of operation is a prepared gesture.
(23) The method of (15), wherein the at least one condition comprises a user's explicit selection of which clustering process to use.
(24) The method of (15) or (23), wherein the first clustering result and the second clustering result are each used to generate a respective composite image.
(25) The method of (24), further comprising:

if the first clustering process is selected, displaying the respective composite image generated from the first clustering result; and

if the second clustering process is selected, displaying the respective composite image generated from the second clustering result.

(26) The method of (16), wherein:

the first clustering process comprises a clustering process used to generate the composite image;

the second clustering process comprises a clustering process different from the clustering process used to generate the composite image.

(27) The method of (16) or (26), wherein the composite image is a result of the previous clustering processing.
(28) The method of (16) or (26) or (27), wherein the first clustering process comprises performing a clustering process on the respective plurality of images associated with the selected at least one of the plurality of representative images using the first coordinate axes that were used in the previous clustering process and using a first resolution different from a resolution used in a the precious clustering process.
(29) The method of (16) or (26) to (28), wherein the second clustering process comprises performing a clustering process on at least the respective plurality of images associated with the selected at least one of the plurality of representative images using the second coordinate axes different from the first coordinate axes used in the previous clustering process.
(30) The method of (29), wherein the second clustering process is performed on the respective plurality of images associated with the selected at least one of the plurality of representative images and at least one image associated with a representative image of the plurality of representative images that was not selected by the user.
(31) An apparatus comprising:

a display unit configured to display information;

a user input device for receiving input from the user;

a processing unit configured to implement a method, the method comprising:
selecting between a first clustering process and a second clustering process based on whether at least one condition is satisfied;
if the first clustering process is selected, performing the first clustering process on a first plurality of images to obtain a first clustering result, wherein the first clustering process uses first coordinate axes that were used in a previous clustering process; and
if the second clustering process is selected, performing the second clustering process on a second plurality of images to obtain a second clustering result, wherein the second clustering process uses second coordinate axes different from the first coordinate axes used in the previous clustering process.
   (32) The apparatus of (31), wherein the method further comprises, prior to selecting between the first clustering process and the second clustering process:

displaying, on the display unit, a composite image comprising a plurality of representative images that each represent a respective plurality of images; and

receiving input, via the user input device, selecting at least one of the plurality of representative images;

wherein the at least one condition is related to the received input.

(33) At least one non-transitory computer-readable storage medium comprising computer-executable instructions that, when executed, perform a method, the method comprising:

selecting between a first clustering process and a second clustering process based on whether at least one condition is satisfied;

if the first clustering process is selected, performing the first clustering process on a first plurality of images to obtain a first clustering result, wherein the first clustering process uses first coordinate axes that were used in a previous clustering process; and

if the second clustering process is selected, performing the second clustering process on a second plurality of images to obtain a second clustering result, wherein the second clustering process uses second coordinate axes different from the first coordinate axes used in the previous clustering process.

(34) The at least one non-transitory computer-readable storage medium of (33), wherein the method further comprises, prior to selecting between the first clustering process and the second clustering process:

displaying a composite image comprising a plurality of representative images that each represent a respective plurality of images; and

receiving input selecting at least one of the plurality of representative images;

wherein the at least one condition is related to the received input.

It should be understood by those skilled in the art that various modifications, combinations, sub-combinations and alterations may occur depending on design requirements and other factors insofar as they are within the scope of the appended claims or the equivalents thereof.

What is claimed is:

1. A method of operating at least one computing device, the method comprising:
selecting between a first clustering process and a second clustering process based on whether at least one condition is satisfied;
if the first clustering process is selected, performing the first clustering process on a first plurality of images to obtain a first clustering result, wherein the first clustering process uses first coordinate axes that were used in a previous clustering process; and
if the second clustering process is selected, performing the second clustering process on a second plurality of images to obtain a second clustering result, wherein the second clustering process uses second coordinate axes different from the first coordinate axes used in the previous clustering process.

2. The method of claim 1, further comprising, prior to selecting between the first clustering process and the second clustering process:
displaying a composite image comprising a plurality of representative images that each represent a respective plurality of images; and
receiving input selecting at least one of the plurality of representative images;
wherein the at least one condition is related to the received input.

3. The method of claim 2, wherein the at least one condition comprises whether the number of images in the respective plurality of images for the selected at least one of the plurality of representative images is greater than a threshold.

4. The method of claim 2, wherein the at least one condition comprises whether the number of selected representative images is greater than a threshold.

5. The method of claim 2, wherein the at least one condition comprises whether the received input was a particular type of operation.

6. The method of claim 5, wherein the particular type of operation is a dragging operation or a pinch-out operation.

7. The method of claim 5, wherein the particular type of operation is selected from the group consisting of a flicking operation, a tapping operation, a sliding operation, and a dragging operation.

8. The method of claim 5, wherein the particular type of operation is a prepared gesture.

9. The method of claim 1, wherein the at least one condition comprises a user's explicit selection of which clustering process to use.

10. The method of claim 1, wherein the first clustering result and the second clustering result are each used to generate a respective composite image.

11. The method of claim 10, further comprising:
if the first clustering process is selected, displaying the respective composite image generated from the first clustering result; and
if the second clustering process is selected, displaying the respective composite image generated from the second clustering result.

12. The method of claim 2, wherein:
the first clustering process comprises a clustering process used to generate the composite image;
the second clustering process comprises a clustering process different from the clustering process used to generate the composite image.

13. The method of claim 2, wherein the composite image is a result of the previous clustering processing.

14. The method of claim 2, wherein the first clustering process comprises performing a clustering process on the respective plurality of images associated with the selected at least one of the plurality of representative images using the first coordinate axes that were used in the previous clustering process and using a first resolution different from a resolution used in a the precious clustering process.

15. The method of claim 2, wherein the second clustering process comprises performing a clustering process on at least the respective plurality of images associated with the selected at least one of the plurality of representative images using the second coordinate axes different from the first coordinate axes used in the previous clustering process.

16. The method of claim 15, wherein the second clustering process is performed on the respective plurality of images associated with the selected at least one of the plurality of representative images and at least one image associated with a representative image of the plurality of representative images that was not selected by the user.

17. An apparatus comprising:
a display unit configured to display information;
a user input device for receiving input from the user;
a processing unit configured to implement a method, the method comprising:
selecting between a first clustering process and a second clustering process based on whether at least one condition is satisfied;
if the first clustering process is selected, performing the first clustering process on a first plurality of images to obtain a first clustering result, wherein the first clustering process uses first coordinate axes that were used in a previous clustering process; and
if the second clustering process is selected, performing the second clustering process on a second plurality of images to obtain a second clustering result, wherein the second clustering process uses second coordinate axes different from the first coordinate axes used in the previous clustering process.

18. The apparatus of claim 17, wherein the method further comprises, prior to selecting between the first clustering process and the second clustering process:
displaying, on the display unit, a composite image comprising a plurality of representative images that each represent a respective plurality of images; and
receiving input, via the user input device, selecting at least one of the plurality of representative images;
wherein the at least one condition is related to the received input.

19. At least one non-transitory computer-readable storage medium comprising computer-executable instructions that, when executed, perform a method, the method comprising:
selecting between a first clustering process and a second clustering process based on whether at least one condition is satisfied;
if the first clustering process is selected, performing the first clustering process on a first plurality of images to obtain a first clustering result, wherein the first clustering process uses first coordinate axes that were used in a previous clustering process; and
if the second clustering process is selected, performing the second clustering process on a second plurality of images to obtain a second clustering result, wherein the second clustering process uses second coordinate axes different from the first coordinate axes used in the previous clustering process.

20. The at least one non-transitory computer-readable storage medium of claim 19, wherein the method further comprises, prior to selecting between the first clustering process and the second clustering process:
displaying a composite image comprising a plurality of representative images that each represent a respective plurality of images; and
receiving input selecting at least one of the plurality of representative images;
wherein the at least one condition is related to the received input.
